(19) United States
(12) Patent Application Publication
(10) Pub. No.: US 2024/0410327 A1
(43) Pub. Date: Dec. 12, 2024

(54) Engine Systems and Uses Thereof

(71) Applicant: Alpha Portfollo LLC, Naples, FL (US)

(72) Inventors: Addison FISCHER, Naples, FL (US); Christopher J. NAGEL, Wayland, MA (US)

(21) Appl. No.: 18/804,359

(22) Filed: Aug. 14, 2024

Related U.S. Application Data
(63) Continuation of application No. PCT/US22/37807, filed on Jul. 21, 2022.

(51) Int. Cl. F02K 9/62; F02K 9/42

(52) U.S. Cl. CPC F02K 9/62; F02K 9/425

(57) ABSTRACT

The invention includes engines adapted for using apparatuses and methods for instantiating chemical reactants in a nanoporous carbon powder, and further includes uses for such engines and vehicles incorporating such engines.

### RELATED APPLICATION

This application is a continuation of International Application No. PCT/US22/37807, which designated the United States and was filed on Jul. 21, 2022, published in English. The entire teachings of the above application are incorporated herein by reference.

### BACKGROUND OF THE INVENTION

A typical internal combustion engine comprises a housing structure such as an engine block that houses one or more internal combustion chamber(s). A fuel-air mixture is introduced into the combustion chamber(s), and a spark or other ignition mechanism controllably ignites the fuel-air mixture within the chamber(s). Expanding gases resulting from combustion drive a mechanical part such as a reciprocating piston, a rotating rotor and/or a rotating turbine to provide drive power for cars, motorcycles, ships, airplanes, helicopters, trains, electrical generators, and countless other machines. Such engine technology changed the world when it was invented in the mid-19^{th} Century and has since become ubiquitous.

Engines that use oxygen from the ambient air to produce power are called “air-breathing” engines. An engine used in an aerobic environment is typically air-breathing: it uses external oxygen in combination with onboard fuel for the combustion process that produces motive power. Air-breathing engines include internal and external combustion engines, which produce rapidly expanding gases that act on other engine components to produce useful work, as well as reaction engines (also termed “expulsive combustion engines,” (ECE)) that use combustion or other energy-producing mechanisms to produce thrust. Reaction engines deployed in an aerobic environment are termed “jet engines”. These use oxygen derived from the atmosphere to react with fuel and produce combustion, generating thrust via the ejection of gases produced by combustion.

By contrast, an engine that is used in an environment lacking air (an “anaerobic environment”) and thus lacking usable oxygen cannot be air-breathing; it must typically provide onboard its own source of oxidant, as it can derive no oxygen from the environment to use in producing power. ECEs can operate anaerobically, using only onboard propellants. Such engines perform energy-producing reactions that accelerate gases in a preselected direction, thereby generating thrust that pushes a designated projectile or vehicle in the opposite direction in accordance with Newton's Third Law of Motion.

Expulsive combustion engines can therefore be used to propel vehicles for travel or transportation and other projectiles in a variety of anaerobic environments including an atmosphere devoid of oxygen, including a vacuum and including under water. In these situations, no oxygen is available externally. If the ECE produces thrust via a chemical reaction such as combustion, the engine must have onboard access to the chemical reactants yielding the reaction;

An expulsive combustion engine used to provide propulsion to a device for transportation or travel or a projectile (collectively, “vehicles”), for example a device for traveling in an anaerobic environment or a projectile carrying a payload, must contain onboard the means for producing the thrust that propels such a vehicle. Vehicles powered by expulsive combustion engines can obtain the thrust for their motive power by the production and ejection of exhaust gases from chemical processes such as combustion. In any of these cases, the vehicle operating in an air-free environment must provide the materials that produce the thrust. If the thrust is produced by combustion, the vehicle must contain onboard both the fuel for the combustion reaction and the oxidant that combines with it.

The need for sources of reactants (collectively “propellants”) on board the vehicle adds considerable weight to the overall vehicle assembly, imposing burdens on the system as the vehicle navigates different stages of a planned voyage or supra-atmospheric mission, such as vehicle launch, entering/exiting Earth orbit, entering/exiting the orbit of another planet or celestial body, powering a direction change in free space, and the like, all of which require acceleration. For a vehicle to move in an opposite direction from a force acting on it, for example to overcome gravity to leave the ground, the expulsive combustion engine must produce an amount of thrust that is greater than the total mass of the vehicle. In accordance with Newton's first law (force=mass times acceleration, F=ma) the greater the mass of the vehicle, the greater amount of thrust is needed to launch it or change its direction. Assuming that the expulsive combustion engine produces the same amount of thrust for a lighter or a heavier vehicle, the lighter vehicle will go faster. In current vehicle design, 80-90% of the weight of a vehicle going into orbit is propellant weight. It would therefore be advantageous to provide a lighter-weight source of propellant that provides similar thrust. It would also be advantageous to increase the efficiency of the expulsive combustion engine, so that for a given amount of propellant, more thrust is produced. While many improvements to engine design have been proposed or implemented, further improvements are possible and desirable. In particular, it would be highly desirable to offer improved technologies for fueling expulsive combustion engines and powering the machines that use them.

### SUMMARY OF THE INVENTION

The present invention relates to the discovery that apparatuses containing carbon matrices can be used to produce reactant chemicals useful as fuels for use in a variety of engines. The processes of the invention include the application of electromagnetic radiation, directly and/or indirectly, to gases, nano-porous carbon, or compositions and combinations thereof, thereby pre-treating the gas, and exposing a carbon matrix to pre-treated gas in an apparatus of the invention and recovering those reactant chemicals that are subsequently used as fuels in engines.

The invention relates to apparatuses for instantiating materials, and processes for using such apparatuses. The invention includes processes comprising the steps of contacting a bed comprising nanoporous carbon with an activated gas while applying electromagnetic radiation to the nanoporous carbon for a time sufficient to cause instantiation of the fuel substance, and collecting the fuel substance. The invention further relates to the fuel substance produced by the process.

More specifically, the invention includes a process of instantiating a chemical reactant within a nanoporous carbon powder comprising the steps of:
(a) adding a nanoporous carbon powder into a reactor assembly (RA), as described below,
(b) adding a feedgas composition to the reactor assembly, wherein the feedgas composition is free of the desired fuel substance;
(c) powering one or more RA coils to a first electromagnetic energy level;
(d) subjecting the nanoporous carbon powder (the terms nanoporous carbon powder, nanoporous carbon material and nanoporous carbon are used herein interchangeably) to harmonic patterning to instantiate the chemical reactant in product compositions;
(e) collecting the product compositions comprising the chemical reactant; and
(f) optionally isolating the chemical reactant from the product compositions.

In one embodiment, the RA coil surrounds a nanoporous carbon bed to establish a harmonic electromagnetic resonance in ultramicropores of the nanoporous carbon powder. The feedgas composition can be, for example, air, oxygen, hydrogen, helium, nitrogen, neon, argon, krypton, xenon, carbon monoxide, carbon dioxide or mixtures thereof, preferably nitrogen or air. Preferably, the nanoporous carbon powder comprises graphene having at least 99.9% wt. carbon (metals basis), a mass mean diameter between 1 μm and 5 mm, and an ultramicropore surface area between about 100 and 3000 m²/g. More specifically, the invention includes a reactor assembly comprising:
(a) A reactor chamber containing a nanoporous carbon material;
(b) A second porous frit defining the ceiling of the reactor chamber; wherein each porous frit has a porosity that is sufficient to allow a gas to permeate into the reactor chamber and contain a nanoporous carbon material;
(c) A reactor head space disposed above the reactor cap;
(d) 1, 2, 3, 4, 5 or more RA coils surrounding the reactor chamber and/or reactor head space operably connected to one or more RA frequency generators and/or one or more power supplies;
(e) 0, 1, 2, 3, 4, 5 or more pairs of RA lamps wherein the pairs of RA lamps are disposed circumferentially around the RA coils and define a space between the pairs of RA lamps and the RA coils, when present;
(f) An optional x-ray source configured to expose the reactor chamber to x-rays;
(g) One or more optional lasers configured to direct a laser towards (e.g., through or across) the reactor chamber or the gas within the reactor assembly, when present; and
(h) A computer processing unit (CPU) configured to control the power supply, frequency generator, x-ray source, lamps and/or lasers.

As will be described in more detail below, the gas inlet of the reactor assembly can be in fluid connection with at least one gas supply selected from the group consisting of air, oxygen, hydrogen, helium, nitrogen, neon, argon, krypton, xenon, carbon monoxide, carbon dioxide and mixtures thereof; and/or (iii) the gas supply is directed through a gas manifold controlled by mass flow meters.

As will be described in more detail below, the nanoporous carbon powder charged to the reactor assembly can comprise graphene having at least 95% wt. carbon (metals basis), a mass mean diameter between 1 μm and 5 mm, and an ultramicropore surface area between about 100 and 3000 m²/g. The nanoporous carbon powder is preferably characterized by acid conditioning, wherein the acid is selected from the group consisting, without limitation, of HCl, HF, HBr, HI, sulfuric acid, phosphoric acid, carbonic acid, and nitric acid, and a residual water content of less than that achieved upon exposure to a relative humidity (RH) of less than 40% RH at room temperature. In a preferred embodiment, the process contemplates degassing the nanoporous carbon powder prior to the process.

As will be described in more detail below, the reactor assembly can include a plurality of devices that can impart electromagnetic fields, including x-ray sources, coils, lasers and lamps or lights, including pencil lamps, short wave and long wave lamps. The wavelengths generated by each device (e.g., lamps or lasers) can be independently selected.

As will be described in more detail below, the RA coils can be made from the same or different electrically conducting materials. For example, a first RA coil comprises a copper wire winding, a second RA coil comprises a braiding of copper wire and silver wire, and a third RA coil is a platinum wire winding and each RA coil is configured to create a magnetic field and wherein each power supply independently provides AC and/or DC current.

As will be described in more detail below, the reactor assembly can be characterized by (i) a first pair of RA lamps configured in a first plane defined by a center axis and a first radius of the reactor chamber, (ii) a second pair of RA lamps configured in a second plane defined by the center axis and a second radius of the reactor chamber and (iii) a third pair of RA lamps configured in a third plane defined by the center axis and a third radius of the reactor chamber. Preferably, each RA lamp is a pencil lamp characterized by a tip substantially equidistant from the central axis and each pair of RA lamps comprises a vertical RA lamp and a horizontal RA lamp. Preferably each pair of lamps is equidistantly spaced around the circumference of the reactor chamber.

As will be described in more detail below, the reactor assembly further comprises an electromagnetic embedding enclosure (E/MEE or EMEE), as defined more specifically below. The E/MEE is typically located along a gas line upstream of the reactor assembly gas inlet. Typically, an electromagnetic embedding enclosure located upstream of the gas inlet comprises:
(a) a gas inlet;
(b) at least one E/MEE pencil lamp positioned below the internal gas line, at least one E/MEE pencil lamp positioned above the internal gas line and at least one E/MEE pencil lamp positioned to the side of the internal gas line;
   wherein each E/MEE pencil lamp is independently rotatably mounted, located along the length of the internal gas line, and
   the lamps and/or coil(s) are powered by a power supply, preferably the power supply of the reactor assembly; and
      wherein the gas flow, lamps and/or coil(s) are preferably independently controlled by one or more central processing units, preferably the central processing unit (CPU) of the reactor assembly.

Typically, a CPU independently controls powering each E/MEE pencil lamp and a rotation position of each E/MEE pencil lamp. It is to be understood that the term “independently” is not meant to be absolute, but is used to optimize results. Rather, controlling each RA coil, lamp and/or laser (each a device) such that it is powered (or rotated) at the same time or at a time specified before and/or after another device is meant to be “independently” controlled. Thus, assigning two or more devices to a power supply and control unit in series is contemplated by the term. The term is intended to exclude simply powering (or rotating) all devices simultaneously.

As will be described in more detail below, the E/MEE housing can be typically closed and opaque, the internal gas line can be transparent and external gas line in fluid connection with the housing outlet and gas inlet can be opaque. Typically, the internal gas line is between 50 cm and 5 meters or more and has a diameter between 2 mm and 25 cm or more.

As will be described in more detail below, the apparatus can have at least 5 E/MEE pencil lamps located along the internal gas line. Each E/MEE pencil lamp can be independently placed such that its longitudinal axis is (i) parallel to the internal gas line, (ii) disposed radially in a vertical plane to the internal gas line, or (iii) perpendicular to the plane created along the longitudinal axis of the internal gas line or along the vertical axis of the internal gas line. Each E/MEE pencil lamp can be independently affixed to one or more pivots that permit rotation, such as, between about 0 and 360 degrees (such as, between 0 and 90 degrees, between 0 and 180 degrees, between 0 and 270 degrees and any angle there between) with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

As will be described in more detail below, at least one E/MEE pencil lamp can be a neon lamp, at least one E/MEE pencil lamp can be a krypton lamp, and at least one E/MEE pencil lamp can be an argon lamp. It can be desirable to match, or pair, one or more E/MEE pencil lamps with one or more (e.g., a pair) of RA lamps. Accordingly, at least one pair of RA pencil lamps can be selected from the group consisting of a neon lamp, a krypton lamp and an argon lamp.

As will be described in more detail below, the invention also includes nanoporous carbon powder compositions, gas compositions, or fluid compositions (preferably gas compositions) produced in accordance with the claimed methods and processes.

As will be described in more detail below, the invention includes a process of producing a nanoporous carbon composition comprising the steps of: (a) initiating a gas flow in a reactor assembly as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to or fluid compositions (preferably gas compositions) or solid chemical reactants in a nanopore.

The invention also includes a process of producing a nanoporous carbon composition comprising the steps of: (a) initiating a gas flow in a reactor assembly further comprising an E/MEE, as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to instantiate a fluid (preferably gaseous) or solid chemical reactant in a nanopore.

The invention also includes a process of instantiating a fluid (preferably gaseous) or solid chemical reactant within an ultramicropore of a nanoporous carbon powder comprising the steps of: (a) initiating a gas flow in a reactor assembly further comprising an E/MEE, as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to instantiate the fluid (preferably gaseous) or solid chemical reactant in a nanopore. The invention further includes a fluid (preferably gaseous) or solid chemical reactant by the aforesaid process.

The invention can also include a process for producing a chemical reactant comprising the steps of:
(a) Adding a feed gas to an electromagnetic embedding apparatus comprising:
   (i) a gas line containing the feed gas,
   (ii) at least one E/MEE pencil lamp positioned below the gas line,
   (iii) at least one E/MEE pencil lamp positioned above the gas line and
   (iv) at least one E/MEE pencil lamp positioned to the side of the gas line, wherein each E/MEE pencil lamp is independently rotatably mounted, located along the length of the gas line;
   (v) a power source operably connected to each pencil lamp, and
   (vi) a central processing unit configured to independently control powering each E/MEE pencil lamp and a rotation position of each E/MEE pencil lamp;
(b) powering each pencil lamp, thereby subjecting the feed gas to electromagnetic radiation; optionally rotating one or more lamps;
(c) directing the feed gas from step (b) to a reactor assembly comprising:
   (i) a gas inlet and one or more gas outlets,
   (ii) a reactor chamber containing a nanoporous carbon disposed within a cup and, optionally, covered with a cap,
   (iii) a first porous frit defining a floor of the reactor chamber disposed within the cup,
   (iv) a second porous frit defining the ceiling of the reactor chamber and disposed below the cap; wherein each porous frit has a porosity that is sufficient to allow a gas to permeate into the reactor chamber and contain a nanoporous carbon,
   (v) a reactor head space disposed above the reactor cap, and
   (vi) at least one RA coil surrounding the reactor chamber and/or reactor head space operably connected to a power supply, wherein the computer processing unit is configured to control the power supply to the RA coil;
(d) powering each RA to a first electromagnetic energy level;
(e) subjecting the nanoporous carbon powder to harmonic patterning to instantiate product compositions; and
(f) collecting the chemical reactant from the product compositions.

The invention further includes a fluid (preferably gaseous) or solid chemical reactant produced by the aforesaid process. In embodiments, the chemical reactant is a fuel substance. In embodiments, the chemical reactant comprises a fluid (preferably gaseous) selected from the group consisting of hydrogen (H₂), carbon (C), carbon monoxide (CO), ammonia (NH₃), a substituted or unsubstituted hydrocarbon, a hydrocarbon derivative, and a carbohydrate. In embodiments, the chemical reactant comprises a substituted or unsubstituted hydrocarbon selected from the group consisting of alkanes, cycloalkanes alkenes, alkynes, and substituted or unsubstituted aromatic hydrocarbons, and can comprise a C₁-C₄ alkane, a C₅-C₈ alkane, a C₉-C₁₆ alkane, or an alkane containing 17 or more carbon atoms. In embodiments, the chemical reactant comprises an alcohol or a nitroalkane. In embodiments, the chemical reactant comprises a suitably combustible material.

The invention further includes expulsive combustion engines and other reaction engines that can be used in vehicles, comprising:
(a) a set of one or more reactor assemblies (RAs) that produces the fuel;
(b) a source of an oxidizing agent;
(c) a fuel intake system in fluid communication with the set of one or more RAs sand further in fluid communication with a combustion chamber, wherein the fuel intake system delivers the fuel into the combustion chamber;
(d) an oxidant delivery system in fluid communication with the source of the oxidizing agent, wherein the oxidant delivery system delivers an oxidizing agent into the combustion chamber;
(e) a control system operatively coupled to the fuel intake system and the oxidant delivery system, wherein the control system regulates delivery of a preselected fuel amount and a preselected oxidizing agent amount into the combustion chamber, and wherein the control system controls the combustion of the fuel and the oxidizing agent when the preselected fuel amount and the preselected oxidizing agent amount are present in the combustion chamber, thereby producing energy and exhaust gases; and
(f) a nozzle in fluid communication with the combustion chamber, through which the exhaust gases exit the combustion chamber in a preselected direction to produce the thrust.

In embodiments, the expulsive combustion engine is an engine designed to operate in anaerobic environments. In embodiments, the set of one or more RAs comprises a plurality of RAs. In embodiments, the fuel comprises hydrogen. In embodiments, wherein the source of the oxidizing agent is a second set of RAs that produces the oxidizing agent, and the oxidizing agent is selected from the group consisting of oxygen, halogen, and hydrogen peroxide. In embodiments, the control system controls the combustion of the fuel by triggering an ignition in the combustion chamber when the preselected fuel amount and the preselected oxidizing agent amount are present in the combustion chamber.

In embodiments, the fuel comprises hydrogen. In embodiments, the set of one or more RAs comprises a plurality of RAs. In embodiments, the oxidizing agent enters the oxidant delivery system from a feed gas line or from ambient atmosphere, and the oxidizing agent can comprise oxygen or a halogen molecule. In embodiments, the engine can further comprise an auxiliary set of RAs that produces the oxidizing agent, wherein the auxiliary set of RAs is in fluid communication with the oxidant delivery system, and wherein the auxiliary set of RAs produces at least a portion of the preselected oxidizing agent amount in the combustion chamber used for combustion. In embodiments, the engine further comprises an exhaust system, wherein the exhaust system expels byproducts of combustion from the combustion chamber.

The invention further includes methods of producing thrust to propel a vehicle, comprising:
a) operatively associating the vehicle with the expulsive combustion engine as described above;
b) activating the set of one or more RAs to produce the fuel;
c) directing the fuel produced by the set of one or more RAs to enter the fuel intake system in fluid communication with the combustion chamber, wherein the fuel intake system directs the fuel into the combustion chamber;
d) providing a source of the oxidizing agent;
e) directing the oxidizing agent from the source of the oxidizing agent into the combustion chamber;
f) mixing the fuel and the oxidizing agent to form a combustion mixture;
g) igniting the combustion mixture to produce a combustion, wherein the combustion produces energy and exhaust gases; and
h) directing the exhaust gases to exit the combustion chamber in a preselected direction, thereby producing the thrust to propel the vehicle.

In embodiments, the vehicle is adapted for travel in whole or in part to at least one destination that is outside the Earth's atmosphere, and the expulsive combustion engine is an anaerobic engine. In embodiments, the fuel comprises hydrogen. In embodiments, the source of the oxidizing agent is a second set of RAs, and the oxidizing agent is selected from the group consisting of oxygen, halogen, and hydrogen peroxide. The method further comprises adding an adjuvant gas to the combustion mixture; the adjuvant gas can be added to at least one of fuel and the oxidizing agent before reaching the combustion chamber. In embodiments, the energy produced by the combustion comprises heat energy. The method further comprises providing a heat management subsystem for managing the heat energy, wherein the heat management system comprises at least one of a heat deflector and radiator structures.

The invention further includes methods of propelling a vehicle on a predetermined course, comprising:
(a) providing an expulsive combustion engine for the vehicle, wherein the expulsive combustion engine operatively coupled to the vehicle, and wherein the expulsive combustion engine provides motive power to the vehicle by producing thrust;
(b) producing a fuel for the engine, wherein the step of producing the fuel comprises the following substeps:
   (i) adding a fuel feed gas to an electromagnetic embedding apparatus:
   (ii) exposing the fuel feed gas to at least one E/MEE light source;
   (iii) directing the fuel feed gas from step (ii) to a reactor assembly comprising: a gas inlet and one or more gas outlets;
      a reactor chamber containing a nanoporous carbon disposed within a cup and, optionally, covered with a cap;
      a first porous frit defining a floor of the reactor chamber disposed within the cup, a second porous frit defining the ceiling of the reactor chamber; wherein each porous frit has a porosity that is sufficient to allow a gas to permeate into the reactor chamber;
      a reactor head space disposed above the reactor chamber;
      at least one RA coil surrounding the reactor chamber and/or reactor head space operably connected to a power supply, wherein the computer processing unit is configured to control the power supply to the RA coil;
   (iv) subjecting the nanoporous carbon powder to harmonic patterning to instantiate a product fluid comprising the fuel; and
   (v) collecting the product fluid comprising the fuel;
(c) mixing an oxidant with the fuel, thereby forming a combustible fuel mixture; and
(d) combusting the combustible fuel mixture in the combustion chamber to generate energy and to produce exhaust gases that are expelled from the combustion chamber to produce thrust that provides motive power to the vehicle; and
(e) directing the vehicle to follow the predetermined course.

In embodiments, the vehicle is adapted for travel outside the Earth's atmosphere. In embodiments, the fuel feed gas comprises nitrogen. In embodiments, the fuel comprises hydrogen. In embodiments, the step of mixing the oxidant with the fuel takes place within the combustion chamber, preceded by a step of delivering the fuel into the combustion chamber and a step of delivering the oxidant into the combustion chamber. In embodiments, the oxidant is produced by a second set of one or more RAs, and the oxidant can be is selected from the group consisting of oxygen, halogen, and hydrogen peroxide. In embodiments, the step of combusting comprises a substep of igniting the combustible fuel mixture to initiate the combusting. The method can further comprise comprising pressurizing or compressing at least one of the fuel and the oxidant prior to its delivery into the combustion chamber.

The invention further includes systems for propelling a vehicle along a designated route, comprising:
(a) a propellant locus comprising at least one set of fuel-instantiating RAs for producing fuel, and at least one set of oxidant-instantiating RAs for producing oxidant;
(b) a propulsion locus comprising:
   (i) a combustion chamber within which a mixture of fuel and oxidant is combusted to produce exhaust gas and to generate energy comprising heat energy; and
   (ii) a nozzle for directing the exhaust gas to exit the combustion chamber in a direction consistent with propelling the vehicle along the designated route;
(c) a series of conduits in fluid communication with the propellant locus and the combustion chamber, wherein the series of conduits directs the fuel and the oxidant into the combustion chamber; and
(d) a heat management subsystem, comprising at least one or more of a heat deflector and one or more radiator structures for managing heat energy.

In embodiments, the propellant locus further comprises at least one set of RAs for producing a propellant additive, and the series of conduits directs the propellant additive into the combustion chamber. The series of conduits can comprise a premixing chamber within which the additive is premixed with at least one of the fuel and oxidant to form a mixture before entering the combustion chamber, wherein the mixture is thereafter directed into the combustion chamber.

In embodiments, the heat management subsystem manages heat energy produced by combustion in the combustion chamber. Its radiator structures can be heat conductive structures with heat emissive surfaces. The one or more radiator structures can comprise fins. In embodiments, the system further comprises an ancillary power source producing electricity for one or more secondary functions; the ancillary power source can comprise a battery or a fuel cell and such a fuel cell can employ reactants produced by at least one set of RAs. In embodiments, the fuel cell is powered by a redox reaction involving hydrogen and oxygen. In embodiments, the secondary function is a function of powering one or more RA systems, or the secondary function is selected from the group consisting of flight control, thruster control, communications, life and food support, environmental control, and thermal control, or the secondary function is selected from the group consisting of guidance, course correction, and maneuvering. In embodiments, the system further comprises a secondary propulsion system for carrying out a secondary function selected from the group consisting of guidance, course correction, and maneuvering, wherein the secondary function directs the vehicle along the designated route. In embodiments, the secondary propulsion system comprises one or more thrusters.

The invention further includes vehicles comprising a payload pod conveying a payload, an electrical power bay, a propellant locus, a propulsion locus, and a radiator,
wherein a distal end of the payload pod is affixed to a proximal end of the electrical power bay, and wherein a distal end of the electrical power bay is affixed to a proximal end of the propellant locus, and wherein the payload pod, the electrical power bay, and the propellant locus are integrated to form a single unified structure;
wherein the electrical power bay is operatively coupled to one or more of the payload pod, the propellant locus, and the propulsion locus to provide power thereto;
wherein the propellant locus instantiates a fuel and an oxidant to deliver to the propulsion locus;
wherein the propulsion locus comprises one or more combustion chambers;
wherein the fuel and the oxidant pass through a set of conduits in fluid communication with the propellant locus and the propulsion locus to reach the propulsion locus and to enter one or more combustion chambers disposed therein;
wherein the fuel and the oxidant undergo combustion in the one or more combustion chambers, thereby generating energy and producing exhaust gases that are expelled in an exit path from the propulsion locus to create thrust that exert thrust in a forward direction; and
wherein the radiator has a proximal end that is affixed to the propulsion locus and a distal end that is open, wherein the radiator is disposed circumferentially around the exit path to circumscribe at least a portion of the exit path, and wherein the radiator is secured to the payload pod with a set of long struts and is secured to the propellant locus by a set of shorter struts.

In embodiments, the vehicle is capable both of flying through the air aerodynamically and of operating in a vacuum environment. In embodiments, the payload comprises living beings. In embodiments, at least one of the payload pod and the propellant locus has a reflective surface. In embodiments, the electrical power bay provides power for one or more secondary functions. In embodiments, the propellant locus comprises a first set of one or more RAs for instantiating the fuel and a second set of one or more RAs for instantiating the oxidant, and the propellant locus can comprise a third set of RAs for instantiating a propellant adjuvant wherein the propellant adjuvant is delivered to the propulsion locus to mix with the fuel and the oxidant in the one or more combustion chambers. The vehicle can further comprise a set of conduits in fluid communication with the propellant locus and the one or more combustion chambers, and wherein the fuel and oxidant pass through the set of conduits to reach the one or more combustion chambers. In embodiments, the set of conduits is in fluid communication with a premixing chamber that is in fluid communication with the one or more combustion chambers, wherein the fuel and the oxidant enter the premixing chamber and mix therein to create a combustible mixture comprising fuel and oxidant, and wherein the combustible mixture enters the one or more combustion chambers to undergo combustion therein. In embodiments, the energy comprises heat energy, and the heat energy is dissipated at least in part by the radiator. In embodiments, the vehicle further comprises a heat discharge or cooling subsystem, which can comprise one or more RA devices that assemble a substance suitable for extracting excess heat from one or more components of the vehicle. In embodiments, the vehicle further comprises radiation shielding, which can be instantiated in whole or in part by a RA system.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of an E/MEE of the invention.

FIGS. 2A and 2C show reactor assembly components. FIG. 2B is an expanded view of the reactor assembly components of FIG. 2A.

FIG. 3A, FIG. 3B, FIG. 3C, FIG. 3D and FIG. 3E provides five views of coils which can be used in a reactor assembly.

FIG. 4A is a perspective view of an E/MEE of the invention used in carbon pretreatment.

FIG. 4B shows reactor assembly components.

FIG. 5A illustrates one conformation for a standard coil. FIG. 5B illustrates one conformation for a reverse field coil.

FIGS. 6A and 6B are illustrations of two examples of two composite reactor assemblies. FIG. 6A illustrates a Composite Reactor with a copper body, carbon graphite cup and a carbon graphite cap and a metal foil boundary. FIG. 6B illustrates a Composite Reactor with a carbon graphite body and cap and metal foil boundary.

FIGS. 7A-7I illustrate various reactor assembly views according to the invention.

FIGS. 8A-8C are illustrations of reactor variations.

FIG. 9 is a diagram of an exemplary system comprising a reactor assembly.

FIG. 10 is a more detailed block diagram of the system illustrated in FIG. 9.

FIG. 11 is a block diagram of an exemplary expulsive combustion engine system.

FIGS. 12A-F depict various aspects of an embodiment of a vehicle.

FIGS. 12G-H are block diagrams of systems comprising reactor assemblies that are suitable for use in vehicles.

FIGS. 13A-C depict, in various projections, an embodiment of a vehicle.

FIGS. 14A-B depict, in various projections, an embodiment of a vehicle.

FIGS. 15A-B depict, in various projections, an embodiment of a vehicle.

### DETAILED DESCRIPTION

The invention relates to methods of instantiating fuels (a type of “chemical reactants”) in nanoporous carbon powders. As used herein, the term “fuel” refers to a chemical substance that reacts with other chemical substances to release energy that is used for work. Chemical reactants produced by the methods and apparatuses disclosed herein can be formed as fluids, (preferably gases), solids, or other states of matter.

The invention involves the production of a chemical reactant to be employed as a fuel substance, using methods comprising the steps of contacting a bed comprising a nanoporous carbon powder with a feedgas composition, and optionally an electromagnetically activated gas, while applying electromagnetic radiation to the nanoporous carbon powder for a time sufficient to cause instantiation within and/or from carbon nanopores. The process results in a product composition comprising a chemical reactant substantially distinct from the feed gas composition. The processes of the invention have broad applicability in producing chemical reactants useful as fuels. Such fuels can be utilized for producing energy and/or for producing other valuable substances.

The invention relates to the discovery that carbon matrices can be used to instantiate or filter, or isolate, or extract, or nucleate, a variety of substances, for example producing nano-deposits, nanostructures, nanowires and nuggets comprising metals or non-metals, by employing processes that include the application of electromagnetic radiation, directly and/or indirectly, to gases, nano-porous carbon, or compositions and combinations thereof, thereby pre-treating these materials, and thereafter exposing a carbon matrix to pre-treated gas in an apparatus to cause metal or non-metal instantiation, nucleation, growth and/or deposition within the carbon matrix.

In more detail, the invention relates to methods of instantiating chemical substances in any form, whether fluid (preferably gaseous), solid, or other. In embodiments, the invention produces metals and non-metals in nanoporous carbon matrices, through processes comprising the steps of contacting a bed comprising nanoporous carbon with an activated gas while applying electromagnetic radiation to the nanoporous carbon for a time sufficient to cause instantiation, including but not limited to nucleation, growth deposition and/or agglomeration, of elemental metal or non-metal nanoparticles within and/or from carbon nanopores and nano-pore networks and matrices. Such processes result in nanoporous carbon compositions or matrices characterized by elemental metals and/or non-metals deposited within carbon nanopores and agglomerated elemental nanoparticles, creating elemental metal nuggets, nanonuggets, nanowires and other macrostructures that can be easily separated from the nanoporous carbon. In embodiments, these processes can produce elemental metal composition and macrostructures; in embodiments, the nanoporous carbon composition can also comprise non-metal nanostructures and/or macrostructures. In embodiments, the processes can instantiate, or filter, or isolate, or extract, or nucleate, materials containing carbon, oxygen, nitrogen, sulfur, phosphorous, selenium, hydrogen, and/or halides (e.g., F, Cl, Br and I). Nanoporous carbon compositions further comprising metal oxides, nitrides, and sulfide such as copper oxide, molybdenum sulfide, aluminum nitride have been identified. Therefore, small inorganic molecules or compounds (e.g., molecules comprising 2, 3, 4, 5, 6, 7, 8, 9 or 10 or 25 atoms) can be instantiated, or filtered, or isolated, or extracted, or nucleated, using the processes disclosed herein. Examples of such small molecules include carbides, oxides, nitrides, sulfides, phosphides, halides, carbonyls, hydroxides, hydrates including water, clathrates, clathrate hydrates, and metal organic frameworks. In embodiments, the processes disclosed herein produce small molecules or other materials useful as fuels. In embodiments, such fuels comprise a fluid (preferably gaseous) selected from the group consisting of hydrogen (H₂), carbon (C), carbon monoxide (CO), ammonia (NH₃), a substituted or unsubstituted hydrocarbon, a hydrocarbon derivative, and a carbohydrate. In embodiments, the chemical reactant comprises a substituted or unsubstituted hydrocarbon selected from the group consisting of alkanes, cycloalkanes alkenes, alkynes, and substituted or unsubstituted aromatic hydrocarbons, and can comprise a C₁-C₄ alkane, a C₅-C₈alkane, a C₉-C₁₆ alkane, or an alkane containing 17 or more carbon atoms.

### 1. Nanoporous Carbon Powders and Compositions

a. Nanoporous Carbon Powders

Nanoporous carbon powders or nanostructured porous carbons can be used in the processes and methods of the invention. Nanoporous carbon powders or nanostructured porous carbons are also referred to herein as “starting material” or “charge material.” The carbon powder preferably provides a surface and porosity (e.g., ultra-microporosity) that enhances metal deposition, including deposit, instantiation and growth. Preferred carbon powders include activated carbon, engineered carbon, graphite, and graphene. For example, carbon materials that can be used herein include graphene foams, fibers, nanorods, nanotubes, fullerenes, flakes, carbon black, acetylene black, mesophase carbon particles, microbeads and, grains. The term “powder” is intended to define discrete fine, particles or grains. The powder can be dry and flowable or it can be humidified and caked, such as a cake that can be broken apart with agitation. Although powders are preferred, the invention contemplates substituting larger carbon materials, such as bricks and rods including larger porous carbon blocks and materials, for powders in the processes of the invention.

The examples used herein typically describe highly purified forms of carbon, such as >99.995% wt. pure carbon (metals basis). Highly purified forms of carbon are exemplified for proof of principal, quality control and to ensure that the results described herein are not the result of cross-contamination or diffusion within the carbon source. However, it is contemplated that carbon materials of less purity can also be used. Thus, the carbon powder can comprise at least about 95% wt. carbon, such as at least about 96%, 97%, 98% or 99% wt. carbon. In a preferred embodiment, the carbon powder can be at least 99.9%, 99.99% or 99.999% wt. carbon. In each instance, purity can be determined on either an ash basis or on a metal basis. In another preferred embodiment, the carbon powder is a blend of different carbon types and forms. In one embodiment, the carbon bed is comprised of a blend of different nano-engineered porous carbon forms. Carbon powders can comprise dopants.

The carbon powder preferably comprises microparticles. The volume median geometric particle size of preferred carbon powders can be between less than about 1 μm and 5 mm or more. Preferred carbon powders can be between about 1 μm and 500 μm, such as between about 5 μm and 200 μm. Preferred carbon powders used in the exemplification had median diameters between about 7 μm and 13 μm and about 30 μm and 150 μm.

The dispersity of the carbon particle size can improve the quality of the products. It is convenient to use a carbon material that is homogeneous in size or monodisperse. Thus, a preferred carbon is characterized by a polydispersity index of between about 0.5 and 1.5, such as between about 0.6 and 1.4, about 0.7 and 1.3, about 0.8 and 1.2, or between about 0.9 and 1.1. The polydispersity index (or PDI) is the ratio of the mass mean diameter and number average diameter of a particle population. Carbon materials characterized by a bimodal particle size can offer improved gas flow in the reactor.

The carbon powder is preferably porous. The pores, or cavities, residing within the carbon particles can be macropores, micropores, nanopores and/or ultra-micropores. A pore can include defects in electron distribution, compared to graphene, often caused by changes in morphology due to holes, fissures or crevices, corners, edges, swelling, or changes in surface chemistry, such as the addition of chemical moieties or surface groups, etc. For example, variation in the spaces that may arise between layers of carbon sheets, fullerenes or nanotubes are contemplated. It is believed that instantiation preferentially occurs at or within a pore or defect-containing pore and the nature of the surface characteristics can impact instantiation. For example, Micromeritics enhanced pore distribution analysis (e.g., ISO 15901-3) can be used to characterize the carbon. It is preferred that the carbon powder is nanoporous. A “nanoporous carbon powder” is defined herein as a carbon powder characterized by nanopores having a pore dimension (e.g., width or diameter) of less than 100 nm. For example, IUPAC subdivides nanoporous materials as microporous (having pore diameters between 0.2 and 2 nm), mesoporous materials (having pore diameters between 2 and 50 nm) and macroporous materials (having pore diameters greater than 50 nm). Ultramicropores are defined herein as having pore diameters of less than about 1 nm.

Uniformity in pore size and/or geometry is also desirable. For example, ultramicropores in preferred carbon materials (e.g., powders) account for at least about 10% of the total porosity, such as at least about 20%, at least about 30%, at least about 40%, at least about 50%, at least about 60%, at least about 70%, at least about 80%, or at least about 90%. Preferred carbon materials (e.g., powders) are characterized with a significant number, prevalence or concentration of ultra-micropores having the same diameter, thereby providing predictable electromagnetic harmonic resonances and/or standing wave forms within the pores, cavities, and gaps. The word “diameter” in this context is not intended to require a spherical geometry of a pore but is intended to embrace a dimension(s) or other characteristic distances between surfaces. Accordingly, preferred carbon materials (e.g., powders) are characterized by a porosity (e.g., nanopores or ultramicropores) of the same diameter account for at least about 10% of the total porosity, such as at least about 20%, at least about 30%, at least about 40%, at least about 50%, at least about 60%, at least about 70%, at least about 80%, or at least about 90%.

Measuring adsorption isotherm of a material can be useful to characterize the surface area, porosity, e.g., external porosity, of the carbon material. Carbon powders having a surface area between about 1 m²/g and 3000 m²/g are particularly preferred. Carbon powders having an ultramicropore surface area of at least about 50 m²/g, preferably at least about 300 m²/g, at least about 400 m²/g, at least about 500 m²/g or higher are particularly preferred. Activated or engineered carbons, and other quality carbon sources, can be obtained with a surface area specification. Surface area can be independently measured by BET surface adsorption technique.

Surface area correlation with metal deposition was explored in a number of experiments. Classical pore surface area measurements, using Micromeritics BET surface area analytical technique with nitrogen gas at 77K (−196.15C) did not reveal a substantial correlation in the deposition of metal elements at ≥5% confidence level, or probability of coincidence. However, a correlation with ultramicropores (pores having a dimension or diameter of less than 1 nm) was observed. Without being bound by theory, instantiation is believed to be correlated to resonating cavity features of the ultra-micropore and ultramicropore network such as the distance between surfaces or walls. Features of the ultramicropore, can be predicted from ultramicropore diameter as measured by BET, augmented by density function theory (DFT) models, for example. With the aid of machine learning, more precise relationships between ultramicropore size, distribution, turbostratic features, wall separation and diameter and elemental metal nucleation can be established.

Carbon materials and powders can be obtained from numerous commercial providers. MSP-20X and MSC-30 are high surface area alkali activated carbon materials with nominal surface areas of 2,000-2,500 m²/g and >3,000 m²/g and median diameters of 7-13 μm and 60-150 μm respectively (Kansai Coke & Chemicals Co). Norit GSX is a steam-washed activated carbon obtained from Alfa Aesar. The purified carbon forms used in the experimental section all exceed ≥99.998_{wt} % C (metals basis).

Modifying the surface chemistry of the carbon can also be desirable. For example, improved performance was observed when conditioning the carbon with an acid or base. Contacting the carbon with a dilute acid solution selected from the group consisting of HCl, HF, HBr, HI, sulfuric acid, phosphoric acid, carbonic acid, and nitric acid followed by washing with water (such as deionized water) can be beneficial. The acid is preferably in an amount less than about 30%, less than about 25%, less than about 20% less than about 15%, less than about 10%, or less than about 5%, preferably less than or equal to 1% vol. The preferred acid for an acid wash is an acid having a pKa of less than about 3, such as less than about 2. After washing, it can be beneficial to subject the carbon to a blanket of a gas, such as helium, hydrogen or mixtures thereof. Alternative gases include, without limitation, carbon monoxide, carbon dioxide, nitrogen, argon, neon, krypton, helium, ammonia and hydrogen. The carbon can also be exposed to a base, such as KOH before or after an acid treatment.

Controlling residual water content in the carbon which may include moisture can improve performance. For example, the carbon material can be placed in an oven at a temperature of at least about 100° C., preferably at least about 125° C., such as between 125° C. and 300° C. for at least 30 minutes such as about an hour. The oven can be at ambient or negative pressure, such as under a vacuum. Alternatively, the carbon material can be placed in an oven with high vacuum at a temperature of at least about 250° C., preferably at least about 350° C., for at least one hour, such as at least 2, 3, 4, 5, or 6 hours. Alternatively, the carbon material can be placed in an oven with high vacuum at a temperature of at least about 700° C., preferably at least about 850° C., for at least one hour, such as at least 2, 3, 4, 5, or 6 hours. Alternatively, the water or moisture can be removed by vacuum or lyophilization without the application of substantial heat. Preferably, the water, or moisture, level of the carbon is less than about 35%, 30%, 25%, 20%, 15%, 10%, 5%, such as less than about 2%, by weight carbon. In other embodiments, the carbon can be exposed to a specific relative humidity (RH) such as 0.5%, 1%, 2%, 5%, 12% RH or 40% RH or 70% RH or 80% RH or 90% RH, for example, at 22° C.

Pre-treatment of the carbon material can be selected from one or more, including all, the steps of purification, humidification, activation, acidification, washing, hydrogenation, drying, chemistry modification (organic and inorganic), and blending. For example, the carbon material can be reduced, protonated or oxidized. The order of the steps can be as described, or two or more steps can be conducted in a different order.

For example, MSP-20X was exposed to an alkali (C:KOH at a molar ratio of 1:0.8), activated at 700° C. for 2 hours, washed with acid and then hydrogenated to form MSP-20X Lots 1000 when washed with HCl and 105 when washed with HNO3. MSP-20X was washed with acid and then hydrogenated to form MSP-20X Lots 1012 when washed with HCl and 1013 when washed with HNO3. Activated carbon powder developed for the storage of hydrogen was HCl acid washed, then subjected to HNO3 washing and hydrogenation to form APKI lots 1001 and 1002, as substantially described in Yuan, J. Phys. Chem. B20081124614345-14357]. Poly(ether ether ketone) (PEEK, Victrex 450P) and poly(ether imide) (PEI, Ultem® 1000) was supplied by thermally oxidized in static air at 320° C. for 15 h, and carbonized at the temperature range of 550-1100° C. in nitrogen atmosphere, at the carbon yield of 50-60_{wt} %. These carbons were then activated by the following procedures: (1) grind the carbonized polymer with KOH at KOH/carbon˜1/1-1/6 (w/w), in the presence of alcohol, to form a fine paste; (2) heat the paste to 600-850° C. in nitrogen atmosphere for 2 h; (3) wash and rinse with DI water and dry in vacuum oven. PEEK/PEI (50/50 wt) blend was kindly supplied by PoroGen, Inc. Likewise, the acid washing sequence of Lots 1001 and 1002 was reversed to form APKI lots 1003 and 1004. Universal grade, natural graphite, ˜200 mesh was purchased from Alfa Aesar, product number 40799. Graphite lots R and Z were HCl washed and hydrogenated to form R lot 1006 and Z lot 1008, respectively. Alfa Aesar graphite R and Z were nitric acid washed and hydrogenated to form R lot 1007 and Z lot 1009, respectively. MSC-30 (Kansai Coke and Chemicals) was acid washed and then hydrogenated to form MSC30 lots 1010 when washed with HCl and 1011 when washed with HNO3. MSC-30 was exposed to an alkali (C:KOH at a molar ratio of 1:0.8), activated at 700 C for 2 hours, HCl or nitric acid washed and then hydrogenated to form MSC-30 lots 1014 (HCl washed) and 1015 (HNO3 washed), respectively. MSP-20X, MSC-30, Norit GSX and Alfa Aesar R were subjected to purification by MWI, Inc. for MSP-20X Lots 2000 and 2004, MSC-30 Lots 2001, 2006 and 2008, Norit GSX Lots 2005 and 2007, and Alfa Aesar R Lot 2009 respectively. MSP-20X Lot 2000 and MSC-30 2001 were HCl washed and hydrogenated to form MSP-20X Lot 2002 and MSC-30 Lot 2003, respectively. Alfa Aesar R was washed with 1%, 5%, 10%, 15%, 20%, 25%, and 30% HCl (vol.) and then hydrogenated to for R Lot Graphite n % vol HCl, respectively. Purified MSP-20X (Lot 2006) was similarly washed by HCl, nitric acid, HF or H₂SO₄ to form MSP-20X 1% HCl, MSP-20X 1% HNO3, MSP-20X 0.4% HF, MSP-20X 0.55% H₂SO₄ (Lot 1044), respectively. Purified Norit GSX (Lot 2007) was similarly washed by nitric acid, HF or H₂SO₄ to form Norit GSX 1% HNO3 (Lot 1045), Norit-GSX 0.4% HF, Norit-GSX 0.55% H₂SO₄, respectively. Purified MSC30 (Lot 2008) was similarly washed by HCl and H₂SO₄ to form MSC30 1% HCl, and MSC30 5% H₂SO₄. Purified MSP20X (Lot 2006), Norit GSX (Lot 2007) and MSC30 (Lot 2008) were hydrogenated. Purified MSP-20X, Norit GSX and MSC30 were washed with 1% HCl using methanol as a wetting agent. APKI-S-108 Lots 1021-1024 were recycled. The Ref-X Blend is a 40% Alfa Aesar R: 60% MSP-20X (lot 2006) 850° C. desorb then CO₂ exposure at 138 kPa (20 psi) for 5 days.

It is preferred to degas the nanoporous carbon powder can be degassed prior to initiating the process. For example, the nanoporous carbon powder can be degassed by subjecting the powder to a vacuum. A range of vacuums can be used, with or without elevated temperatures. It has been found that applying a vacuum of about 10⁻² torr to 10⁻⁶ torr was sufficient. The powder can be degassed prior to charging the powder into the reactor chamber. Preferably the powder can be degassed after the powder is charged into the reactor chamber. In the examples below, which are non-limiting, the carbon powder is charged into the reactor chamber, placed into the reactor assembly and the entire reactor assembly is subjected to a degassing step by maintaining the reactor assembly under vacuum. The degassing step can be performed at ambient temperature or an elevated temperature. For example, good results were achieved at a temperature of 400 C. Other temperatures can be at least 50 C, such as at least 100 C, at least 150 C, at least 200 C, or at least 300 C. The degassing step can be maintained for at least 30 minutes, such as at least 45 minutes, at least 60 minutes, at least 4 hours, at least 6 hours, at least 12 hours, or at least 24 hours. Degassing the carbon powder ensures that contaminant elements have been removed from the system.

The carbon can be recycled or reused. In recycling the carbon, the carbon can optionally be subjected to an acid wash and/or water removal one or more times. In this embodiment, the carbon can be reused one or more times, such as 2, 3, 4, 5, 10, 15, 20, or about 25 or more times. The carbon can also be replenished in whole or in part. It has been discovered that recycling or reusing the carbon can enhance metal nanostructure yields and adjust nucleation characteristics enabling change in element selectivity and resultant distributions. Thus, an aspect of the invention is to practice the method with recycled nanoporous carbon powder, e.g., a nanoporous carbon powder that has been previously subjected to a method of the invention one or more times.

b. Nanoporous Carbon Compositions

The nanoporous carbon compositions produced by the processes described herein possess several surprising and unique qualities. The nanoporosity of the carbon powder is generally retained during processing and can be confirmed, for example, visually with a scanning electron microscope or modeled by BET analysis. Visual inspection of the powder can identify the presence of elemental nanostructures residing within and surrounding the nanopores. The nanostructures can be elemental metals or non-metals. Visual inspection of the powder can also identify the presence of elemental macrostructures residing within and surrounding the nanopores. The macrostructures can be elemental metals or nonmetals, and can contain interstitial and/or internal carbon, as generally described by Inventor Nagel in U.S. Pat. Nos. 10,889,892 and 10,844,483, each of which is incorporated herein by reference in its entirety. Methods for instantiating gases are described in U.S. Ser. No. 63/241,697 by Inventor Nagel, which is incorporated herein by reference in its entirety.

Typically, the porosity of the nanoporous carbon compositions will be at least about 70% of the porosity attributed to ultramicropores of the nanoporous carbon powder starting, or charge, material and having a total void volume that is about 40% or more of the bulk material volume. The pores, or cavities, residing within the carbon particles can be macropores, micropores, nanopores and/or ultra-micropores. A pore can include defects in electron distribution, compared to graphene, often caused by changes in morphology due to holes, fissures or crevices, edges, corners, swelling, dative bonds, or other changes in surface chemistry, such as the addition of chemical moieties or surface groups, etc. For example, the spaces that may arise between layers of carbon sheets, fullerenes, nanotubes, or intercalated carbon are contemplated. It is believed that instantiation preferentially occurs at or within a pore and the nature of the surface characteristics can impact the deposit. For example, Micromeritics enhanced pore distribution analysis (e.g., ISO 15901-3) can be used to characterize the carbon. It is preferred that the carbon powder is nanoporous. Chemical reactant products or product compositions useful as fuels that are produced by the process can be isolated or harvested from nanoporous carbon compositions.

### 2. Methods and Apparatus

Conceptually, the apparatus for baseline experimentation can be broken into two primary areas: Gas Processing and Reactor Assembly.

a. Gas Processing:

The gas processing section controls gas composition and flow rate, with the optional embedding of electromagnetic (e.g., light) information or electromagnetic gas pre-treatment to the reactor. The invention includes an electromagnetic embedding enclosure (E/MEE or EMEE), or apparatus, for processing a gas (feed gas or first gas composition, used interchangeably herein) comprising or consisting of:
a central processing unit and power supply;
one or more gas supplies;
a housing having a housing inlet and housing outlet;
an upstream gas line that is in fluid connection with each gas supply and the housing inlet;
an internal gas line in fluid connection with the housing inlet and housing outlet;
a downstream gas line in fluid connection with the housing outlet;
at least one pencil lamp positioned below the internal gas line, at least one pencil lamp positioned above the internal gas line and/or at least one pencil lamp positioned to the side of the internal gas line;
an optional short-wave lamp and/or a long wave lamp; and
an optional coil wrapped around the internal gas line, operably connected to a frequency generator;
   wherein each lamp is independently rotatably mounted, located along the length of the internal gas line, and powered by the power supply; and
   wherein the central processing unit independently controls powering the frequency generator, if present, and each lamp and the rotation position of each lamp.
      It will be understood that spatial terms, such as “above,” “below”, “floor” and “to the side” are relative to a particular specified object or other point of reference. Thus, a lamp, for example, that is positioned “above” a gas line takes its orientation from the gas line as reference point; if the gas line is positioned “above” the floor of the room in which the apparatus is housed, the lamp positioned “above” the gas line is also “above” the floor. A lamp that is positioned “above” the floor does not have a designated position with respect to a gas line that is also positioned “above” the floor unless the lamp's position is also specified with reference to said gas line. In other words, if one were to draw X, Y and Z axes through a particular assembly or apparatus, the terms “above,” “below” and “to the side” is intended to only refer to positions relative to such axes and not as the axes would be drawn relative to the space or room in which the assembly resides.

Feed gases can preferably be research grade or high purity gases, for example, as delivered via one or more gas supplies, such as a compressed gas cylinder. Examples of gases that can be used include, for example and without limitation, air, oxygen, nitrogen, helium, neon, argon, krypton, xenon, ammonium, carbon monoxide, carbon dioxide and mixtures thereof. Preferred gases include nitrogen, helium, argon, carbon monoxide, carbon dioxide and mixtures thereof. Nitrogen, air and helium are preferred. In the examples below, a highly purified nitrogen gas was used. The use of highly purified nitrogen gas facilitated product gas analysis. The feed gas can be added continuously or discontinuously, throughout the process. The gases can be free of metal salts and vaporized metals.

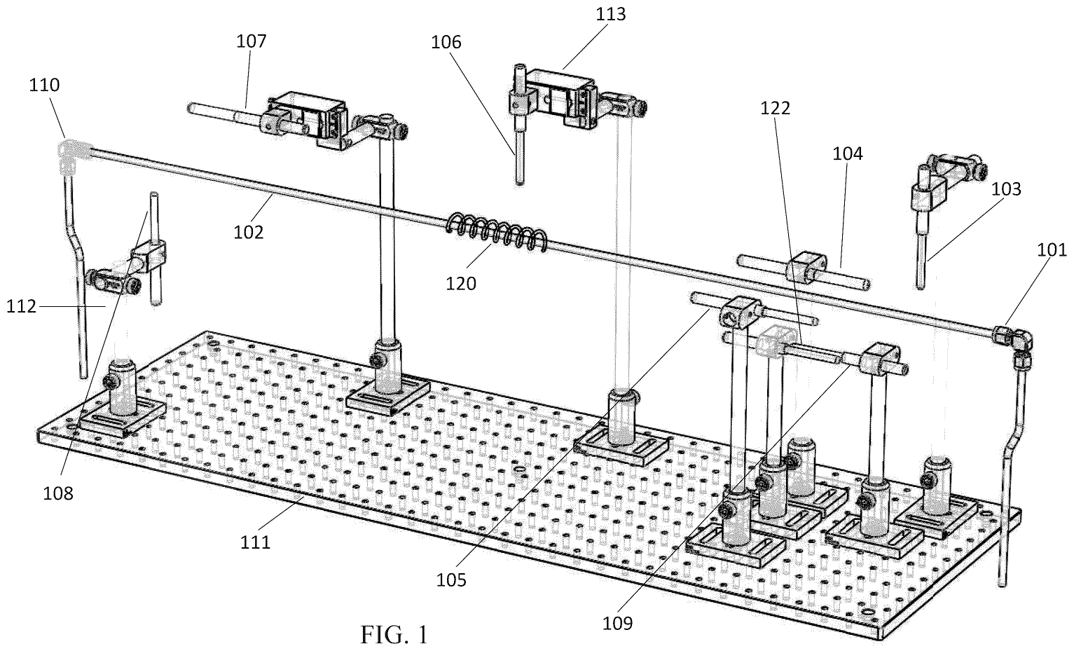

One or more gases (e.g., 2, 3, 4, 5, or more gases) can optionally pass through a gas manifold comprising mass flow meters to produce a feedgas composition, also called the reactor feed gas. The reactor feedgas may then either by-pass an electromagnetic (EM) embedding enclosure (E/MEE) or pass through one or more E/MEEs. The E/MEE exposes the reactor feed gas to various electromagnetic field (EMF) sources. Flow rates, compositions, and residence times can be controlled. The rate of flow of the reactor feed gas can be between 0.01 standard liters per minute (SLPM) and 10 SLPM, or 100 SLPM or more. A constant flow of gas can maintain a purged environment within the reactor. The schematics shown in FIG. 1 depicts a flow path for the gases through a sample E/MEE. The sample E/MEE comprises a series of lights and coils that can optionally expose the reactor feed gas to EM radiation. EMF sources within the E/MEE can be energized simultaneously or in sequence or a combination thereof.

FIG. 1 is an illustration of an E/MEE of the invention for the production of gaseous chemical reactants. Gas enters the E/MEE via the inlet 101, or entrance, in line 102 and exits at the outlet, or exit, 110. The inlet 101 and outlet 110 may optionally have valves.

Line 102 can be made of a transparent or translucent material (glass is preferred) and/or an opaque or non-translucent material, such as stainless steel or non-translucent plastic (such as TYGON® manufactured by Saint-Gobain Performance Plastics) or a combination thereof. Using an opaque material can reduce or eliminate electromagnetic exposure to the gas as the gas resides within the line. The length of line 102 can be between 50 cm and 5 meters or longer. The inner diameter of line 102 can be between 2 mm and 25 cm or more. Line 102 can be supported on and/or enclosed within a housing or substrate 111, such as one or more plates, with one or more supports 112. For example, substrate 111 can be configured as a plane or floor, pipe or box. Where the substrate is a box, the box can be characterized by a floor, a ceiling and side walls. The box can be closed to and/or insulated from ambient EM radiation, such as ambient light.

One or more lamps (such as 2, 3, 4, 5, 6, 7, 8, 9, 10 lamps or more) can be configured within the E/MEE. Lamps (numbered individually) are preferably pencil lamps characterized by an elongated tube with a longitudinal axis. The pencil lamps can independently be placed such that their longitudinal axes are (i) parallel to the line 102, (ii) disposed radially in a vertical plane to the line 102, or (iii) perpendicular to the plane created along the longitudinal axis of the line 102 or along the vertical axis of the line 102.

Each lamp can, independently, be fixed in its orientation by a support 112. Each lamp can, independently, be affixed to a pivot 113 to permit rotation from a first position. For example, the lamps can be rotated between about 0 and 360 degrees, such as about 45, 90, 135, 180, 225 or 270 degrees, preferably about 90 degrees relative to a first position. The rotation can be with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

Referring to the specific pencil lamps within an E/MEE, line 102 is configured along the E/MEE with gas flowing from the inlet 101 and exiting at the outlet 110. Lamp 103, a neon lamp, is first and is shown above line 102 oriented to be along the z-axis and perpendicular to line 102, with the tip of the lamp pointed towards line 102. Lamp 109, a krypton lamp, is shown below line 102 oriented to be parallel to the x-axis, with the tip pointing towards the outlet 110. Lamps 104 and 105, a long wave and short-wave lamp, respectively, are shown parallel to line 102 oriented to be along the x-axis with the tips pointing towards the inlet. Lamp 122, an argon lamp, is shown to be below line 102 oriented to be parallel to the x-axis, with the tip pointing towards the inlet 101 at approximately the same distance from the inlet as lamps 104 and 105. Lamp 106, a neon lamp, is downstream at about the midpoint of the E/MEE, is above line 102 with the tip pointing down. Lamp 107, a xenon lamp, is shown downstream of lamp 106 above line 102, parallel to the x axis of line 102 and points toward the outlet 110. Lamp 108, an argon lamp, is below line 102 and the tip is pointing toward line 102 along the z-axis. Optional coil 120 is wrapped around line 102. Each of these lamps can be independently rotated, for example, 90 degrees along any axis. Each lamp is connected to a power supply or power source to turn on or off the power. Each lamp can be independently rotated 1, 2, 3, 4 or more times during the process. For convenience, each lamp is held by a pivot that can be controlled by a central processing unit, such as a computer programmed to rotate the pivot and provide power to each lamp. For the case of describing the experimental procedures, each orientation of each lamp is called “position n” wherein n is 0, 1, 2, 3, 4, or more. As the procedure is conducted, each lamp can be powered for specific periods of time at specific amperage(s) and positioned or repositioned.

In the exemplification described below, the initial bulb position for each lamp is described with a degree. A zero-degree (0°) reference point is taken as the 12 o'clock position on the glass pipe when looking down the gas pipe in the direction of intended gas flow (e.g., when looking at the E/MEE exit). The length of the glass pipe or line is taken as the optical length (e.g., in this instance 39 inches). For example, 6 inches from the end is defined as 6 inches from the optical end of pipe.

The lamps can be placed above, below, or to the side (for example, level with the longitudinal axis or a plane parallel to (above or below) the longitudinal axis), for example, of line 102. The lamps can be independently placed between 5 and 100 cm from the center of the line 102 in the vertical plane, as measured from the tip of the lamp to the center of line 102. One or more lamps can be placed in the same vertical plane along line 102, as illustrated by lamps 122, 104, and 105. Two lamps are in the same vertical plane if they (as defined by the tip or base of the lamp) are the same distance from the inlet 101. Preferably, lamp 105 can be placed in a plurality of (e.g., 2, 3, 4, 5 or more) vertical planes along the length of line 102 within the E/MEE. Further, one or more lamps can be placed in the same horizontal plane above, below or through line 102, as shown with lamps 104 and 105. Two lamps are in the same horizontal plane if they (as defined by the tip or base of the lamp) are the same distance from the center of line 102. Preferably, lamps can be placed in a plurality of (e.g., 2, 3, 4, 5 or more) horizontal planes along the length of line 102 within the E/MEE, as generally illustrated.

It is understood that “pencil lamps,” as used herein, are lamps filled with gases or vapor that emit specific, calibrated wavelengths upon excitation of the vapor. For example, pencil lamps include without limitation argon, neon, xenon, and mercury lamps. For example, without limitation, one or a plurality of lamps can be selected from argon, neon, xenon or mercury or a combination thereof. Preferably, at least one lamp from each of argon, neon, xenon and mercury are selected. Wavelengths between 150 nm and 1000 nm can be selected. One example of a pencil lamp is a lamp characterized by an elongated tube having a tip and a base.

Long wave and/or short-wave ultraviolet lamps can also be used. Pencil lamps used in the E/MEE were purchased from VWR™ under the name UVP Pen_Ray® rare gas lamps, or Analytik Jena in the case of the UV short wave lamps.

A power supply is operably connected to independently to each lamp, E/MEE coil, and frequency generator. The power supply can be AC and/or DC.

The E/MEE can be open or enclosed. Where the E/MEE is enclosed, the enclosure is typically opaque and protects the gas from ambient light. Without limitation, the enclosure can be made of a plastic or resin or metal. It can be rectangular or cylindrical. Preferably, the enclosure is characterized by a floor support.

In baseline experimentation the feed gas can by-pass the E/MEE section and are fed directly to the reactor assembly. The energy levels and frequencies provided by the EM sources can vary.

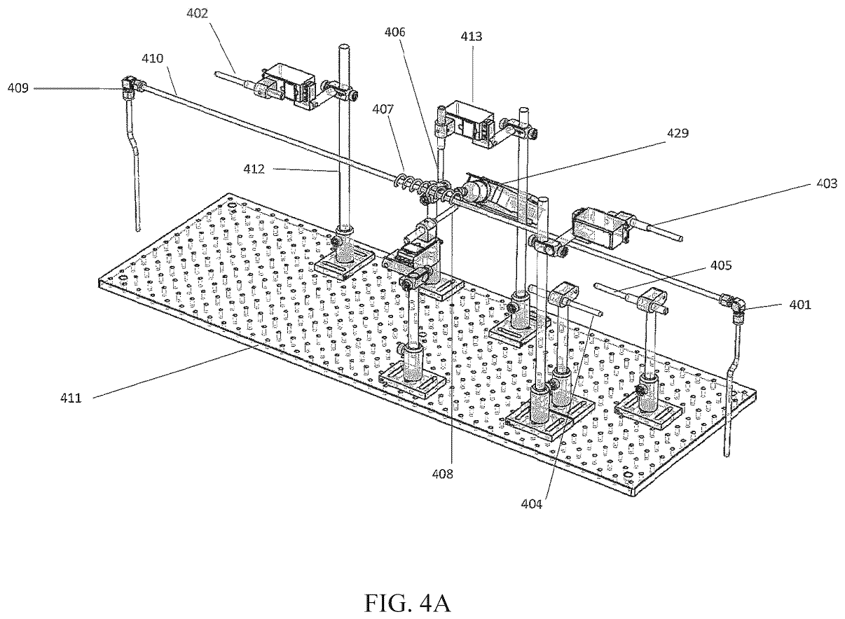

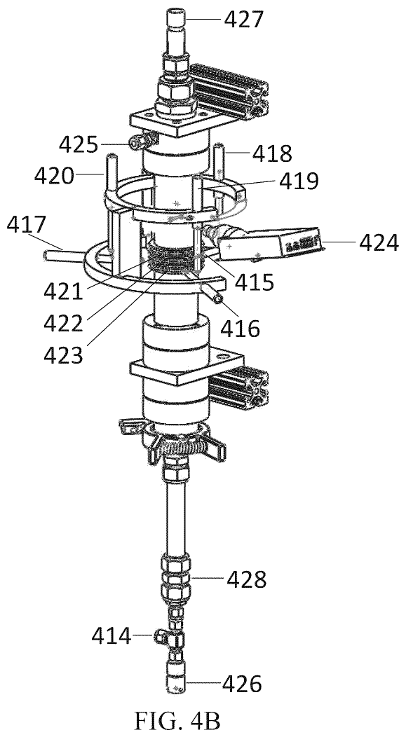

FIG. 4A provides a second illustration of an E/MEE of the invention. Gas enters the E/MEE at inlet 401 and exits at outlet 409 along line 410. Pencil lamp 402 and Pencil lamp 403 are shown parallel to and above line 410 along the vertical plane through line 410 axis. Pencil lamps 404 and 405 are parallel to and below line 410 in the same horizontal plane equidistant from the vertical plane through line 410. Pencil lamp 406 is shown above and perpendicular to line 410, positioned along the z axis. An optional coil 407 is a conductive coil wrapped around line 410. Pencil lamp 408 is shown below and perpendicular to line 410 along the y axis. Substrate 411 provides a base for supports 412. Pivots 413 control the position of each pencil lamp and permit rotation along axis x, y and z. An optional x-ray source 429 is also shown directed towards the coil 407.

The coil 407 is preferably made of conducting material and is connected to a power supply and, optionally, a frequency generator. The coil can comprise copper, aluminum, platinum, silver, rhodium, palladium or other metals or alloys (including braidings, platings and coatings) and can optionally be covered with an insulating coating, such as glyptal. It can be advantageous to use a braid of 1, 2, 3 or more metal wires. The coil can be manufactured from wire typically used in an induction coil and can vary in size and the number of turns. For example, the coil can comprise, 3, 4, 5, 6, 7, 8, 9, 10 or more turns. The inner diameter of the coil can be between 2 cm and 6 cm or more and preferably snugly fits the line 410. The wire used can have a diameter of between 5 mm and 2 cm. An x-ray source 429 can included in the E/MEE. For example, the x-ray source can be directed at line 410 along the line between the inlet 401 and outlet 409. For example, it can be advantageous to direct the x-ray source at coil 407, where present.

b. Reactor Assembly (RA):

The invention further relates to a reactor assembly comprising:
A gas inlet and one or more gas outlets;
A reactor chamber, preferably containing a nanoporous carbon material or powder;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
An optional reactor cup defining side walls of the reactor chamber;
An optional reactor cap positioned above the second porous frit;
A reactor body disposed below the first porous frit;
A reactor head space disposed above the reactor cap;
An optional foil disposed between the reactor chamber and reactor cup;
One or more coils surrounding the reactor body and/or the reactor chamber operably connected to a power supply and/or frequency generator;
An optional x-ray source configured to expose the reactor head space to x-rays;
One or more optional lasers configured to direct a laser towards a frit and/or through the reactor chamber;
A computer processing unit configured to control the power supply, frequency generator, lamps, lasers and x-ray source, when present.

The invention also includes a reactor assembly comprising:
A gas inlet and one or more gas outlets;
A reactor chamber, preferably containing a nanoporous carbon material;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
A reactor head space disposed above the reactor cap;
2, 3, 4, 5 or more RA coils surrounding the reactor chamber and/or reactor head space operably connected to an RA frequency generator and power supply;
2, 3, 4, 5 or more pairs of lamps wherein the pairs of lamps are disposed circumferentially around the RA coils and define a space between the pairs of lamps and the RA coils;
An optional x-ray source configured to expose the reactor chamber to x-rays;
One or more optional lasers configured to direct a laser through the reactor chamber; and
A computer processing unit configured to control the power supply, frequency generator and the optional x-ray source and lasers.

The invention also includes a reactor assembly comprising:
A gas inlet and one or more gas outlets;
A reactor chamber, preferably containing a nanoporous carbon material;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
A reactor head space disposed above the reactor chamber;
An induction coil surrounding the reactor chamber and/or reactor head space operably connected to a power supply; and
computer processing unit configured to control the power supply.
   The reactor chamber can optionally contain a cap and/or cup to contain the carbon material.

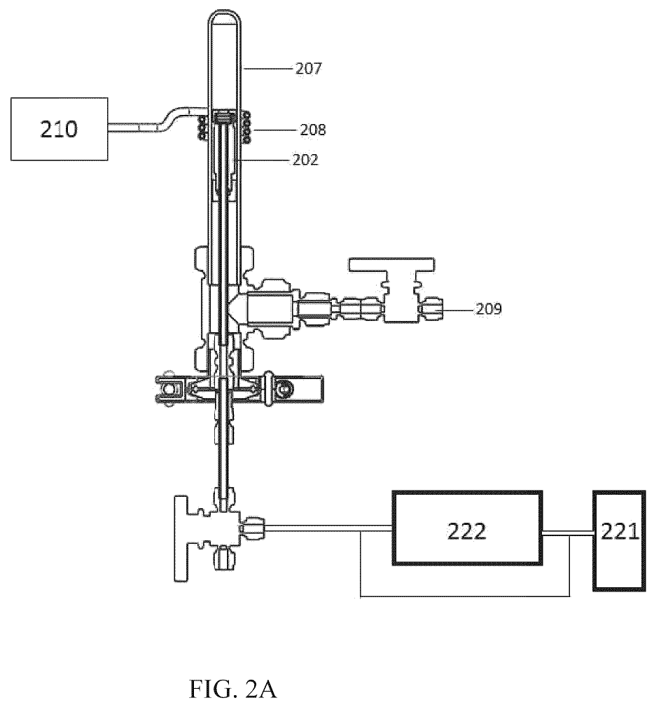

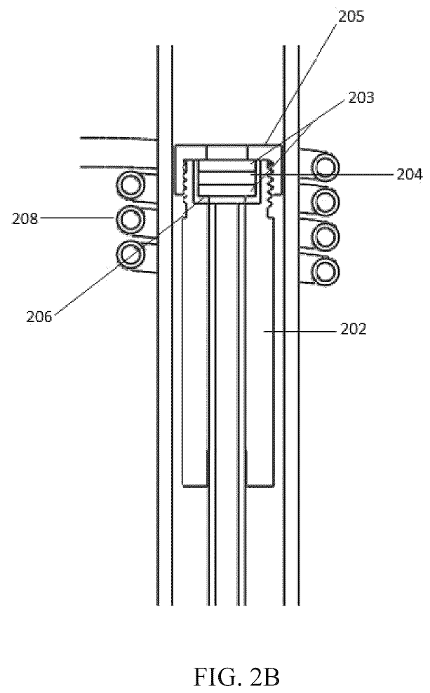

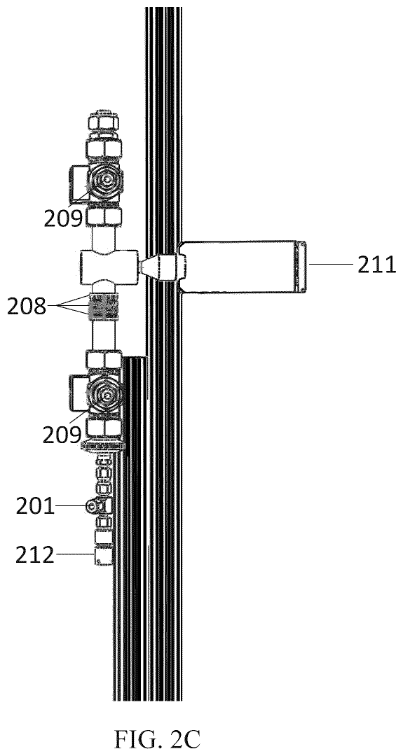

As shown in FIGS. 2A and 2B, the reactor assembly comprises a reactor body 202 and starting, or charge, material 204 (which is generally a nanoporous carbon powder) and is located downstream of the gas sources 221 and E/MEE 222, as shown in FIG. 2A. As described above, it is possible for reactor feed gas to bypass the E/MEE. The reactor body 202 can be a packed bed tubular micro-reactor surrounded by one or more conducting coils 208, as illustrated in FIGS. 2A, 2B, and 2C. FIG. 2A and FIG. 2B show cross sections of the reactor assembly.

The conducting coil 208 can be manufactured from electrically conducting material, such as copper, aluminum, platinum, silver, rhodium, palladium or other metals or alloys (including braidings, platings and coatings) and can optionally be covered with an insulating coating, such as glyptal. The coil can be manufactured from wire typically used in an induction coil and can vary in size and the number of turns. For example, the coil can comprise 3, 4, 5, 6, 7, 8, 9, 10 or more turns. The inner diameter of the coil can be between 2 cm and 6 cm or more and preferably snugly fits the reactor body containment 207. The wire used can have a diameter of between 5 mm and 2 cm.

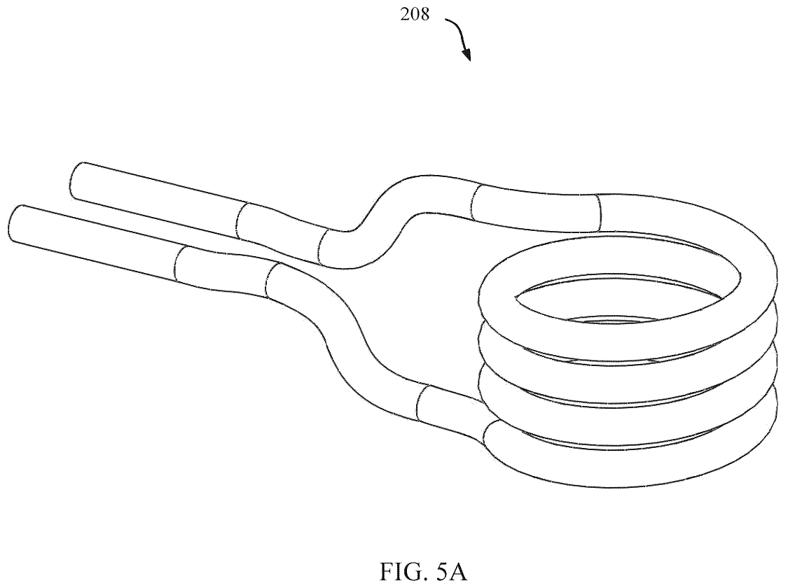

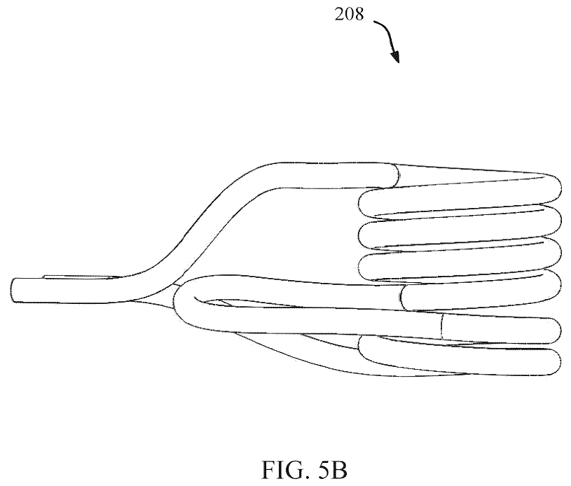

Each conducting coil 208 (or coils) can generate inductive heat and, optionally, a magnetic field. Standard induction coils or reverse field induction coils (coils that have a lower and upper sections connected through an extended arm that allows the sections to be wound in opposite directions, thereby producing opposing magnetic fields) are preferred. The coil 208 can be water-cooled via a heat exchanger. The coil can be connected to a power flange 210, which can be water cooled as well and in turn can connect to a power supply, such as an Ambrell 10 kW 150-400 kHz power supply. In baseline experimentation a standard coil was used with simple copper windings. The windings can form a coil 208 such that the connection to the power supply is at opposite ends of the coil FIG. 5A or the coil can return such that the connection to the power supply are adjacent, as shown in FIG. 5B.

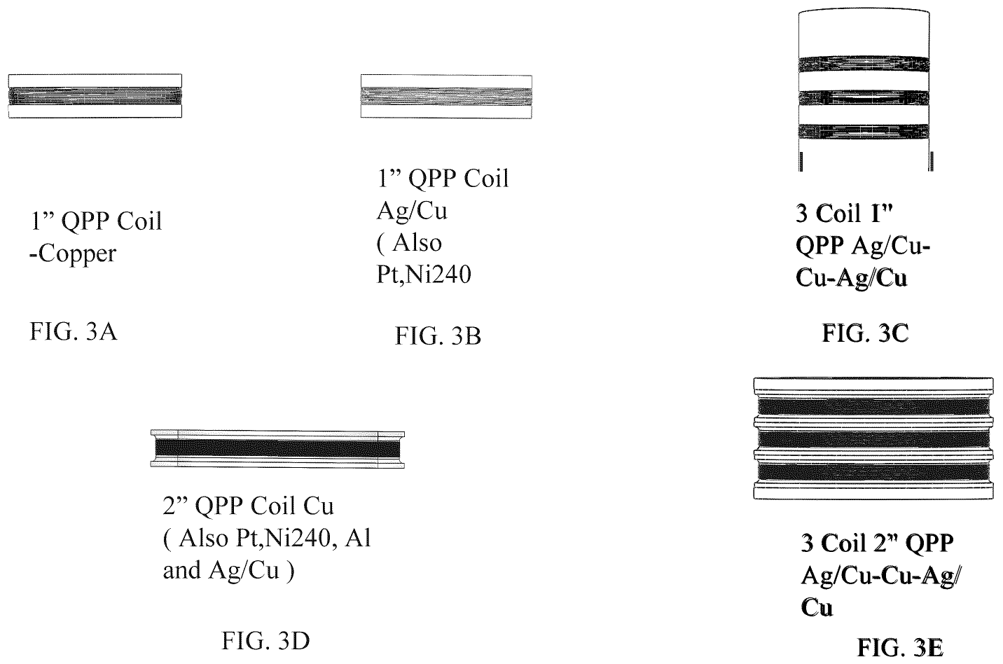

Referring to FIGS. 2A, 2B and 2C, the reactor assembly can optionally further comprise one or more coils 208, preferably surrounding the reactor body and its containment system. For example, the reactor assembly can comprise 1, 2, 3, 4, 5, 6, 7, 8, 9, or 10 or more coils, also called RA coils. As shown in FIG. 2B, one or more electromagnetic (E/M) coils can be used to provide magnetic fields. Preferably, 1, 2, 3, 4, or 5 or more E/M coils can be used, more preferably 3, 4, or 5 E/M coils. FIGS. 3A-3E shows groupings of three coils, for example, which can generally be numbered 1, 2, or 3, from top to bottom. A grouping of coils, as shown in FIGS. 3A-3E, can be called a boundary. Where a plurality of groupings is used, the number of coils used is independently selected. Further, the groupings can be equidistantly spaced along or irregularly spaced.

Coils can be manufactured from electrically conducting materials, such as, without limitation, copper, platinum, silver, rhodium, palladium and, wire braids or coated wires of two or more materials. Each coil in a grouping may be made of the same material or different. For example, a grouping can be made such that each coil is made of a different material. For example, a braiding of copper wire and silver wire can be used. Silver plated copper wire can be used. A first RA coil can be made of a copper winding. A second RA coil can be a copper/silver braid. A third RA coil can be a platinum wire winding. An RA coil can be configured to create a magnetic field and wherein each power supply independently provides AC and/or DC current. Any one or all RA coils can be optionally lacquered.

The coils are preferably circular in geometry. However, other geometries, such as rounded shapes, ellipses and ovoids can be used. The wire diameter can be between about 0.05 mm (>about 40 gauge) and about 15 mm (about 0000 gauge) or more. For example, the wire diameter can be between about 0.08 mm (about 40 gauge) and about 0.8 mm (about 20 gauge) wire. Excellent results have been obtained using 0.13 mm (36 gauge) wire. Coils can be wire windings (e.g., the wire can be wound in 1, 2, 3, 4, 5, 6, 7, 8, 9, 20, or more turns or can be a single turn. In this context, a “wire” can also be considered a band where the width of the material is greater than the depth. FIGS. 3A-E provide illustrations or views of various coils and groupings of coils. A wire coil can be made of a single wire, a wire alloy or two or more wires. For example, two wires comprising different metals can be wound or braided together.

The inner diameter (or dimension(s) where the coil is not a circle) of each coil can be the same or different and can be between 2 and 200 cm.

Coils 208 can independently be connected to one or more power supplies, such as an AC or DC power supply or combination thereof. For example, an AC current can be supplied to alternating (1, 3, and 5, for example) or adjacent coils (1, 2 and/or 4, 5, for example) while DC current is supplied to the remaining coils. Current can be provided (independently) in a frequency, such as in a patterned frequency, e.g., triangle, square or sine pattern or combination thereof. The frequency supplied to each coil can be the same or different and between 0 to 50 MHz or higher. While the coils 208 can generate and transfer thermal energy, or heat, to the reactor feed gas they are predominantly used to create a magnetic field.

The power supply can be an AC and/or DC power supply or combination thereof. Current can be provided (independently) in a frequency, such as in a patterned frequency, e.g., triangle, square or sine pattern or combination thereof. The frequency supplied to each coil can be the same or different and between 0 to 50 MHz or higher, such as between 1 Hz to 50 Mhz.

As described above, the RA coils typically surround the reactor chamber and/or reactor head space. For example, a first RA coil can be aligned with the first (or bottom) frit. A second RA coil can be aligned with the reactor chamber or nanoporous carbon bed. A third RA coil can be aligned with the second (or top) frit. Where present, a fourth RA coil can be disposed between the first RA and the second RA coil. When present, a fifth RA coil can be disposed between the second RA coil and third RA coil. When two or more reactor chambers, or nanoporous carbon beds are present, it can be desirable to add additional RA coils, also aligned with a second or additional reactor chambers or nanoporous carbon beds. Additional RA coils can be added to align with additional frits when present.

The RA coils can typically be supported in a support or stator to maintain a fixed distance between each coil. The support, when present, can be transparent. In one embodiment, the RA coils can be configured in a cartridge that can be removed or moved.

The RA coils can, additionally or alternatively, be aligned with the reactor headspace. The reactor headspace can typically be a volume above the second, or top, frit. It is understood that where the reactor assembly is positioned horizontally (or at some other angle than vertical), the geometry of the spaces is maintained, albeit rotated. The reactor headspace can typically be an enclosed volume. For example, the reactor assembly can be inserted into a closed ended transparent (e.g., glass) tube, vial or bottle. The reactor assembly can be movably engaged with the RA coils (or boundary), thereby permitting each RA coil to align to a different element within the reactor assembly. For example, the first RA coil can be realigned with the reactor chamber.

Referring to FIGS. 2A, 2B, and 2C, a reactor body 202 can also be a packed, moving or fluidized bed or other configuration characterized by one or more chambers that receive the charge material 204 and facilitates transfer of a reactor feed gas through the charge material 204 and can transfer thermal and/or electromagnetic energy to the charge material 204. The reactor chamber is sized to contain the desired amount of charge material 204. For the experiments described herein, the chamber is designed to contain between 20 mg to 100 grams of nanoporous carbon powder. Larger reactors can be scaled up.

The reactor body 202 is generally contained within a housing, e.g., closed end tube, 207 and frits 203, which function to contain the charge material 204. It can be advantageous to use a reactor within a translucent or transparent housing, such as quartz or other materials characterized by a high melting point. The volume of the reactor bed can be fixed or adjustable. For example, the reactor bed can contain about 1 gram, or less of starting material, between about 1 g to 1 kg of starting material or more. Where the reactor assembly comprises two or more reactor chambers, the reactor chambers are preferably directly or indirectly stacked, preferably having a common central axis and can be separated by one or two frits.

The reactor body 202 can, for example and without limitation, be made of a thermally conductive material, such as graphite, copper, aluminum, nickel, molybdenum, platinum, iridium, cobalt, or niobium, or non-thermally conducting material, such as quartz, plastic (e.g., acrylic), or combinations thereof. An optional cup 206 capped with cap 205 can be advantageous. The cup and cap material can be independently selected. For example, a graphite cup can be combined with a graphite cap, which is the selection for the examples below. A copper cup can be combined with a graphite cap. A graphite cup can be combined with a copper cap. A copper cup can be combined with a copper cap and so on.

The reactor assembly can also receive the gas line through the entrance, or inlet, 201 and to provide an exhaust through an exit, or outlet, 209, optionally controlled by valves. A head space defined by a closed end tube 207 can be configured above the reactor body. The reactor body is preferably made of graphite, copper, or other inorganic rigid material. The gas line is preferably made of an inert tubing, such as glass, acrylic, polyurethane, plexiglass, silicone, stainless steel, and the like can also be used. Tubing can, optionally, be flexible or rigid, translucent or opaque. The inlet is generally below the charge material. The outlet can be below, above or both.

Frits 203 used to define the chamber containing the charge material are also shown. The frits can be made of a porous material which permits gas flow. The frits will preferably have a maximum pore size that is smaller than the particle size of the starting material. Pore sizes of between 2 and 50 microns, preferably between 4 and 15 microns can be used. The thickness of the frits can range satisfactorily between approximately 1 and 10 mm or more. The frits are preferably made of an inert material, such as silica or quartz. Porous frits from Technical Glass Products (Painesville Tp., Ohio) are satisfactory. On the examples below, fused quartz #3 porous frits (QPD10-3) with a pore size between 4 and 15 microns and a thickness of 2-3 microns and fused quartz frits with a pore sizes between 14 and 40 microns (QPD10-3) were used. The purity of the frits exemplified herein was very high, 99.99% wt, to ensure that the results obtained cannot be dismissed as the result of contamination. Frits of lower purity and quality can also be used. The diameter of the porous frit is preferably selected to permit a snug fit within the reactor interior, or cup. That is, the diameter of the porous frit is approximately the same as the inner diameter of the reactor or cup, if present.

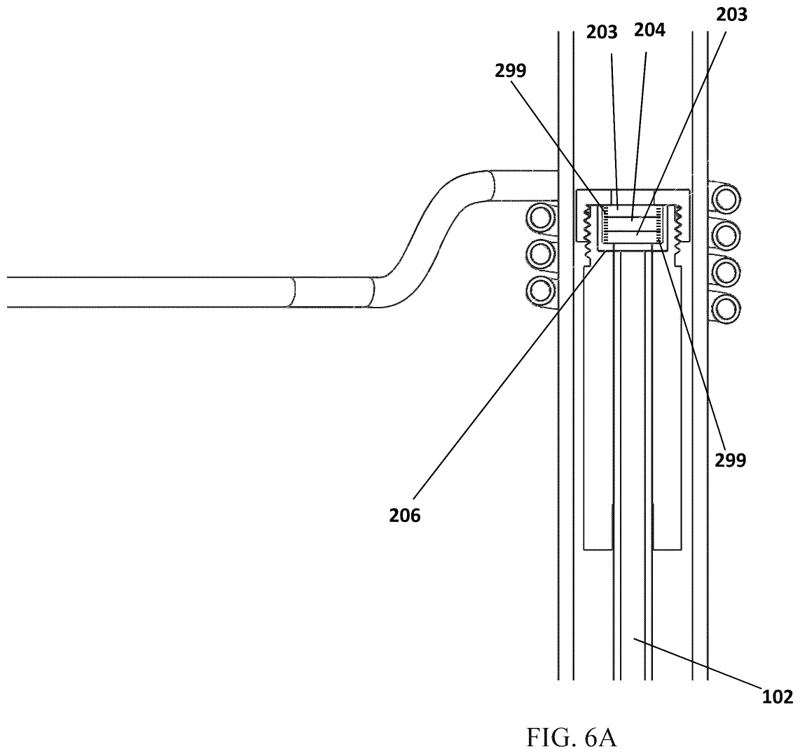

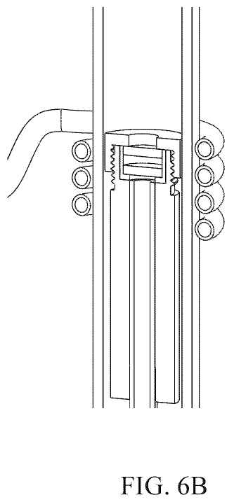

FIGS. 6A and 6B are illustrations of two examples of two composite reactor assemblies. FIG. 6A illustrates a Composite Reactor with a copper reactor body 606, carbon graphite cup 605, and a carbon graphite cap 601 and a metal foil boundary 607. FIG. 6B illustrates a composite reactor with a carbon graphite reactor body 606 and cap 601 and metal foil boundary 607. The embodiments depicted in FIG. 6A and FIG. 6B show a top frit 602 and a bottom frit 604, with a graphite bed 603 therebetween.

Referring to FIGS. 6A and 6B, a foil 607 can optionally encase the chamber containing the charge material on the inside and/or outside of the frits 602, 604 and/or cup 605, thereby creating a metal boundary surrounding the starting material. The foil 607 can be a metal, such as copper, platinum, niobium, cobalt, gold, silver, or alloys thereof. The foil 607 can also be graphite or the like. The foil 607 can be between 0 and 0.5 cm thick, preferably 1-10 mm. The profile of the reactor can be linear or it can be configured to contain a constriction below the lower frit, providing the general appearance of a lollipop.

The reactor assembly may be augmented with additional forms of electromagnetic radiation, such as light. FIG. 4B exemplifies light sources 426 and 427 that generate light directed through the reactor housing 415 and starting material contained therein. Preferred light sources 426 and 427 can be lasers and/or can emit light in a wavelength between 10 nm and 1 mm. The light is optionally subjected to one or more filters 428, as shown in the use of light sources (beams) in FIG. 4B. Preferably, the reactor assembly comprises 2, 3, 4, 5 or more pairs of lamps disposed circumferentially around the RA coils. Pencil lamps, such as the lamps used within the E/MEE which is incorporated herein by reference from above, are preferred. The pairs of lamps preferably define a boundary surrounding the coil and are not touching or otherwise adjacent to the coils. Two lamps are considered paired where they are proximal to each other, such as within the same plane with the center axis of an RA coil. Paired lamps can be parallel or orthogonal to each other and the RA coil center axis. Lamps can be considered proximal to each other if the space between any two points between the lamp tip and base is within 10 cm, preferably within 5 cm. Lamps that are positioned orthogonally to the RA coil center axis are generally positioned along the line defined by the radius of one or more RA coils.

The RA lamps, e.g., the pencil lamps proximal to the reactor body, can be matched, or paired, to one or more E/MEE lamps, e.g., the pencil lamps residing within the E/MEE housing and proximal to the gas line. For example, where an E/MEE pencil lamp is a neon lamp, a pair of RA lamps can be neon pencil lamps. Additionally, where an E/MEE pencil lamp is a neon lamp, a pair of RA lamps can be neon pencil lamps. Such matched lamps can emit light characterized by substantially the same wavelength. This can be conveniently achieved by using lamps from the same manufacturer with the same specifications.

The reactor can be in a closed or open housing 415 and can be supported therein by reactor supports. The reactor feed gas is directed to the reactor inlet frit, or bottom frit, directed through the starting material contained within the housing 415 and exits the reactor at the reactor exit frit, or top frit. The reactor feed gas can then be exhausted or recycled, optionally returning to the E/MEE for further treatment.

The reactor can further comprise an x-ray source 211 (FIG. 2C) or 424 (FIG. 4B) and/or one or more lasers 212 (FIG. 2C) or 426 and 427 (FIG. 4B). Preferred x-ray sources include a mini-x. The x-ray is preferably directed through the reactor towards a gas headspace, or target holder 213 (FIG. 2C), above the charge material. The x-ray can be directly or indirectly provided from the source, such as by reflecting the x-ray from a foil disposed above or below a frit.

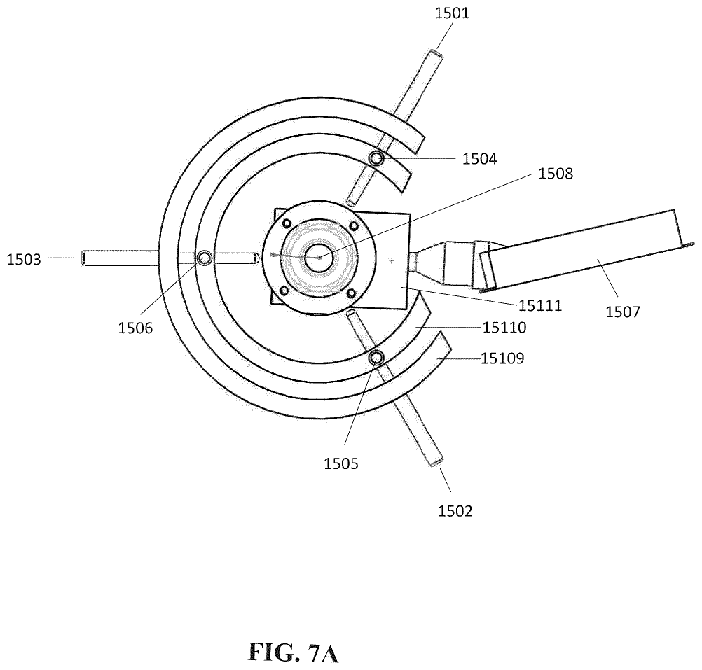

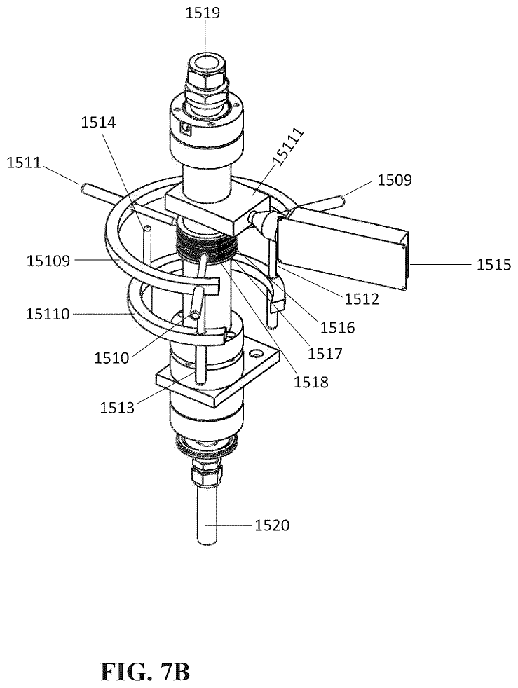

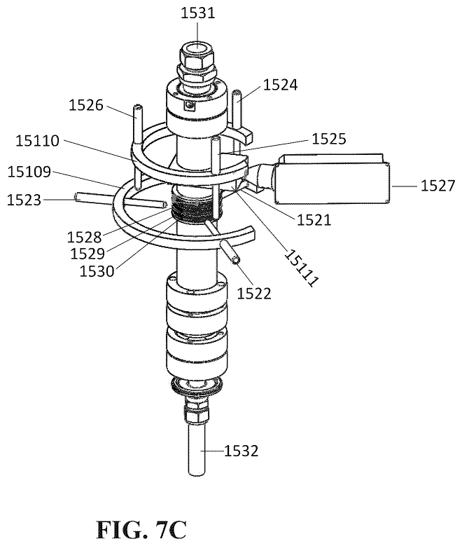

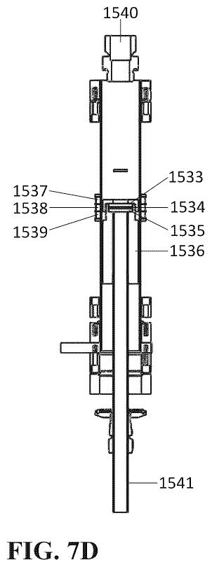

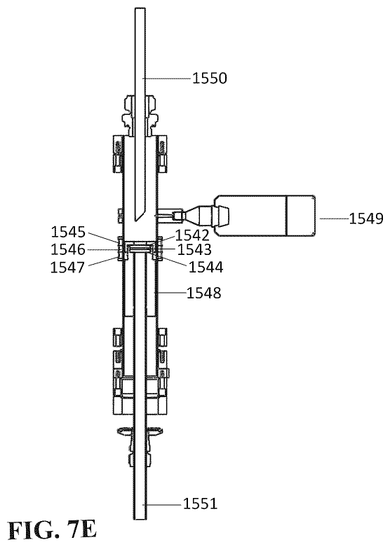

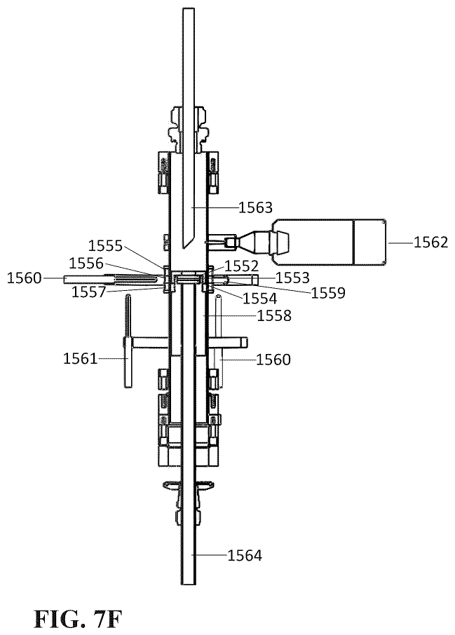

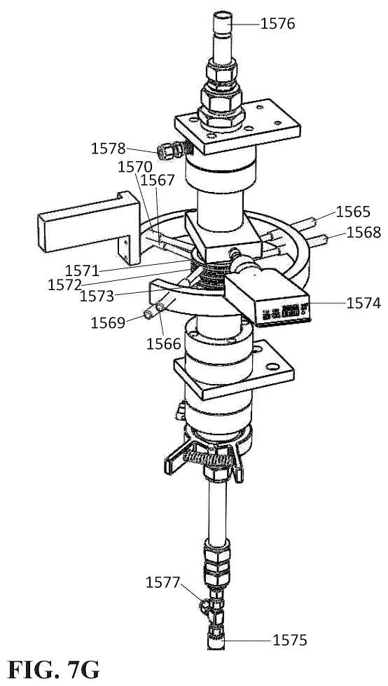

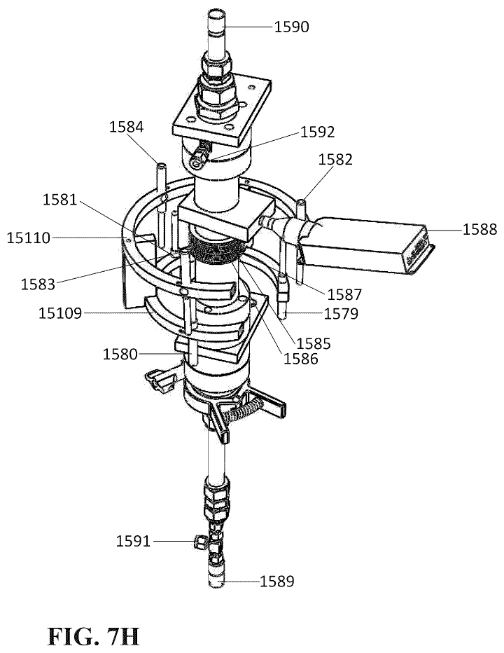

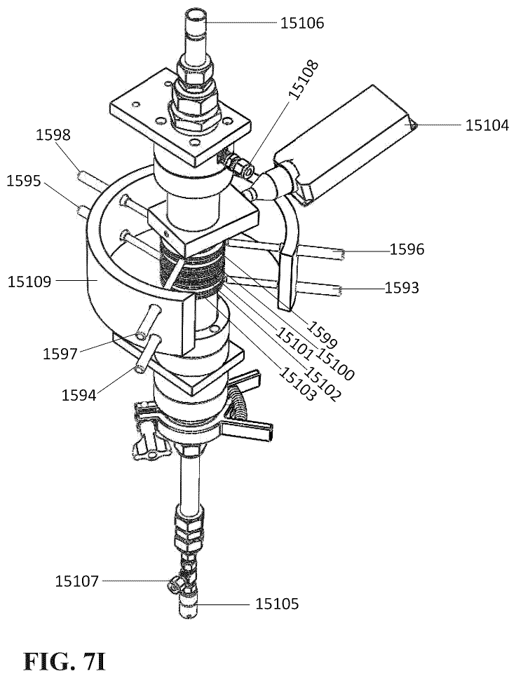

FIG. 7A illustrates a top view of a preferred reactor assembly. Pencil lamp 1501, pencil lamp 1502 and pencil lamp 1503 are shown with the tip directed towards a center axis of the reactor assembly along a radius of the reactor assembly. Pencil lamp 1504, pencil lamp 1505 and pencil lamp 1506 are shown directed parallel to a center axis of the reactor assembly and are disposed in a plane along a radius of the reactor assembly. Pencil lamp 1501, together with pencil lamp 1504, form a first RA lamp pair. Pencil lamp 1502, together with pencil lamp 1505, form a second RA lamp pair. Pencil lamp 1503, together with pencil lamp 1506, form a third RA lamp pair. As with the E/MEE pencil lamps, each RA lamp can be rotated along its x, y or z axis. Each pair can optionally reside within the same radial plane, as shown. Outer support 15109 provides support for the pencil lamps 1501, 1502 and 1503. Inner support 15110 provides support for the pencil lamps 1504, 1505 and 1506. The outer and inner supports are preferably made of non-conductive materials (such as polymers or resins) and are preferably transparent. An optional x-ray source 1507 is shown directing x-rays towards the center axis of the reaction chamber 1508. Reactor connector 15111 is also shown.

FIG. 7B is a perspective view of this reactor assembly. Pencil lamp 1509, pencil lamp 1510 and pencil lamp 1511 are shown directed with the tip towards a center axis of the reactor assembly along a radius of the reactor assembly. The tip of each lamp aligns with the center, or third, RA coil 1517 and is in the same horizontal plane. Pencil lamp 1512, pencil lamp 1513 and pencil lamp 1514 are shown directed parallel to a center axis of the reactor assembly, disposed in a plane along a radius of the reactor assembly and is characterized by a tip pointing towards top of the reactor, away from the gas inlet 1520. These lamps are illustrated above the horizontal pencil lamps. The length of each pencil lamp align with RA coils 1516, 1517 and 1518. Outer support 15109 and inner support 15110 support the pencil lamps. An optional x-ray source 1515 is shown directing x-rays towards the center axis of the reactor assembly above the third RA coil 1516. Disposed within the reactor assembly can be a reflecting plate to direct the x-ray towards the reaction chamber. Reactor connector 15111 is also shown, as well as other non-material connectors and spacers. Gas inlet 1520 and gas outlet 1519 are also shown.

FIG. 7C is a second perspective view of a reactor assembly. Pencil lamp 1521, pencil lamp 1522 and pencil lamp 1523 are shown directed with the tip towards a center axis of the reactor assembly along a radius of the reactor assembly. Pencil lamp 1524, pencil lamp 1525 and pencil lamp 1526 are shown directed parallel to a center axis of the reactor assembly, disposed in a plane along a radius of the reactor assembly and is characterized by a tip pointing towards the bottom of the reactor, towards the gas inlet 1532. These vertical lamps are shown above the horizontal lamps and, again, each pair of lamps can optionally lie in the same radial plane. The tip of each pencil lamp aligns with the third RA coil 1528. Outer support 15109 and inner support 15110 support the pencil lamps. Three RA coils 1528, 1529 and 1530 are shown. An optional x-ray source 1527 is shown directing x-rays towards the center axis of the reactor assembly. Disposed within the reactor assembly can be a reflecting plate to direct the x-ray towards the reaction chamber. Reactor connector 15111 is also shown, as well as other non-material connectors and spacers. Gas inlet 1532 and gas outlet 1531 are also shown.

FIG. 7D is a cross sectional side view of the reactor assembly, stripped of the pencil lamps and x-ray source. Gas enters at the inlet 1541 and exits at the outlet 1540. RA coils 1537, 1538 and 1539 are shown. The first, or bottom, frit 1535 and the second, or top, frit 1533 contain the reaction chamber 1534, which can be charged with nanoporous carbon powder. The reactor body 1536 is also shown. Other non-material spacers and connectors remain unlabeled.

FIG. 7E is a second cross sectional side view of a reactor assembly, stripped of the pencil lamps and x-ray source. Gas enters at the inlet 1551. RA coils 1545, 1546 and 1547 are shown. The first, or bottom, frit 1544 and the second, or top, frit 1542 contain the reaction chamber 1543, which can be charged with nanoporous carbon powder. The reactor body 1548 is also shown. X-ray source 1549 directs x-rays towards the center axis of the reactor assembly which is then deflected towards the reactor chamber with element 1550. Other non-material spacers and connectors remain unlabeled.

FIG. 7F is a second cross sectional side view of a reactor assembly with the pencil lamps and x-ray source. Gas enters at the inlet 1564. RA coils 1555, 1556 and 1557 are shown. The first, or bottom, frit 1554 and the second, or top, frit 1552 contain the reaction chamber 1553, which can be charged with nanoporous carbon powder. The reactor body 1558 is also shown. Vertical pencil lamps 1560 and 1561 are shown as are horizontal pencil lamps 1560 and 1559. X-ray source 1562 directs x-rays towards the center axis of the reactor assembly which is then deflected towards the reactor chamber with element 1563. Other non-material spacers and connectors remain unlabeled.

FIG. 7G is a perspective view of a reactor assembly with the pencil lamps and x-ray source. Gas enters at the inlet 1577 and exits at outlet 1578. A first laser 1575 and a second laser 1576 directing radiation towards the reaction chamber along the axis of the reactor assembly is shown. RA coils 1571, 1572 and 1573 are shown. In this embodiment pencil lamps 1565, 1566, 1567, 1568, 1569, and 1570 are all shown horizontally disposed in pairs along the radius towards the reactor assembly central axis. Tips are proximal to RA coils 1571, 1572 and 1573. X-ray source 1574 directs x-rays towards the center axis of the reactor assembly. Support 15109 (FIG. 7A) supports all of the horizontal pencil lamps. Other non-material spacers and connectors remain unlabeled.

FIG. 7H is a perspective view of a reactor assembly with the pencil lamps and x-ray source. Gas enters at the inlet 1591 and exits at outlet 1592. A first laser 1589 and a second laser 1590 directing radiation towards the reaction chamber along the axis of the reactor assembly is shown. RA coils 1585, 1586 and 1587 are shown. In this embodiment pencil lamps 1579, 1580, 1581, 1582, 1583, and 1584 are all shown vertically disposed in pairs in radial planes aligned with the RA coils. Tips are proximal to RA coils 1585, 1586 and 1587. X-ray source 1588 directs x-rays towards the center axis of the reactor assembly. Supports 15109 and 15110 support the pencil lamps. Other non-material spacers and connectors remain unlabeled.

FIG. 7I is a perspective view of a reactor assembly illustrating 5 RA coils, horizontal pencil lamps and an x-ray source. Gas enters at the inlet 15107 and exits at outlet 15108. A first laser 15105 and a second laser 15106 directing radiation towards the reaction chamber along the axis of the reactor assembly is shown. RA coils 1599, 15100, 15101, 15102 and 15103, defining a cylindrical boundary, are shown. In this embodiment pencil lamps 1593, 1594, 1595, 1596, 1597, and 1598 are all shown horizontally disposed in pairs in radial planes aligned with the RA coils. Tips are proximal to RA coils 1599 and 15103. X-ray source 15104 directs x-rays towards the center axis of the reactor assembly. Support 15109 supports the pencil lamps. Other non-material spacers and connectors remain unlabeled.

i. Ni-1 Reactor:

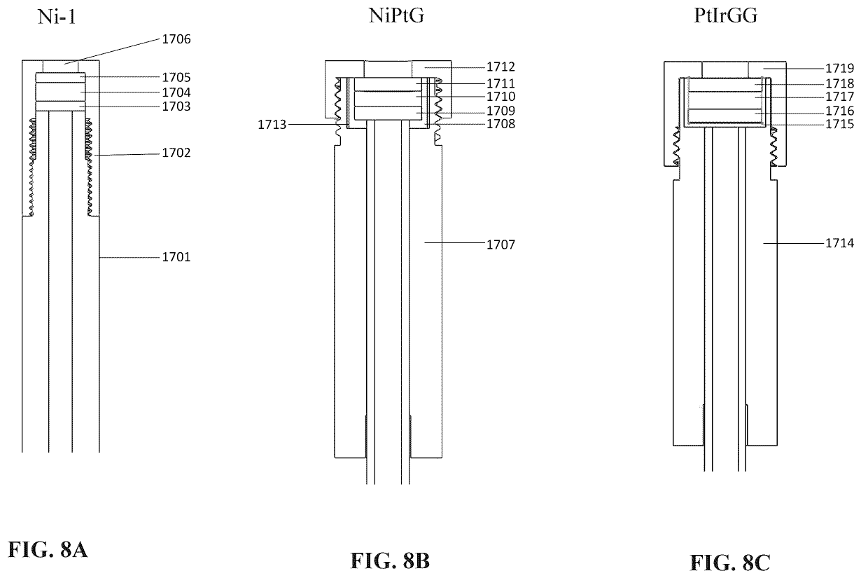

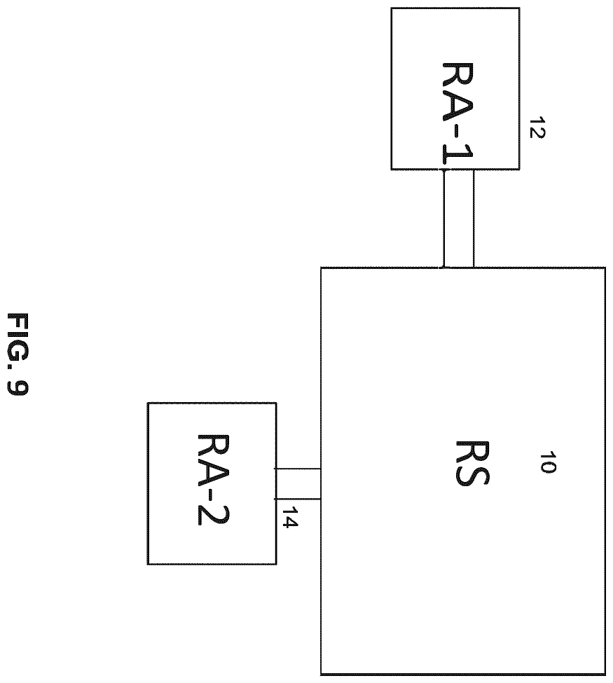

Referring to FIG. 8A, the reactor body (1702) is based on a high purity nickel (Ni) rod. The Ni rod, with an outside diameter of 15.873 mm (OD) is bored through then machined with a female thread on one end. The inside diameter allows for the installation of upper and lower frit and carbon bed. The carbon reaction medium is housed inside the reactor body (1702). To load the reactor, the reactor body (1702) is positioned with the gas discharge opening (1706) facing down on a flat surface. A quartz frit (1705) is placed inside the reactor body (1702) to form the upper containment. 100 mg of carbon is then loaded into the reactor body (1702). After loading of the graphite bed inside the reactor body (1702), a second quartz frit (1703) is installed. A reactor pole (1701), machined out of a high purity graphite rod with matched male threads for the reactor body (1702), is then screwed onto the reactor body (1702). The reactor pole (1701) is designed to allow and provide for the identical graphite bed compression (1704) equivalent to that provided by the cup design (1710 in FIG. 8B and 1717 in FIG. 8C).

ii. NiPtG Reactor:

Referring to FIG. 8B, in the NiPtG Reactor embodiment, the reactor body (1707) is based on a high purity nickel (Ni) rod. The Ni rod, with an outside diameter of 15.873 mm (OD) is bored through then machined on one end to have an inside diameter of 11.68 mm (ID). The inside diameter allows for the installation of a graphite cup (1708) and an optional 0.025 mm platinum (Pt) foil (1713). The graphite cup provides for reactor wall and foil isolation from the carbon bed. The carbon reaction medium is housed inside a 99.9999_{wt} % pure graphite cup (1708). To load the reactor, a quartz frit (1709) is placed inside the graphite cup (1708) to form the bottom containment. 100 mg of carbon (1710) is then loaded into the cup (1708). After loading of the graphite bed inside the cup, a second quartz frit (1711) is installed; this system is defined as the cup assembly. Prior to installing the cup assembly, the foil (1713) is used to line the inside surface of the reactor wall. The cup assembly is then placed within the nickel reactor body (1707) and foil (1713). After the cup assembly is installed, a 99.9999_{wt} % pure graphite cap (1712) is screwed onto the reactor body. The cap secures the cup from movement after assembly.

iii. PtIrGG Reactor:

Referring to FIG. 8C, the reactor body (1714) is based on a high purity graphite rod. The graphite rod, with an outside diameter of 15.873 mm (OD) is bored through then machined on one end to have an inside diameter of 11.68 mm (ID). The inside diameter allows for the installation of a graphite cup (1715) for reactor wall isolation from the carbon bed. The carbon reaction medium is housed inside a 99.9999_{wt} % pure graphite cup (1715). To load the reactor, a quartz frit (1716) is placed inside the graphite cup to form the bottom containment. 100 mg of carbon (1717) is then packed into the cup. After loading of the graphite bed inside the cup, a second quartz frit (1718) is installed; this system is defined as the cup assembly. The cup assembly is then placed within the graphite reactor body (1714). After the cup assembly is installed, a cap (1719) composed of platinum and 10% wt iridium is screwed onto the reactor body. The cap secures the cup from movement after assembly.

The residence time of the starting material within the reactor is effective to instantiate, or filter, or isolate, or extract, or nucleate, product into the starting material and can be between 0 and 15 minutes.

Preferred reactors used in the methods of the invention are shown in the table below.

TABLE 1

| Reactor | Cup | Cap | Reactor | Pole | | Chamber | | |
|---|---|---|---|---|---|---|---|---|
| ID | Material | Material | Material | Material | Boundary | Capacity | | Coil Type |
| CgF | N/A | N/A | Cu, Ni | graphite | N/A | 100 | mg | Induction |
| | | | or Mo or | | | | | |
| | | | graphite | | | | | |
| CuG | Graphite | graphite | Cu | quartz | N/A | 100 | mg | Induction or |
| | | | | | | | | Frequency |
| PtIrGG | Graphite | Pt/Ir | graphite | quartz | N/A | 100 | mg | Induction |
| GPtG | Graphite | graphite | graphite | quartz | Pt | 100 | mg | Induction or |
| | | | | | | | | Frequency |
| GPtGPtG | Graphite | graphite | graphite | quartz | 2X Pt | 100 | mg | Induction |
| GG-EL | Graphite | graphite | graphite | quartz | N/A | 100 mg- | | Induction or |
| | | | | | | 3 g | | Frequency |
| Foil (Pt) | Graphite | graphite | graphite | quartz | Pt | 100 | mg | Induction or |
| | | | | | | | | Frequency |
| GZ Foil | Graphite | graphite | graphite | quartz | Nb, Co | 100 | mg | Induction or |
| | | | | | or any | | | Frequency |
| nZG Foil | Graphite | Any Z | graphite | quartz | Ir | 100 | mg | Induction or |
| | | | | | | | | Frequency |
| NiG | Graphite | graphite | Ni | quartz | N/A | 100 | mg | Induction or |
| | | | | | | | | Frequency |
| NiPtG | Graphite | graphite | Ni | quartz | Pt | 100 | mg | Induction |
| ZG | N/A | Pd/Ru or | graphite | quartz | N/A | 100 | mg | Induction |
| | | any Z | | | | | | |
| Ref-X | Graphite | graphite | graphite | quartz | N/A | 1-20 | g | Frequency |

The invention further relates to methods of instantiating materials in nanoporous carbon powders. It has been surprisingly found that light elements, such as hydrogen, oxygen, helium, and the like are instantiated, or filtered, or isolated, or extracted, or nucleated. Instantiating is defined herein to include the nucleation and assembly of atoms within carbon structures, particularly, ultramicropores, and it includes without limitation processes such as filtering, or isolating, or extracting, or nucleating such atoms. Without being bound by theory, it is believed instantiation is related to, inter alia, degrees of freedom of the electromagnetic field as expressed by quantum field theory. By exposing a gas to harmonic resonances, or harmonics, of electromagnetic radiation within one or more ultramicropores, vacuum energy density is accessed and allows for the nucleation and assembly of atoms. Electromagnetic energy that is within the frequencies of light, x-rays, and magnetic fields subjected to frequency generators can enhance the formation and maintenance of such harmonics. Modifying the boundaries of the system, by selecting the reactor materials and adding a foil layer can also enhance the harmonics.

In particular, the invention includes processes of producing, or instantiating, nanoporous carbon compositions comprising the steps of:
adding a nanoporous carbon powder into a reactor assembly as described herein;
adding a feed gas to the reactor assembly;
powering the one or more RA coils to a first electromagnetic energy level;
heating the nanoporous carbon powder;
harmonic patterning the nanoporous carbon powder between a first electromagnetic energy level and a second electromagnetic energy level for a time sufficient to instantiate, or filter, or isolate, or extract, or nucleate, a chemical reactant in a nanopore and, optionally, collecting the chemical reactant.

The invention includes a process for producing a chemical reactant comprising the steps of:
(a) adding a feed gas to an electromagnetic embedding apparatus:
(b) exposing the feed gas to at least one E/MEE light source;
(c) directing the feed gas from step (b) to a reactor assembly comprising:
   A gas inlet and one or more gas outlets;
   A reactor chamber containing a nanoporous carbon disposed within a cup and, optionally, covered with a cap;
   A first porous frit defining a floor of the reactor chamber disposed within the cup,
   A second porous frit defining the ceiling of the reactor chamber; wherein each porous frit has a porosity that is sufficient to allow a gas to permeate into the reactor chamber;
   A reactor head space disposed above the reactor chamber;
   At least one RA coil surrounding the reactor chamber and/or reactor head space operably connected to a power supply, wherein the computer processing unit is configured to control the power supply to the RA coil;
(d) subjecting the nanoporous carbon powder to harmonic patterning to instantiate, or filter, or isolate, or extract, or nucleate, the chemical reactant integrated within a product composition;
(f) collecting the product composition comprising the chemical reactant; and
(g) isolating the chemical reactant from the product composition.

The term “harmonic patterning” is defined herein as oscillating between two or more energy levels (or states) a plurality of times. The energy states can be characterized as a first, or high, energy level and a second, or lower, energy level. The rates of initiating the first energy level, obtaining the second energy level and re-establishing the first energy level can be the same or different. Each rate can be defined in terms of time, such as over 1, 2, 3, 4, 5, 6, 7, 8, 9, 10 or more seconds. Each energy level can be held for a period of time, such as 1, 2, 3, 4, 5, 6, 7, 8, 9, or more seconds. Harmonic patterning is continued until instantiation is achieved.

Where two more electromagnetic radiation sources are present (e.g., coils, x-ray source, lasers, and/or lamps), each can be subjected to harmonic patterning and the patterning can occur independently, simultaneously or sequentially.

The process further comprises independently powering any additional electromagnetic radiation source, as described above in the E/MEE apparatus or reactor assembly. For example, the process further comprises the step(s) of powering RA frequency generator(s) connected to one or more RA coils, one or more lamps or lasers, x-ray sources, induction coils, E/MEE coils, and the like substantially as described above.

c. Use Cases for Chemical Reactants

Methods and and apparatus for producing chemical reactants in accordance with these inventions can be appreciated in more detail by reference to the following description and Figures.

i. General Use Cases

In general terms, a reactor assembly (RA) as disclosed herein can interface with a system within which a chemical reaction can take place, which chemical reaction utilizes the chemical reactant(s) produced by the RA. Such a system for utilizing chemical reactants to support chemical reactions can be termed a “reaction system,” (RS) and it can comprise an apparatus or enclosure within which a chemical reaction takes place. The term “reaction system” is not limited to closed vessels for reactions, since it is understood that certain chemical reactions such as flame combustion do not require a closed system, but can occur in “the open.” As described previously, a RA produces a chemical reactant that can be supplied to a RS; one or more RAs can produce one or more chemical reactants, to be used by one or more RSs.

In the exemplary embodiment, shown schematically in FIG. 9, a plurality of RAs, (RA-1, 12 and RA-2, 14) can produce the same or different substances, to be supplied to RS 10. As an example, one RA can produce a chemical reactant useful as a fuel (e.g., H₂), while the other RA can produce a chemical reactant useful as an oxidizing agent (e.g., O₂). These chemical reactants can be conveyed into the RS 10, where the designated reaction takes place, advantageously producing energy or other reaction products that can be beneficially employed. RAs such as RA-1 (12) and RA-2 (14) are capable of instantiating a desired chemical substance(s) or mixture of chemical substances, including but not limited to simple mono-elemental atoms and molecules (e.g., alkali metals such as Na, alkaline earth metals such as Ca, H₂, O₂, halogen molecules such as Cl₂, etc.), simple multi-elemental molecules comprising at least two elements (e.g., CO, NH₃ or H₂O₂, etc.), or complex multi-elemental molecules comprising at least two elements in various distinguished configurations (e.g., hydrocarbons, carbohydrates, alcohols, etc.). As depicted in FIG. 9, the RAs 12 and 14 can be coupled to any RS apparatus 10 that can immediately, or almost immediately, or at other timing, consume the chemical substance(s) (such as fuel(s)) through combustion or other chemical reaction.

In an exemplary embodiment, as described below in more detail, the RS 10 acting as a “fuel-sink” can be, without limitation any fuel-consuming apparatus, such as an engine, that converts fuel to mechanical energy alone or in combination with any other fuel-consuming apparatus such as, without limitation, (i) a thermal apparatus that converts fuel to heat; or a fuel-cell that converts fuel to electricity; (ii) any other apparatus that consumes a chemical substance; (iii) any fuel-storage facility such as a tank or other container that stores the fuel; or (iv) any reactant-transformation process that uses a chemical reactant as a feedstock or precursor in the production of other chemicals or materials, or any combination of the foregoing.

As depicted in FIG. 9, the RAs 12 and 14 can be coupled to any RS apparatus 10 that can immediately, or almost immediately, or at other timing, consume the chemical substance(s) such as fuel(s) through combustion or other chemical reaction. These various dispositions of chemical substances such as fuels/reductants or oxidants can be generalized by the concept of “fuel/reductant sink” and “oxidizer sink”. Accordingly, the output(s) of such RA(s) 12, 14 in some embodiments is/are directed through a “conduit” to a “fuel sink” or an “oxidizer sink” which receives the fuel/reductant or oxidizer and processes it.

Systems incorporating one or more RAs in communication with one or more RSs can include one or more fuel consumers, one or more fuel retainers and one or more fuel transformers. For example, RAs 10 and/or 12 can be coupled to a storage facility apparatus whereby the chemical substance(s) (e.g., a fuel) can be retained for use elsewhere or later; or can be moved through a conduit for other processing such as being used as a feedstock or precursor to the production of other chemicals.

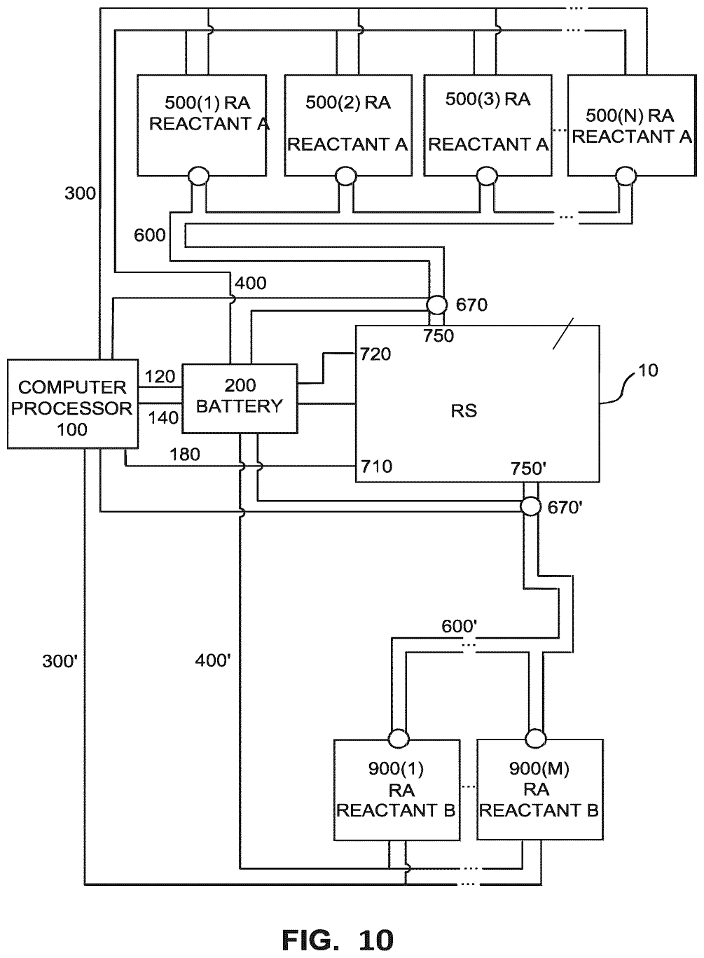

In embodiments, a plurality of RAs can be harnessed to form an integrated system delivering appropriate quantities of chemical reactants to a RS in order to achieve a desired reaction. Such a system is illustrated in FIG. 10. FIG. 10 depicts a series of RAs 500(1-n) that supplies a chemical substance such as a fuel to a RS 10 via a conduit 600. In the example shown, “N” RA(s) 500(1), 500(2), . . . , 500(N) (where N is any positive integer) can be configured to assemble the fuel or fuel mixture in sufficient quantities appropriate for the fuel sink and deliver the fuel to the fuel sink, i.e., RS 10.

In the depicted example, “M” RAs(s) 900 (where M is zero or any positive integer) can be configured to assemble a second chemical substance, such as a chemical reactant (e.g., an oxidant) appropriate for the fuel sink and deliver the chemical substance to the fuel sink, i.e., RS 10. It is understood that the RA bank or set 900(1)-900(M) is optional, to be used in systems where a second chemical substance is to be provided to the RS in addition to the chemical substance produced by the RA bank or set 500(1)-500(n). Any number of additional RAs or banks or sets of RAs can be provided to supply any number of and quantity of chemical substances individually, alternately, simultaneously or in any desired mixtures or ratios, to RS 10.

The chemical substances produced by RAs 500, 900 are supplied to RS 10 via one or more conduits 600, 600′. Thus, as material moves between points it is said to move through a “conduit”. Examples of such materials include without limitation: hydrogen, ammonia (NH₃), hydrocarbons, alcohols (as fuels); oxygen, ozone, hydrogen peroxide (H₂O₂), (as oxidants); helium, xenon, argon, krypton, (as elements to moderate or buffer the reaction); nitrogen, other gases, fuels, oxidizing agents, boron, calcium, aluminum, and any other elements or compounds used within the system. Depending on an implementation's design and engineering constraints, a “conduit” may vary from being a trivial, almost abstract, connection to a complicated path in which a number of operations are performed, sometimes conditionally, on the subject material. Such operations may include, for example and without limitation, being: pumped, collected, combined, combined with the output of other conduits or sources, pressurized, compressed, liquefied, solidified, stored, packaged, transported, hauled, unpackaged, repackaged, gasified, uncompressed, depressurized, filtered, mixed, agitated, centrifuged, shaken, oscillated, stirred, vibrated, gated, shunted, injected, diverted, merged, blown, aerated, propelled, spun, blended, dissolved, extracted, sensed, tested, humidified, dehumidified, monitored, measured, regulated, accumulated, cooled, heated, or otherwise processed. Such operations may involve the use of components including for example and without limitation: pumps, sensors, gates, shunts, injectors, valves, baffles, pipes, splitters, plumbing, relays, filters, controls, accumulators, tanks, containers, reservoirs, fans, blowers, propellers, impellors, aerators, agitators, oscillators, vibrators, shakers, stirrers, centrifuges, pressurizers, humidifiers, dehumidifiers, compressors, refrigerators, blenders, mixers, vats, dissolvers, extractors, coolers, heaters, gasifiers, liquefiers, and sensors and controls for flow, humidity, concentration, density, purity, particle size, particle diameter, particle surface area, particle weight, viscosity, temperature, volume, and pressure, as well as other sensors and controls and processing equipment. Each operation may be performed zero or more times, sometimes simultaneously, and the order in which they are performed (and whether they are appropriate or necessary) depends on a particular implementation's design, tradeoffs, and constraints.

Conduits can also be used to route power and signal cables. A conduit 600, 600′ may thus without limitation comprise a single pipe or other structure capable of conducting fluids (preferably gases), a conveyor for conducting powders or solids, a blower system for moving powders or gas, a manifold that couples the outputs of multiple RAs 500 together as a bank or set of RAs, a mixer that mixes the outputs of multiple RAs together, or any other suitable structure for conveying outputs of RAs 500, 900 to RS 10. As shown in FIG. 10, a conduit can act as a fuel intake manifold for delivering the instantiated chemical reactants to the RS 10. The conduit(s) 600, 600′ can also convey fuel supplied by another fuel source(s), for example, a storage tank or other production process such as e.g., electrolysis. Such additional source(s) could be used in some embodiments and/or under some operating conditions in addition to RA(s) 500, 900 to provide sufficient fuel quantities and/or flow rates and/or combinations to meet demands of the RS 10. For example, RA(s) 500, 900 may operate for an extended period of time to develop substances for storage in storage tanks, and RS 10 may later consume the substances stored in the storage tanks.

Delivery of chemical reactants from RAs to the one or more RSs can be coordinated by control systems that monitor aspects of the overall system, and that regulate the flow of materials through the different components of the overall system. In the embodiment depicted in FIG. 10, aspects of each RA 500, 900 are monitored and regulated by processor 100 through bus 300/300′, which may comprise a digital data bus in one embodiment. The various monitored aspects can include, without limitation, power, temperature, humidity, configuration, pressure, flow, concentration, viscosity, density, purity, particle dimension, and any other relevant state or parameter; together with the operation of fans, blowers, oscillators, pumps, valves, reservoirs, accumulators, pressurizers, compressors and/or other devices used to support the processes shown. The processor 100 can also send signals over bus 300/300′ to control aspects of the state and operation of each RA 500, 900 such as flow control, output rate, and any other relevant state, parameter or characteristic. As shown in FIG. 10, computer processor 100 provides an electronic controller that senses, monitors, coordinates, regulates, and controls the various aspects of chemical substance production and usage. Processor 100 is connected as needed (120, 140, 180, 300, 300′, etc.) to other various components (200, 500, 900, 670, 670′, 10) to receive sensor input signals and send control signals. Computer processor 100 may be operatively coupled to a non-transitory storage device(s) (not shown) that stores executable instructions. The computer processor 100 may include a CPU(s) and/or a GPU(s) that reads instructions from the storage device and executes the instructions to perform functions and operations the instructions specify. In some embodiments, the computer processor 100 can comprise or consist of hardware such as a programmable or non-programmable gate array, an ASIC or any other suitable implementation comprising hardware and/or software. In some embodiments, processor 100 can be implemented as multiple processors which may, although not necessarily, be mutually connected or communicating and including an absence or any plurality of connection or communication means. Computer processor 100 receives operating power 120 from the battery 200, from which it can also receive sensory signals 140 and to which it can send control signals. Implementations can have connections beyond those specifically illustrated here, from computer processor 100 to other components. For example, computer processor 100 can be operatively coupled to numerous input sensors; numerous output devices such as actuators, displays and/or audio transducers; and digital communication devices such as buses, networks, a wireless or wired data transceivers, etc.

In some embodiments, battery 200 provides ancillary power to various components in addition to processor 100. Battery 200 is shown external to the reactor, although in many embodiments it can be internal to the reactor, such as if the RS is implemented as or includes a fuel cell, an alternator/generator, or possesses other electrical power generation capabilities, if present, to receive and maintain charge. In some embodiments, battery 200 can be supplemented or replaced by other power sources such as solar panels, fuel cells, generators, alternators, or any external power sources, etc. In embodiments, the system depicted in FIG. 10 can have connections from battery 200 and processor 100 to other components not shown in the Figure. In embodiments, a battery 200 can be included as an initial power source. A battery 200 can also be useful in remote locations; in situations where battery acquisition, maintenance, or replacement may be difficult; or in emergency and special situations. In embodiments, the system and/or its battery 200 can provide for being jump-started with manually operated, or other kinetic current sources, or with solar panels.

In an embodiment, an operator (and/or the computer processor 100) activates the system by setting an ignition switch (not shown) to “on”. Referring to FIG. 10, this action by the operator or computer processor 100 gates power from battery 200 to the other components as appropriate, which can include RAs 500, 900 (if present), the processor 100, and optionally the RS, for example in systems where the RS requires preparation in anticipation of fuel flow. Once started, processor 100 senses, monitors, coordinates, regulates, and controls, as necessary, the activity and interaction of all components. The RAs 500, 900 (if present) can be started under control of processor 100, with the appropriate environment being established for producing the desired chemical reactants, including as examples and without limitation: power, temperature, humidity, pressure, charge, and electromagnetic fields. If sensors and controls in the RAs 500, 900 (if present) are required, such signals can be transmitted through bus 300/300′ to and from the processor 100. Once ready, the RAs 500, 900 (if present) are operationally activated under control of processor 100, which thereafter senses, monitors, coordinates, regulates, and controls RAs 500, 900 to ensure proper operation.

In an embodiment, the RAs 500 are activated to instantiate, or filter, or isolate, or extract, or nucleate, a chemical reactant useful as a fuel material, which can be atoms or molecules, such as hydrogen (H₂). The chemical reactant produced by the RAs 500 is/are collected by the conduit 600, optionally purified or separated, which can further process it in various ways (denoted by the chemical processor 670) as appropriate before it is delivered to the RS 10 through an intake port 750. The chemical processor 670 can include various aspects of conduit(s) 600 that may exist and be attached to processor 100 and battery 200. Similarly, RAs 900 in one embodiment can instantiate, or filter, or isolate, or extract, or nucleate, a chemical reactant useful as an oxidizing agent which can be atoms or molecules, such as oxygen (O₂). The chemical reactant emitted by the RAs 900 (1-M) (if present) is/are collected by the conduit 600′ which can process it in various ways (denoted by the chemical processor 670′) as appropriate before it is delivered to the RS 10 through its reactant intake 750′.

After an operation reacting the different chemical reactants takes place in the RS 10 with satisfactory completion, the computer 100 can conduct a proper close-down for the RAs 500, 900, conduits 600, processors 670, 670′, RS 10, battery 200, any other integrated equipment, and for itself 100. The satisfactory completion of the intended chemical reaction in the RS 10 can be determined in various ways depending on the particular specific embodiment. In certain embodiments, the completion can be signaled by the operator setting an ignition switch (not shown) to “off,” or can be signaled via some computer interaction or artificial intelligence decision, or can be signaled by any sensor, detector, monitor, or probe interior to, or exterior to RS which may be available to the processor, or can be signaled by parameters pertaining to the RS itself, such as the passage of time or the generation of heat or other energy, or can be signaled by the status of a storage unit or other non-reactive fuel sink, such as a storage tank reaching a full state.

The Figures that follow depict use cases that exemplify the principles for the RAs and RSs as disclosed herein.

ii. Use Cases Involving Fuels Generally

In embodiments, the invention particularly relates to the identification and collection of chemical reactants useful as fuels produced by the disclosed methods. In embodiments, the methods and apparatus disclosed above can produce chemical reactants such as fuel substances and/or reductants including, but not limited to, the many and varied substances containing hydrogen, carbon, nitrogen, oxygen, calcium, sodium, potassium, phosphorus, sulfur, or other materials, such as other oxidizable materials, such as, by way of example but not limited to: hydrogen (H₂), carbon (C), carbon monoxide (CO); ammonia (NH₃); unsaturated aliphatic hydrocarbons, such as alkynes and alkenes (including olefins); saturated hydrocarbons (e.g., alkanes, paraffins); cyclic and polycyclic hydrocarbons including aromatic compounds; heterocyclic compounds; and a vast collection of other organic compounds, of which a small sample includes: alcohols, such as alkanols (such as monohydric (CₙH₂ₙ₊₁OH), diols or polyols, unsaturated aliphatic, alicyclic, and other alcohols having various hydroxyl attachments); nitroalkanes such as nitromethane (CH₃NO₂); carbohydrates; and the like. In embodiments, these fuel substances can include substituted or unsubstituted alkanes or paraffins of various sizes and structures, for example methane (CH₄), ethane (C₂H₆, CH₃CH₃), propane (C₃H₈), butane (C₄H₁₀); pentane (C₅H₁₂), hexane (C₆H₁₄), heptane (C₇H₁₆), octane (C₈H₁₈), C₉-C₁₆ alkanes, or heavier molecules can also be used as fuel or for other purposes, such as lubricating oil, wax, or asphalt. In many cases, the methods and apparatuses disclosed herein can directly instantiate, or filter, or isolate, or extract, or nucleate the chemical substance, the production of which might otherwise require transformation by a chemical reaction or a different source.

While the use of these methods and apparatuses for producing conventional chemical reactants useful as fuels (including but not limited to those disclosed herein) is especially advantageous, these methods and apparatuses also are capable of producing materials not usually considered to be fuels, but which can be economically harnessed in appropriate situations for the energy of their exothermic fuel-like reactions with other chemical substances, such as oxygen and other oxidizing agents described herein. Such atypical fuels produced by these methods and apparatuses include those elements such as calcium, sodium, lithium, and the like, that are so reactive in the natural environment that they are not encountered in their unbound, elemental state. Examples of such atypical fuels include, without limitation, alkali metals: Li (which can react, e.g., with O₂, H₂O, CO₂, N₂), Na, K, and the like; alkaline earth metals (Be, Mg, Ca, and the like); and those other elements and compounds that can be involved in exothermic reactions, such as Al, Fe, CaO, and the like, including for example but without limitation, those that can be made to undergo exothermic reactions, such as Al, Fe, CaO. While the reactions involving conventional fuels tend to take place via a redox mechanism using an oxidizing agent such as oxygen, the chemical substances available as fuels are not limited to those that undergo redox reactions. Atypical fuels can produce energy through non-redox mechanisms, for example, a reaction between metal oxide such as CaO, and H₂O, and similar reactions.

Chemical reactants produced by the methods and apparatuses disclosed herein can also include oxidants (i.e., oxidizing agents), which can be used to react with reductants or fuels produced by the methods and apparatuses disclosed herein, or which can be isolated to be used for other purposes. The oxidants that can be instantiated, or filtered, or isolated, or extracted, or nucleated, by these methods and apparatuses include without limitation, atomic oxygen and oxygen species, hydrogen peroxide, water (which can exothermically oxidize alkali metals, alkaline earth metals, and the like, and can exothermically react with alkali metal oxides or alkaline earth metal oxides such as CaO), halogen molecules such as F₂, Cl₂, Br₂, and the like, and other reactive metals (e.g., metal oxides) or non-metals.

In embodiments, the invention particularly relates to the identification and collection of chemical reactants useful as fuels produced by the methods disclosed herein. In embodiments, reactors as described herein can produce and extract chemical feedstock substances for more complex chemical reactions, making them available for further processing that includes, without limitation, the use of chemical reactions such as substitution and addition of other reagents such as chlorine, or other chemicals; and/or physical processes such as mixing, blending, melting, softening, refining, hardening, vaporizing, cooling, distilling, liquefying, solidifying, freezing, crushing, powdering, exuding, extruding, rolling, smelting, alloying and the like, to produce more advanced products such as solvents (e.g., nail polish, paints, naphtha (mothballs)); lubricating oils; waxes and paraffins; asphalt; polymers (e.g., polyester, polyethylene, polypropylene, polystyrene, acrylates); aromatic compounds (e.g., benzene, toluene, xylene, and the like); pharmaceutical small molecules; vitamins; fertilizers; pesticides; and the like.

Fuels or reactants produced by the methods and apparatuses disclosed herein can be stored in various containers or other retaining mechanisms for use elsewhere. Such containers or retaining mechanisms (collectively, “retainers”) allow the chemical reactants thus produced to be stored for use elsewhere or at a later time. Retainers can include, without limitation, bags, tanks or bottles (for fluids (preferably gases)), caves (for gases), bags, envelopes or boxes (for solids), conduits, or any other vessel or other structure that at least for a discernible period of time (whether short or long), either while in transit or statically, stores a quantity of the chemical reactant.

### 3. Principles for Engines Using Instantiated Fuels

a. Engine Systems and Components Thereof

A number of use cases can be envisioned that employ one or more RAs, as described above, for the production of fuels to be used in one or more RSs in systems that function as engines. As used herein, the term “engine” refers to any artificially constructed machine or system that converts one or more forms of energy into mechanical energy, where mechanical energy is understood to be the energy that is possessed by an object due to its position or its momentum. As known in the art, mechanical energy can be either kinetic energy (energy of motion) or potential energy (stored energy of position), and total mechanical energy is the sum of kinetic and potential energy. Objects have mechanical energy if they are themselves in motion, or if they occupy a position relative to a zero potential energy position. Mechanical energy can be understood as the ability to do work: mechanical energy enables an object to apply force to another object to cause displacement, with the work produced being expressed by the following standard equation EQ. 1:

$$Work = Force \times displacement \times cos Θ , \qquad EQ 1$$

where Θ is the angle between the force vector and the displacement vector.

Available energy sources for engines include potential energy, heat energy, electric potential energy, nuclear energy, and chemical energy. Certain of these processes generate heat as an intermediate form, so that engines employing them can be described as heat engines even if the immediate source of the heat is some other reaction, such as a chemical or a nuclear reaction. Mechanical heat engines convert heat into work by well-understood thermodynamic and thermomechanical processes.

As an example, a conventional internal combustion engine uses chemical reactions (for example combustion) to produce heat, which in turn causes the rapid expansion of combustion products in the combustion chamber; this rapid volumetric expansion can drive a piston, which then turns a crankshaft. As another example, the gases produced by the combustion can be released from the combustion chamber in a directed stream, for example through a nozzle, that can interact with the blades of a turbine or comparable force converter, whereby the force of the rapidly exiting gases impacts the force converter and produces useful work, for example by turning the turbine blades. As yet another example, in a reaction or expulsive combustion engine, the exhaust gases produced by combustion within the engine, or mass that is otherwise energized within the engine, can be expelled backwards from the engine to produce thrust, which in turn provides forward propulsion to the vehicle being accelerated by the engine.

As used herein, the term “thrust” refers to a reaction force described quantitatively by Newton's Third Law, wherein, when a system expels or accelerates mass in one direction, the accelerated mass will cause a force of equal magnitude but opposite direction to be applied to that system. Thrust can be produced by a chemical reaction that produces exhaust gases that are directed backwards, thus propelling the vehicle in accordance with Newton's Third Law of Motion. The reaction mass and its velocity determines the total velocity change of the vehicle in accordance with the Tsiolkovsky equation, stated below as EQ. 2:

$$Δ v = {v}_{e} ln ( {m}_{0} / {m}_{f} ) = {I}_{s p} {g}_{0} ln ( {m}_{0} / {m}_{f} ) \qquad EQ 2$$

### Where:

Δv or delta-v, =maximum change in velocity of the vehicle with no external forces acting;
m₀ is the initial total mass including propellant, i.e., wet mass
m_{f} is the final total mass without propellant, i.e., dry mass
v_{c}=Iₛₚg₀ is the effective exhaust velocity, where Iₛₚ is the specific impulse in dimension of time, and g₀ is standard gravity; and.
ln is the natural logarithm function.

A number of engine species are powered by chemical reactions, either to produce heat (as in the internal or external combustion engine) or to produce rapidly expanding gases that can act on external engine components to produce useful work, or to produce thrust (as in a so-called “reaction engine” or an expulsive combustion engine). Those engines that employ air as part of a fuel reaction are termed airbreathing engines, as have been described in PCT/US2022/018511, filed Mar. 2, 2022, the contents of which are included herein by reference in their entirety.

By contrast, those engines that are powered by chemical reactions but without use of the Earth's atmosphere or other gaseous oxygen sources need to have self-contained oxidant sources to produce the chemical reactions that provide the motive force to the vehicle that contains them. Examples include submarines and vehicles operating outside the Earth's atmosphere.

In embodiments, engine systems using the methods and apparatuses of the invention can include, without limitation:
Internal combustion engines using instantiated H₂ as fuel for combustion with O₂, where the O₂ can be instantiated, or filtered, or isolated, or extracted, or nucleated, by one or more RAs, and/or where the O₂ can be provided externally, for example by a separate feedline or from the atmosphere;
Internal combustion engines using instantiated diesel (C₉H₂₀ to C₁₁H₂₄) as fuel for combustion with O₂, where the O₂ can be instantiated, or filtered, or isolated, or extracted, or nucleated, by one or more RAs, and/or where the O₂ can be provided externally, for example by a separate feedline or from the atmosphere;
Internal combustion engines using instantiated C₈H₁₈ as fuel and instantiated or non-instantiated O₂, such as ambient atmospheric O₂ as oxidant;
External combustion engine, e.g., “steam engine,” using an exothermic reaction produced by the combustion of an instantiated fuel and an oxidant such as ambient atmospheric O₂.
Turbine engine using instantiated NH₃ as fuel and ambient atmospheric O₂ as oxidant or instantiated O₂, or H₂O₂ (hydrogen peroxide) as oxidant;
Expulsive combustion engines (ECE), referring to any engine that substantially or primarily propels by the forceful emission of exhaust or other mass, and including those using, e.g., H₂, NH₃, any hydrocarbon, or any other instantiated liquid or gaseous fuel; and/or where the oxidant can comprise instantiated or ambient atmospheric O₂, or instantiated O₂, or H₂O₂ (hydrogen peroxide);

The engine categories mentioned above all employ combustion as a mechanism for producing the energy that is translated into useful work. As used herein, the term “combustion” refers to a high-temperature exothermic redox chemical reaction between a fuel (the reductant) and an oxidant, to yield oxidized products and heat. The oxidant is often atmospheric oxygen, although other sources of oxidizing materials can be used as well. Combustion in a combustion chamber typically yields reaction products that are high-temperature and high-pressure gases. In certain species of engines, such as internal and external combustion engines, the production of gases during combustion applies a force to a component of the engine such as a piston, a rotor, a nozzle, or a set of turbine blades, wherein the component is moved over a distance, thereby transforming the chemical and heat energy into kinetic energy. In other engine species, such as expulsive combustion engines (reaction engines), the expulsion of the exhaust gases produces the desired kinetic energy. For example, in a gas turbine engine, expelling the gaseous products of combustion from the combustion chamber acts upon an external mechanical engine component such as turbine blades. Such an external engine component is operatively associated with the combustion chamber so that the rapidly expanding gaseous products of combustion can act upon it as those products are expelled from the combustion chamber to strike an external mechanism such as a turbine blade. In such engines, the gases striking the turbine blades cause them to turn, which can rotate a central shaft to produce useful work. In other types of expulsive combustion engines, the expulsion of the exhaust gases itself produces the mechanical force, thrust, that propels the vehicle or projectile that is powered by the engine. The methods and apparatus disclosed herein can be used for any sort of engine that operates to produce thrust, such as an expulsive combustion engine.

b. Expulsive Combustion Engines

The principles of the invention are demonstrated in expulsive combustion engines (ECE) (i.e., reaction engines), in which the motive energy is provided by the rapid expansion of the combustion reaction's exhaust gases as they leave the reaction/combustion chamber. In an ECE, the force of the expanding exhaust gases leaving the chamber (e.g., expelled from the chamber through a nozzle in one direction or harnessed by a turbine) provides an oppositely directed thrust thus propelling the vehicle within which the ECE is disposed.

In general terms, a reactor assembly (RA) as disclosed herein can interface with a system within which a chemical reaction can take place such as an engine, in which the chemical reaction yielding the mechanical energy produced by the engine utilizes the chemical reactant(s) produced by the RA. As used herein, a the term “reaction system” (RS) refers to a system for utilizing chemical reactants to support chemical reactions. As described previously, a RA produces a chemical reactant that can be supplied to a RS; one or more RAs can produce one or more chemical reactants, to be used by one or more RSs. As applied to engines, a reaction system comprises the apparatus or enclosure within which a chemical reaction takes place, for example a combustion chamber in the engine. As previously described, a reaction system for combustion can include both closed and open vessels, since combustion does not require a closed system, but can also occur in “the open.” However, for use in anaerobic environments, the combustion takes place in a closed vessel.

In exemplary embodiments, the fuel instantiated, or filtered, or isolated, or extracted, or nucleated, by one or more RAs as described herein is suitably reactive (combustible) to power a reaction engine (expulsive combustion engine). In embodiments, hydrogen is preferred as a fuel, although any material produced by a RA or an assembly of RAs can be used, as appropriate. Further descriptions of exemplary engine systems are provided below to illustrate the principles of the invention.

As described herein in more detail, an expulsive combustion engine uses the force of the expanding reaction/combustion fluids themselves, typically gases that are expelled through a nozzle in one direction which provides an oppositely directed thrust, i.e., a reaction force (as described quantitatively by Newton's Third Law) such that the expulsion or acceleration of mass in the one direction produces force of equal magnitude in the opposite direction. Expulsive combustion engines can function in aerobic or anaerobic environments.

A jet engine is a type of internal combustion engine that generates its power by producing thrust; in other words, it is a reaction engine (i.e., an expulsive combustion engine) formatted as a continuous combustion engine. Most jet engines used in aviation are air breathing, axial flow, gas turbine engines. In the typical jet engine, the exhaust (in addition to providing forward thrust) also drives a turbine which is connected, via a central shaft, to a compressor at the front of the engine which enriches the incoming air density to improve combustion efficiency. Such a jet engine, using a gas turbine engine but producing its motive power by thrust, can be termed a “turbojet engine.” The component parts of a turbojet engine are (a) an inlet, (b) a gas turbine engine, comprising a compressor, a combustion chamber and a turbine, and (c) exhaust nozzle. In a gas turbine used as a jet engine, ambient air enters the engine through an intake, whereupon an axial or centrifugal compressor increases both the pressure and the temperature of the air before feeding it into a combustion chamber, wherein it is combined with fuel and ignited. After ignition has taken place, the combustion is self-sustaining because the constant inflow of air and fuel and the concomitant outflow of exhaust products provide for a continuous redox reaction (i.e., continuous combustion). The high energy exhaust stream (the reaction mass) then passes through one or more turbines that are driving the compressor, with remaining gas being ejected backwards through a nozzle to propel the vehicle (e.g., an aircraft) forward. An afterburner component can be added to the engine to provide an increase in thrust as needed for special situations, such as supersonic flight, takeoff, or combat. Afterburning involves injecting additional fuel into the exhaust gas flow downstream from the turbine. The combustion of this additional fuel accelerates the exhaust gas to a higher velocity, thereby increasing thrust. Fuel needed for the afterburning process can be added from separate sources, or can be produced by RAs using the apparatus and methods of the invention.

Often aircraft are intended to operate at speeds much slower than the velocity of the ejected exhaust gases. Thus, the energy from the engine turbines can be used to drive other engine components, such as a fan, propeller, or other mechanical components, so that the residual gas velocity is optimized to match the speed desired for the aircraft. Such modifications are termed turboprop, turbofan, turboshaft engines, and the like. Certain jet engines designed for high-speed use can eliminate the need for a powered compressor, so that the air entering the engine is compressed by the high speed of the aircraft itself due to the specialized geometry of the intake and compressor section of the engine. Such engines, termed ramjet or scramjet engines operate efficiently at high speeds but do not have the ability to operate when the aircraft is stationary.

An expulsive combustion engine is also a reaction engine. An expulsive combustion engine, like a jet engine, produces thrust by ejecting mass rearward, in accordance with Newton's third law. As used herein, the term “vehicle” includes those projectiles, missiles, aircrafts, vehicles adapted for short-range or long-range travel in the atmosphere or beyond the atmosphere, or any other mechanical agents of transportation that are powered by thrust from an ECE. Expulsive combustion engines work by Newtonian principles of action and reaction, and produce propulsion by expelling exhaust in an opposite direction from the intended path of travel. Expulsive combustion engines can therefore operate effectively in anerobic environments such as vacuums and undersea environments, or environments otherwise lacking oxygen.

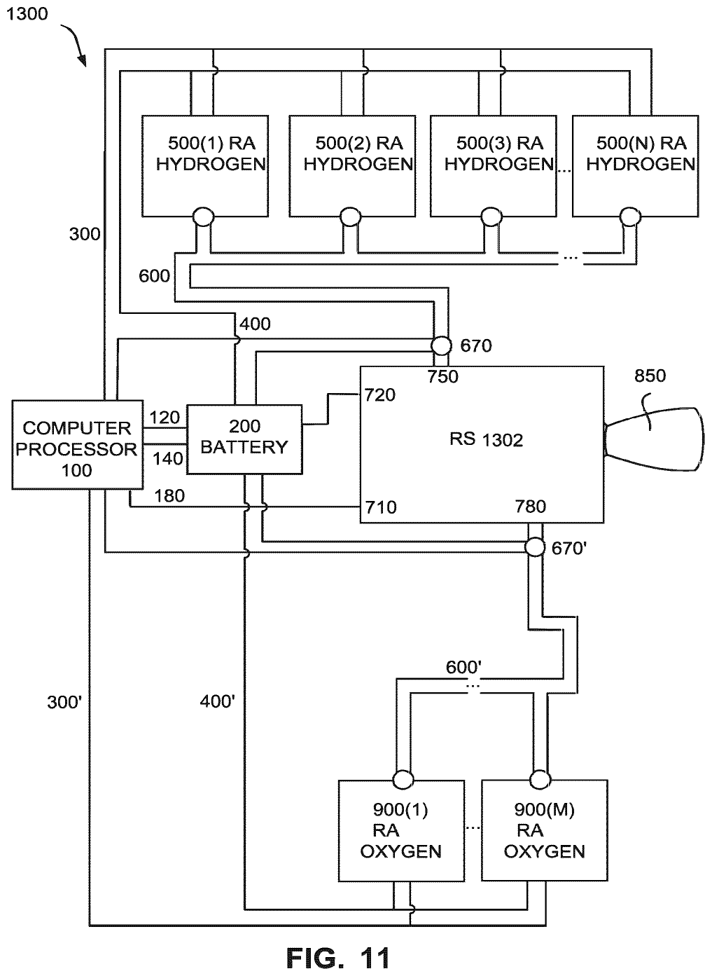

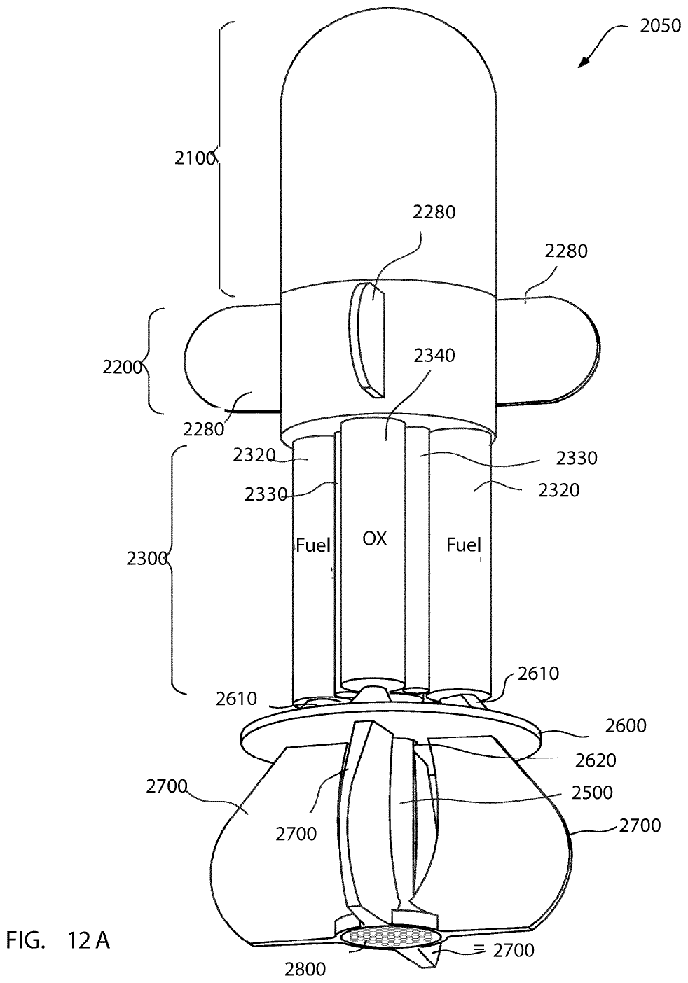

In an exemplary embodiment, an expulsive combustion engine (ECE) system can incorporate the principles of the invention illustrated schematically in FIG. 11. FIG. 11 depicts a hydrogen-powered engine system for an expulsive combustion engine 1300 that includes, at a high level, a computer processor 100, a battery or other electrical power source 200, an engine core or reaction system (RS) 1302, and a posteriorly directed stream of exhaust gases 850, wherein acceleration of exhaust gases 850 in one direction produces force of equal magnitude in the opposite direction. The RS can include one or more combustion chambers (not shown) within which chemical reactants combine to produce the chemical reaction that generates the exhaust gases 850 that produce the thrust providing motive power to the vehicle within which the ECE resides. As previously described, these chemical reactants comprise a fuel reactant and an oxidant that complete the fuel-oxidation reaction (which is typically combustion).

In the depicted embodiment, the fuel reactant and the oxidant are produced in accordance with the principles of the invention by two different banks or sets of RAs shown schematically in FIG. 11, the 500 series and the 900 series of RAs. In this Figure, RAs 500 (1 through N, where N is any positive integer) instantiate, or filter, or isolate, or extract, or nucleate, an engine fuel, for example hydrogen, and RAs 900 (1 through M, where M is any positive integer) can instantiate, or filter, or isolate, or extract, or nucleate, an oxidant like oxygen. As shown in this Figure, one or more RAs 900 (1-M) can be used to produce a supply of oxidizing agent to react with the fuel, which can be oxygen, or any other chemical or substance that will react appropriately with the fuel provided by the RAs 500 (1-N).

Oxidizing agents can include, for example, but without limitation; oxygen; or a halogen molecule such as chlorine (Cl₂), fluorine (F₂), and/or bromine (Br₂). In some embodiments, especially for those in which liquids are easier to manage, hydrogen peroxide can be used as an oxidant. In some embodiments, the designated oxidizing agent can be produced, collected and managed by a system of RAs, conduits and processors that are analogous to those used for producing, collecting, and managing the fuel input, but generally separated therefrom in order to prevent premature reaction between fuel and oxidizing agent until the fuel and oxidizing agent are combined in the reaction/combustion chamber. Delivery of the oxidizing agent can take place at the same time as the delivery of the fuel, or before or after, so long as the fuel and the oxidizing agent are present at the same time in adequate quantities to permit the desired exothermic reaction to take place, i.e., synchronous delivery. During operation the combustion chamber may receive additional fuel, oxidant, and possible moderating material on a continuous or sporadic basis, as applicable to the design and constraints of the embodiment. The oxidizing agent can be injected into a combustion chamber through a valve, port, injector, nozzle, turbocharger, or other means. In some implementations, one or more RA(s) 900 can be used to produce oxidizing agent, which is used to combust a fuel provided conventionally such as from a storage tank or other process or source.

The RS 1302 can include a number of other components or subsystems useful for its function as an engine, such as the following (certain of which are not shown in FIG. 11): a reaction or combustion chamber, region or space; conventional intake components such as an intake manifold and intake valves or ports, a throttle, fuel injectors, etc.; a compressor that compresses incoming gas to high pressure for introduction into the combustion chamber; conventional exhaust components such as exhaust valves or ports, an exhaust manifold and an exhaust system; a turbine that extracts energy from high-pressure, high-velocity gas flowing from the combustion chamber; a nozzle that receives hot exhaust 850 from the combustion chamber and accelerates the flow of the hot exhaust 850 to produce thrust (as described in more detail below); conventional lubrication components such as an oil pump, an oil filter, an oil crankcase or sump, oil galleys, etc.; conventional cooling components such as a radiator or other heat sink, a coolant pump to circulate coolant, a cooling jacket, etc.; conventional ignition components such as high voltage coils and spark plugs, glow plugs, ignition charges, or any other fuel igniter, and associated wiring; a conventional electrical charging system such as an alternator or generator or other electricity producer; etc.

In more detail, with reference to FIG. 11, the engine core 1302 can be constructed as a hydrogen-powered engine including certain features. In the depicted embodiment, the instantiated fuel (hydrogen) enters the RS (engine) through fuel intake 750, and oxygen enters through oxygen intake 780. Processor 100 controls the amount of hydrogen and oxygen produced by the RAs and/or supplied to the engine 1302 to control the speed and power output of the engine system 1300a.

In more detail, with reference to FIG. 11, a fuel such as hydrogen produced by the RAs 500 (1-N) can be conducted into the combustion chamber 700 through a conduit 600. The fuel is then directed via 670 and 750 to the engine's reaction/combustion chamber 700 where it reacts with an oxidizing agent. Depending on the nature of the fuel and other engineering constraints, the fuel can go through additional steps including for example and without limitation, those of being: pumped, collected, combined, e.g., combined with the output of other conduits or sources, pressurized, compressed, liquefied, solidified, stored, packaged, transported, hauled, unpackaged, repackaged, gasified, uncompressed, depressurized, filtered, mixed, agitated, centrifuged, shaken, oscillated, stirred, vibrated, gated, shunted, injected, diverted, merged, blown, aerated, propelled, spun, blended, dissolved, extracted, sensed, tested, humidified, dehumidified, monitored, measured, regulated, accumulated, cooled, heated, or otherwise processed. Such operations may involve the use of components including for example and without limitation: pumps, sensors, gates, shunts, injectors, valves, baffles, pipes, splitters, plumbing, relays, filters, controls, accumulators, tanks, containers, reservoirs, fans, blowers, propellers, impellors, aerators, agitators, oscillators, vibrators, shakers, stirrers, centrifuges, pressurizers, humidifiers, dehumidifiers, compressors, refrigerators, blenders, mixers, vats, dissolvers, extractors, coolers, heaters, gasifiers, liquefiers, and sensors and controls for flow, humidity, concentration, density, purity, particle size, particle diameter, particle surface area, particle weight, viscosity, temperature, volume, and pressure, as well as other sensors and controls and processing equipment. Each step can be performed zero or more times, and the order in which they are performed (and whether they are necessary or used) depends on an implementation's design, tradeoffs, and constraints. The oxidizing agent can be instantiated, or filtered, or isolated, or extracted, or nucleated, by the set or bank of RAs 900 (1-M), and it can be conducted into the combustion chamber through a conduit 600′ to react with the fuel. The expansion of gases resulting from the reaction of the fuel and the oxidizing agent within the combustion chamber 700 of the RS 1302 (engine) provides the force which drives the engine, here shown as the exhaust gases 850 that provide the thrust.

As the fuel is assembled and emitted by the one or more RA(s) 500, it is conducted to the at least one reaction (combustion) chamber 700 of the engine. In some cases, such as when the fuel is hydrogen, it can be desirable to moderate the combustion temperature by running a fuel-rich mixture, or by supplying another gas into the combustion process. Examples include nitrogen (although that can lead to undesirable combustion by-products), or an inert gas (like helium, neon, argon, krypton, or xenon (although xenon has anesthetic properties which are probably often undesirable in some contexts)). Such other gas can be produced by at least one of the depicted RAs and mixed with the fuel (or oxidizer) before delivery, or it can be produced through a separate bank or set of RAs and delivered separately through its own conduit (not shown). As mentioned previously, the fuel thus produced is directed to the engine's reaction/combustion chamber where it reacts with an oxidizing agent produced by a set or bank of RAs or provided otherwise. The expansion of gases resulting from the reaction, directed backward, provides the force which drives the engine in a forward direction.

c. Chemical Reactants for Engines

RAs as disclosed herein can produce the chemical reactants required for the chemical reactions needed to produce energy. The preceding Figures have illustrated arrangements of RAs to provide fuel, and other arrangements of RAs to provide oxidants. In more detail, one or more RAs can produce a supply of oxidizing agent to react with the fuel. This oxidizing agent is typically oxygen in most embodiments, although it could be other chemical or substance that will react appropriately with the fuel and satisfies an implementation's constraints;

The invention is compatible with air-breathing engines, which can use oxygen from the atmosphere, but the invention is also usable in anerobic environments without a supply of oxidizing agent, for example for undersea use or for use outside the Earth's atmosphere. For use in anaerobic environments, however, the fuel source and the oxidizing agent can be both provided by an appropriate set of RAs. In some cases, such as when the fuel is hydrogen, it may be desirable to moderate the combustion temperature by running a fuel-rich mixture, or by supplying another gas into the combustion process as a buffer to moderate the temperature and reaction, as has been described previously. Gases such as nitrogen or inert gases can be used. Such other moderator gas can be produced by a RA that operates in addition to the sets or banks of RAs depicted in these Figures. In embodiments, the moderator can be mixed with the fuel or oxidizer before delivery, or it can be delivered separately through its own conduit (not shown).

In situations such as when the engine operates in the earth's atmosphere where oxygen, the classic oxidizing agent, is freely and sufficiently abundant, there may be no need for the engine system to produce its own oxidizing agent. The ability of an engine system to produce its own oxidizing agent may be useful or important, however, in engine implementations designed to operate where oxygen is scarce, unavailable or impure (e.g., mixed with nitrogen or other gases), as can be seen in expulsive combustion engines, which can be used in vacuum environments and underwater. Engine systems that produce their own oxidizing agent can also rely in part on oxidizing agents sourced by other means, e.g., storage tanks or the like.

d. Operation of Engine Systems
i. Control Systems for Engines

Engine systems embodying the principles of the invention can incorporate control systems to sense, monitor, regulate, and control various aspects of the implementation. The engine systems depicted in FIG. 11 illustrates certain features of these control systems, some of which have been described in connection with FIG. 10. As shown in FIG. 11, a computer processor 100 can act as an electronic controller to integrate other aspects of the control system, and it is connected as needed to various components to receive sensor input signals, send control signals and the like. Computer processor 100 can be operatively coupled to a non-transitory storage device that stores executable instructions. The computer processor 100 can include a CPU(s) and/or a GPU(s) that reads instructions from a storage device and executes the instructions to perform functions and operations the instructions specify. In some embodiments, the computer processor 100 can comprise or consist of hardware such as a programmable or non-programmable gate array, an ASIC or any other suitable implementation comprising hardware and/or software. In some embodiments the computer processor 100 can be implemented as multiple processors not necessarily mutually connected or communicating. Computer processor 100 receives operating power 120 from the battery 200, from which it can also receive sensory signals 140 and to which it can send control signals 160. Embodiments of engine systems can have connections beyond those specifically illustrated here, from computer processor 100 to other components. For example, computer processor 100 can be operatively coupled to numerous input sensors; numerous output devices such as actuators, displays and/or audio transducers; and a digital communication device such as a bus, a network, a wireless or wired data transceiver, etc.

The processor 100, as well as the battery 200, can also be connected to the “start”/“ignition” switch (not shown) that activates the various components in response to a manual or automatically generated start event. In an embodiment, the “ignition”/“start” switch can activate the entire engine system including without limitation, all relevant components and sub-components, as appropriate.

In some embodiments, battery 200 provides power to various ancillary components in addition to powering the processor 100. Battery 200 is shown external to the engine, although in embodiments it can be internal to the engine. In some implementations, battery 200 can be supplemented or replaced by other power sources such as solar panels, fuel cells, generators, alternators, or any external power sources, etc. Certain embodiments can have connections beyond those specifically illustrated here, from battery 200 to other components. Certain embodiments can include a battery 200 as an initial power source. In remote locations, in situations where battery acquisition, maintenance, or replacement may be difficult, or in emergency and special situations, motor units can be included that can be jump-started, manually operated, or be powered by alternate sources of kinetic current, or by solar panels.

Sensory and control connections 300 are provided from computer 100 to the bank or set of RA(s) 500. Power lines 400 are provided from the battery 200 to the bank or set of RA(s) 500.

In FIG. 11, “n” RA(s) 500 can be configured to assemble hydrogen (where n is any integer greater than 0) and deliver the hydrogen to the engine 700 as fuel. These “n” RA(s) 500 receive electrical power as needed, from battery 200 through 400. For illustrative simplicity, while all “power” connections to or from battery 200 are shown as a single line, they are intended to reflect at least a pair of conductors through which current flows. Aspects of the RA(s) 500 are monitored and regulated by processor 100 through 300, which can comprise a data bus in one embodiment. The various monitored aspects can include, without limitation, power, temperature, humidity, configuration, pressure, flow, concentration, viscosity, density, purity, particle dimension, and any other relevant state or parameter; together with the operation of fans, blowers, oscillators, pumps, valves, reservoirs, accumulators, pressurizers, compressors and/or other devices used to support the processes shown. The processor 100 can also control aspects of the state and operation of each RA 500 such as flow control, output rate, and any other relevant state or operation.

A fuel intake manifold in the form of conduit(s) 600 is shown, through which the hydrogen fuel produced by RA(s) 500 is conducted to various cylinders/combustion chambers of the engine 700. The conduit(s) 600 can also convey hydrogen supplied by another hydrogen source(s), for example, a storage tank or other production process such as e.g., electrolysis. Such additional source(s) could be used in some embodiments and/or under some engine operating conditions in addition to RA(s) 500 to provide sufficient fuel quantities and/or flow rates to meet demands of engine core 700.

ii. Operational Features of Expulsive Combustion Engine Systems

In embodiments, engine systems incorporating the principles of the invention entail certain operational features pertaining to the production of power by the engine system, the use of the power to produce work, and the use of ancillary power or other complementary systems. In more detail, successful operation of an engine using one or more RSs may include carrying out the following steps:
creating the conditions necessary to support the instantiation of fuel materials using one or more RAs as described herein;
activating the one or more RAs once the prerequisite conditions are established;
sustaining, to the extent necessary, the activity of the one or more RAs once activated;
providing an oxidizing agent for use with the instantiated fuel to accomplish a chemical reaction, wherein the oxidizing agent is produced through its own bank or set of RAs or is provided from an external source
circulating and pumping the instantiated fuel and/or oxidizing agent as necessary;
pressurizing or compressing the fuel and/or oxidizing agent as necessary;
liquefying or otherwise changing the state of the fuel and/or oxidizing agent as necessary;
delivering the fuel and oxidizing agent to the combustion chamber as required for the combustion needed to produce thrust; in some embodiments, the fuel and the oxidizing agent can be delivered to the combustion chamber separately and mixed within the chamber, while in other embodiments, the fuel and the oxidizing agent are premixed before entering the combustion chamber, for example in a premixing chamber that provides for a measured intake of fuel and oxidizing agent and a premixing thereof, with the premixed mixture then being delivered into the combustion chamber;
activating the fuel-oxidizing agent reaction (combustion) as necessary; commonly, however, jets and expulsive combustion engines may require only a single initiating event
   managing and directing the exhaust as needed to produce the desired thrust; and
handling cooling and radiator issues as required.

Generation and/or delivery of the fuel can involve various additional steps and/or structures, including for example and without limitation, those of being: collected, combined, combined with the output of other RAs, stored, pressurized, compressed, liquefied, pumped, filtered, gated, injected, diverted, monitored, regulated, accumulated, cooled, heated, or otherwise processed; and through use of components including for example without limitation: pumps, sensors, injectors, valves, relays, controls, accumulators, reservoirs, tanks, fans, pressurizers, compressors, refrigerators, heaters, liquefiers, and sensors and controls for flow, concentration, temperature, humidity, volume, and pressure, as well as other sensors and controls and processing equipment. Each step can be performed zero or more times, and the order in which they are performed (and whether they are necessary) depends on a particular implementation's design, tradeoffs, and constraints.

Aside from those operational features that relate specifically to the production of fuel materials and/or oxidizing agents by RAs, the other steps in engine operation are familiar to skilled artisans. Conventional solutions to operational problems can be readily incorporated. For example, line current, batteries, or outside sources can be employed to start or to operate the system; once started, operation of the engine itself can also be employed to provide, as needed, ongoing mechanical energy to run a generator or to directly drive functions such as pumps, compressors, fans, turbines, turbochargers, etc. As another example, most types of engines mentioned (e.g., internal and external combustion engines generally, expulsive combustion engines generally, reciprocating piston engines, gas turbines, jet engines and the like) transmit mechanical energy through a central rotating shaft (e.g., a crankshaft in common internal combustion engine designs) from which ancillary power can be extracted. Ancillary power can also be provided by adding a second engine system operating conventionally or embodying the principles of the invention, wherein the second engine can act to assist the main engine.

While the power required to start a RA seems modest in many implementations, its correlation with an engine's performance has not been clearly determined. Furthermore, the fuel is likely to require at least an initial spark to incite combustion, and in some embodiments an additional spark(s) may be required. Therefore, it may be advantageous to provide an electrical source at least to start the engine's RA(s), activate the processor, provide ignition, and which can also be required to sustain the proper operating environment. In embodiments, RA chain reactions, once started, can continue instantiating material for use by an engine system with little or no additional ongoing power requirement as long as the proper operating environment is maintained.

In manufacturing an engine system that embodies the principles of the invention, an engine designer should further consider the material from which the engine is constructed and the lubrication issues. As an example, in certain cases hydrogen gas will be the chosen fuel, burned with either atmospheric oxygen for air-breathing (jet) ECEs or with oxygen assembled onboard with RAs. The water resulting from this combustion reaction is not toxic and provides some degree of lubrication. However, in this case, materials used in engine design should be chosen to resist oxidation and rust, since both hot water vapor (steam) and incompletely burned oxygen will be present during combustion and in the exhaust. Designs should consider using strong, heat resistant, non-reactive materials for relevant parts of the engine, especially for surfaces. stainless steel, chromium, titanium, or even other low-reactive or non-reactive metals such as iridium, osmium, palladium, platinum, or gold, should be considered, as well as glass and various ceramics.

### 4. Expulsive Combustion Engine Systems Using Instantiated Fuels: First Exemplary Embodiment

a. Vehicles for Use with ECE Systems
i. Aspects of Vehicle Construction

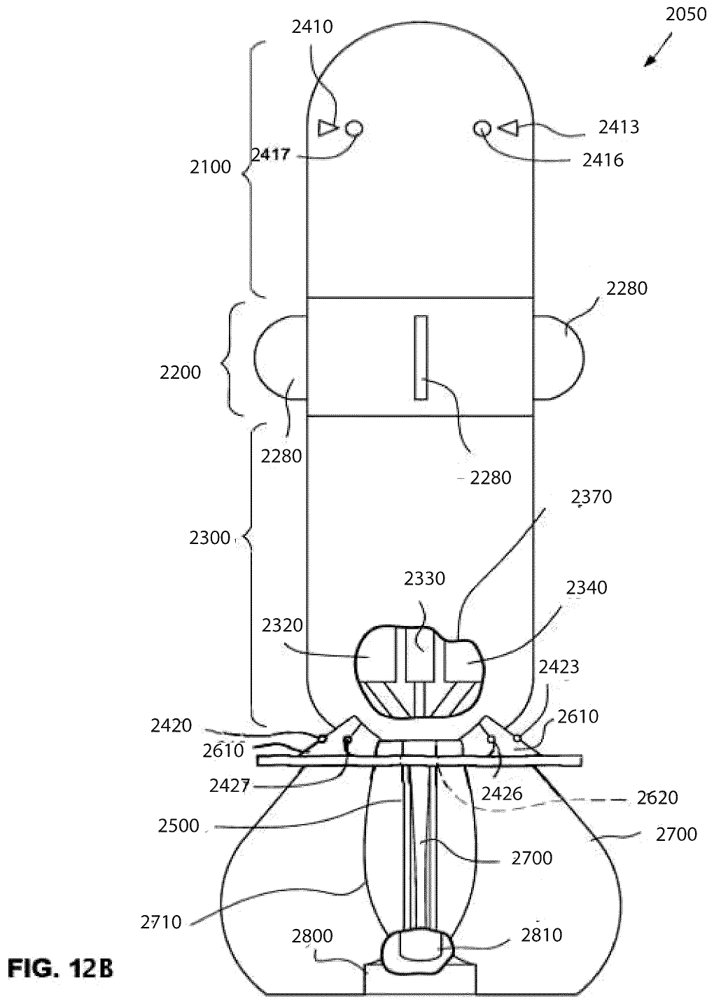

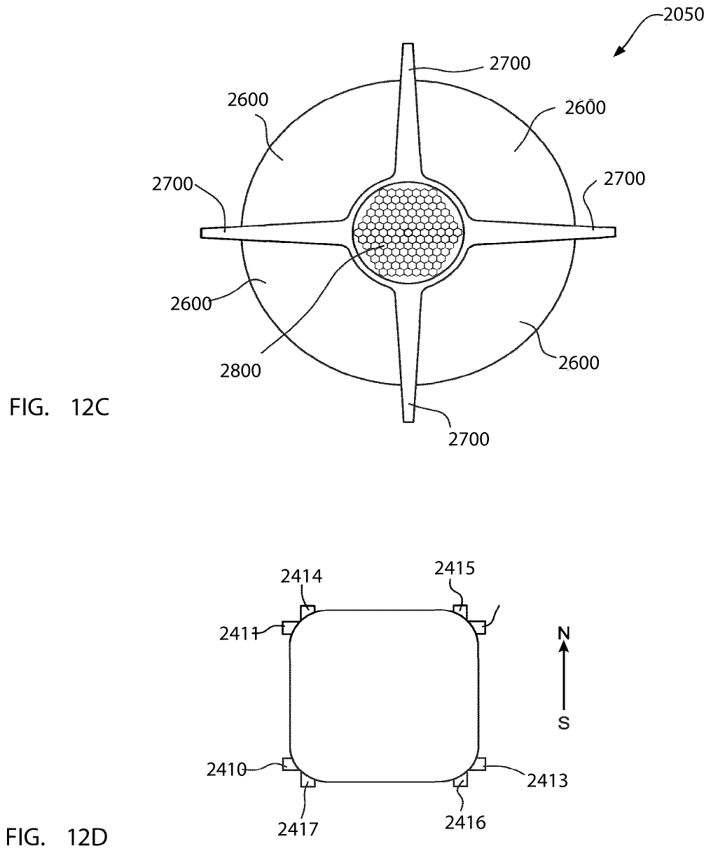

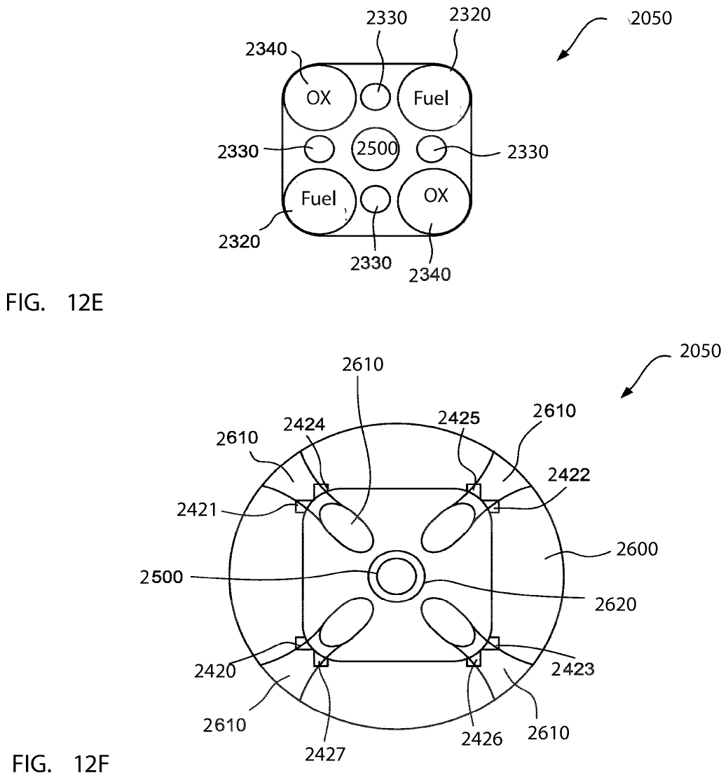

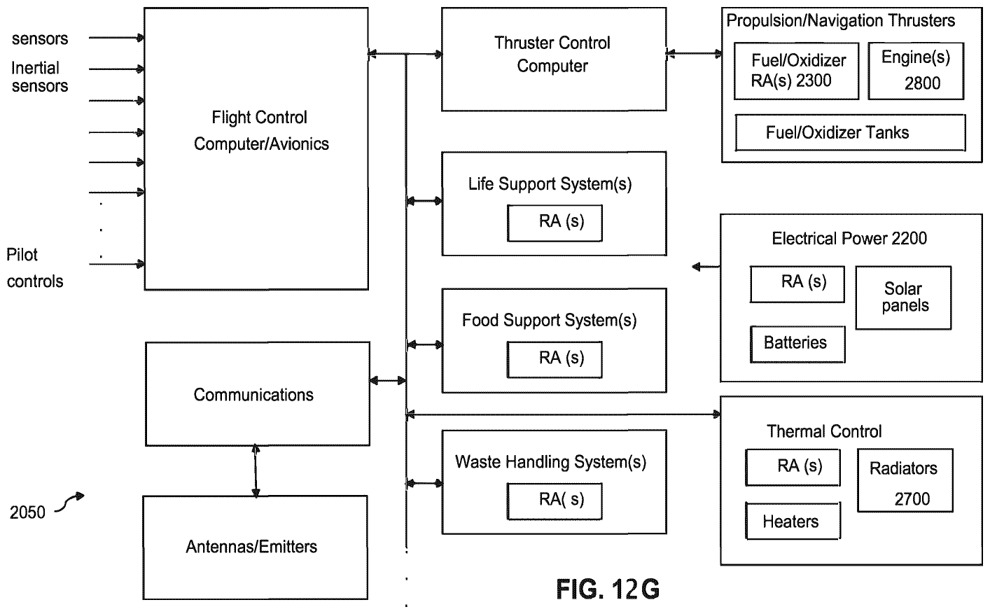

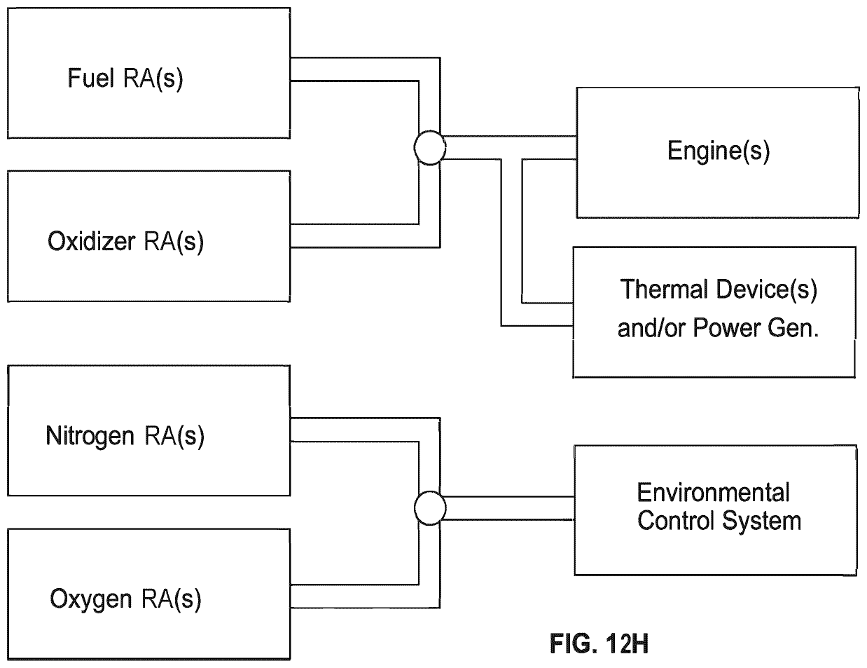

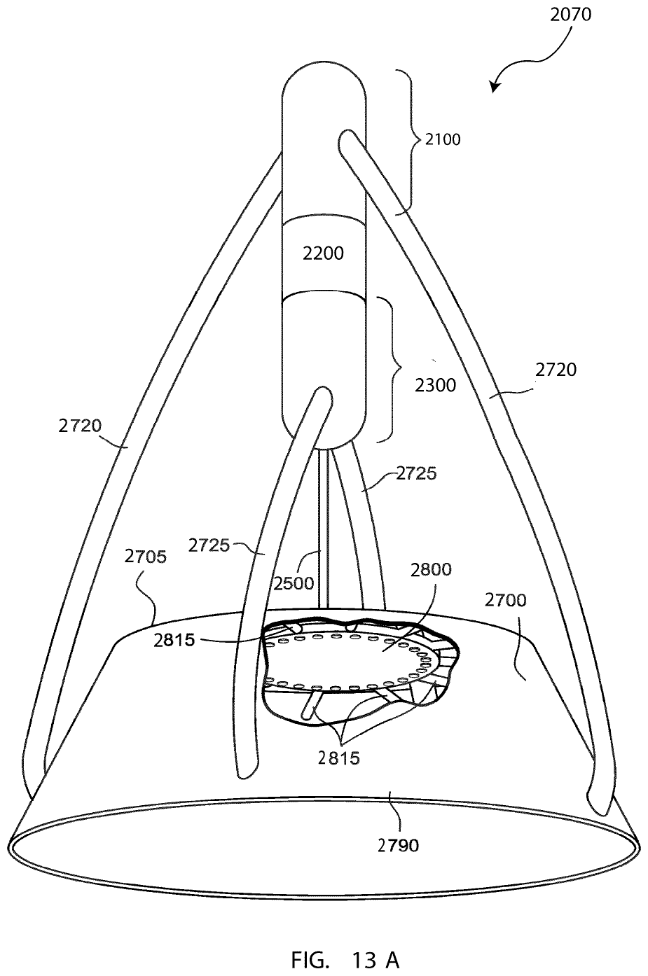

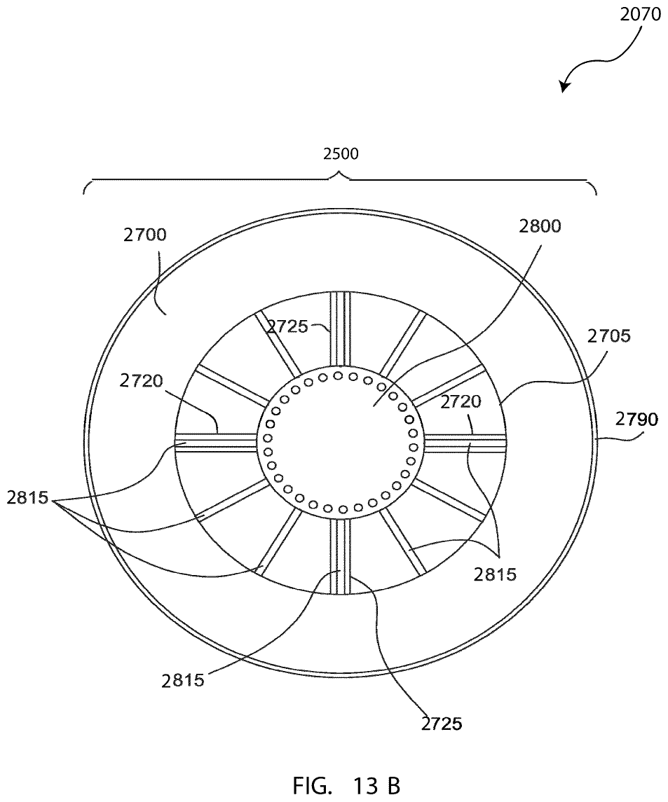

In embodiments, the ECE systems described above can be advantageously employed to power vehicles and other machines intended to operate in anaerobic environments, such as vacuums, underwater, or in atmospheres lacking oxygen. An exemplary vehicle consistent with the principles of the invention is depicted schematically in FIGS. 12A-12H. These Figures illustrate aspects of an embodiment of a vehicle suitable for supra-atmospheric travel, whether manned by human pilots or unmanned. Features having the same number are the same in each of the Figures.

FIG. 12A depicts an embodiment of a vehicle for long-range travel 2050, including a payload 2100; an ancillary electrical power bay 2200; secondary radiator structures 2280; fuel production and propellant loci 2300; secondary guidance propulsion; conduits 2500 for power cables, signal cables, fuel, oxidizer, and propellant and possible adjuvant primary heat deflector 2600; securing structures 2610; radiator structures 2700; and primary propulsion locus 2800. FIGS. 12B-12F depict additional views of the embodiment shown in FIG. 12A, to illustrate more clearly certain features of the embodiment shown in FIG. 12A.

As shown in these Figures, particularly FIGS. 12A, 12B, and 12E, the propellant locus 2300 contains RAs for instantiating propellants in accordance with the systems and methods previously disclosed, including a propellant RA for “Fuel” as indicated on the Figure, and a separate propellant RA for Oxidants (“OX”), as indicated on the Figure.

The propellants instantiated by these RAs react in a combustion chamber (not shown), to produce exhaust gases that are expelled through the nozzle at the primary propulsion locus 2800, thereby providing thrust for propelling the long-range vehicle 2050. Returning to FIG. 12A, the propulsion locus 2800 shows for each propellant a RA bay within which it is instantiated: fuel RA bays 2320 and oxidant RA bays 2340. In embodiments, other sets of RAs can be provided, for example to instantiate, or filter, or isolate, or extract, or nucleate, adjuvants such as xenon, or to instantiate, or filter, or isolate, or extract, or nucleate, other fuels or oxidants. Depending on the adjuvant, certain embodiments may be able to mix adjuvant with fuel and deliver them together as a fuel mixture, or for an inert adjuvant (such as xenon for example), to mix adjuvant and oxidizer together and deliver them to the propulsion chambers through a common sub-conduit.

In between the propellant bays are service access passages 2330 running along the backbone of the vehicle 2040, which can be used to house power and signal cables and the like. Within the core of the vehicle is a conduit 2500 that delivers fuel, oxidizer, adjuvant propellant, power, and control and sensor connections through different subconduits to different components of the vehicle. The conduit 2500 can be envisioned as the backbone of the vehicle 2050, passing through an opening in the primary heat deflector 2600 and avoiding contact with the heated elements of the vehicle, except where it interfaces with the primary propulsion locus 2800, as shown in FIG. 12B. The outside surface of conduit 2500 is covered with heat-reflective material to ward away stray heat emitted from the narrow interior edge 2710 of each radiator structure 2700 fin which is exposed to the conduit 2500. Heat management is performed by a primary heat deflector 2600 and by radiator structures 2700. In the depicted embodiment, the primary heat deflector 2600 deflects any primary heat emitted by the radiator structures 2700 or the primary propulsion locus 2800 where the exhaust gases are emitted. The top and bottom surfaces of the primary heat deflector 2600 can be reflective, sandwiching a sturdy non-conductive interior. The radiator structures 2700 are heat conductive structure(s) with heat emissive surface(s). Due to fundamental thermodynamic inefficiencies, a significant fraction of the energy created by the combustion process to produce thrust also generates unwanted heat by-product which will, if not dealt with on an on-going basis, ultimately flow through the entire vessel, building up heat. Energy produced by combustion can be used in three ways: (i) as forward thrust, increasing the vehicle's kinetic energy, (ii) as hot propellant which is expelled, and (iii) as radiant (heat) energy emitted from the surface of the vehicle. The radiator structures 2700 are configured to conduct heat away from the vehicle 2050 overall, in particular the propulsion locus 2800. To this end, radiators 2700 ideally comprise an emissive surface supported by a structure capable of rapidly conducting heat from the primary propulsion locus 2800 to the entirety of that emissive surface; the heat-conducting structure may be capable of moving and distributing the heat as fast as it is produced and delivered through the primary propulsion locus 2800; and the emissive surface may be capable of radiating the heat as fast as conduction delivers it. There are many radiator designs suitable for these purposes, but the depicted embodiment is not intended to limit those potential designs. Instead, the invention is intended to employ or encompass any radiator design capable of remediating the heat produced by prolonged operation of the propulsion system.

The ancillary electrical power bay 2200 can employ the systems and methods of the present invention to produce electrical power, as shown schematically in FIGS. 12G and 12H. Fuel cells can be powered by redox reactions as shown in these Figures to power the ancillary systems shown in these Figures, including without limitation to accomplish secondary functions such as flight control, thruster control, communications, life and food support, environmental control, and thermal control. Advantageously, the electrical power bay 2200 can contain its own sources of fuel and oxidizer, without drawing from the larger stores of propellants contained in the propellant loci 2300. This design is more “self-contained” and modular and avoids the need to pump fuel and oxidizer “upward” against the acceleration “g”-force. Power cables (not illustrated) run from power sources here to destinations and equipment throughout the vehicle: including payload 2100, to and through ancillary electrical power bay 2200, to and through fuel production and propellant loci 2300, to and through conduits 2500, and generally to all components of the vehicle 2050. In one embodiment, the fuel cells within ancillary electrical power bay 2200 generate heat by-product approximately proportional to the power generated. In the exemplary embodiment, the fuel cells are organized in such a way to conduct this excess heat by-product toward the outer wall of the interior of ancillary electrical power bay 2200 where it can flow therefrom to the emissive outside surface where it can be discharged and/or radiated. In embodiments, the radiator function performed by the radiator structures 2700 is supplemented by radiator capacity provided by secondary radiator fins 2280. These structures function like radiators 2700, but they can be made much smaller in size, particularly if their main objective is to dissipate heat that is produced by the ancillary power bay 2200. If the ancillary power bay 2200 is expected to produce more heat than can be discharged by the surface of this structure, secondary radiator fins 2280 can be added to aid with heat management in this area.

In the depicted embodiment, the primary heat deflector 2600 is shaped as an annulus 2620, allowing the passage of the conduit 2500 through its center. The primary heat deflector 2600 also acts as a structural link, connecting the upper structural components (the payload 2100, the electrical power bay 2200, and the fuel production and propellant loci 2300) to the lower structural components (the radiator structures 2700, and the primary propulsion locus 2800). The upper components are attached to the primary heat deflector 2600 with struts 2610, while the lower structural components are attached to the primary heat deflector by the radiator structures 2700. The struts are sturdy, and are not employed for heat conduction.

As shown in FIG. 12B, the inner edge 2710 of radiator structure 2700 fin faces the conduit 2500 but is distanced from it, in order to limit as much as possible, heat reaching the conduit 2500. FIG. 12C depicts the undersurface of the vehicle looking up, showing the relationship in the transverse plane of the primary propulsion locus 2800, the radiators 2700, and the primary heat deflector 2600.

FIG. 12B depicts the vehicle 2050 illustrated in FIG. 12A, but with cutaways to show arrangement of interior structures. In the embodiment illustrated in FIG. 12B, the propellant locus 2300 is designed to contain at least one fuel RA bay 2320, an oxidant RA bay 2340, and service access passages 2330, as seen through a cutaway 2370. FIG. 12E provides a cross-sectional view showing the arrangement of the RA bays within the propellant locus 2300. In embodiments, a RA bay can be provided for instantiating an auxiliary or adjuvant material. Note that while each of the production loci (2340 for oxidizer, 2320 for fuel, or for adjuvant (not shown)) can be a bay with a cylindrical housing, embodiments may implement these functions in any manner using any desired structure. Furthermore, depending on an embodiment's engineering constraints, any of these loci, in addition to producing material with RAs, may also perform additional functions and take additional steps such as, for example and without limitation (as described above in connection with “conduit”), those of being: collected, combined, combined with the output of other RAs, stored, pressurized, compressed, liquefied, pumped, filtered, gated, injected, diverted, monitored, regulated, accumulated, cooled, heated, or otherwise processed through use of components including for example without limitation: pumps, sensors, injectors, valves, relays, controls, accumulators, reservoirs, tanks, fans, pressurizers, compressors, refrigerators, heaters, liquefiers, and sensors and controls for flow, concentration, temperature, humidity, volume, and pressure, as well as other sensors and controls and processing equipment. Each step or operation may be performed zero or more times, and the order in which they are performed (and whether they are necessary) may depend on a particular implementation's design, tradeoffs, and constraints.

FIGS. 12B, 12D, and 12F illustrate features of the vehicle permitting secondary guidance propulsion. Propulsion/combustion chambers, thrusters, and the like can be situated at strategic points, such as fore and aft with various lateral orientations, to provide course adjustment and alignment maneuvers such as docking and (e.g., midway to destination) reversing vehicle orientation to begin deceleration. In one embodiment, there are eight pairs of secondary alignment/guidance thrusters: four thruster pairs (2411/2414, 2415/2412, 2413/2416, 2417/2410) fore (illustrated in FIG. 12D) and four thruster pairs (2421/2424, 2425/2422, 2423/2426, 427/420) aft (illustrated in FIG. 12F), each pair situated at one of the four cardinal points, with the two members of each pair oriented 90° apart, each 45° off the normal. Used in proper combination, these 16 alignment thrusters permit maneuvers along all axes, and provide redundancy in event of thruster failure. Because these thrusters are used only rarely for short bursts (typically only of a few seconds), there is no need for an elaborate and extensive heat dissipation system similar to 2700. These small thrusters can be self-contained expulsive combustion engines, each with its own sets of RAs for fuel and oxidizer production. In other embodiments, these small thrusters can be implemented as self-contained electric thruster units each with their own proximate RAs for propellant (e.g., xenon) production. Power for such thrusters may be provided centrally from the ancillary power bay 2200, or otherwise.

In embodiments, there are three categories of thrusters: Lift thrusters, forward thrusters, and steering thrusters. Lift thrusters (“lifters”) are directed “downward.” These can serve to act against a gravity field, keeping the craft suspended in, or propelling it away from, the gravity source. Forward thrusters (“pushers”) are directed “backward.” For embodiments having a clearly identified “front,” these thrusters can serve to propel the craft “forward” which is considered to be the direction of primary lateral motion, a direction which is typically orthogonal to “downward.” For embodiments without a clearly identified front, or forward direction, there may be no clearly distinguished category of forward thrusters, lateral motion being achieved instead by combinations of steering thrusters. For embodiments, that may lack pusher engines, reasonable forward motion in the atmosphere (or within any gravity influence) can also be achieved by pitching down slightly, helicopter-like, and vectoring some lifter force into forward motion. Steering (“trim”) thrusters are used to adjust the orientation of the craft, including “turning”, yaw (rotation around the up-to-down axis); roll (rotation around the front-to-back axis); pitch (rotation around the left-to-right axis); and lateral translation (some rigid motion not involving yaw, in a plane orthogonal to “downward”).

ii. ECE Systems for Powering Vehicles

ECE systems based on combustion chemistry, as described above, are particularly advantageous for powering vehicles. As taught above, RAs in the vehicle produce fuel and oxidizing agent (e.g., hydrogen and oxygen) that can be conducted to at least one propulsion (combustion or reaction) chamber where they are combined in a combustion reaction to produce thrust that propels the vehicle. In some embodiments, RAs may also produce propellant adjuvants that are conducted to the propulsion chamber where they are added during combustion to affect some aspect of the reaction and/or exhaust, such as for example, without limitation: the temperature, heat, velocity, momentum, or kinetic energy. Effective reaction temperature can also be moderated by using a fuel (e.g., hydrogen) rich mixture so that the reaction energy is divided into a greater mass.

One exemplary embodiment of an ECE system uses RA(s) to create three gases: hydrogen, oxygen and a propellant adjuvant such as xenon. Among the various engineering trade-offs, this embodiment chooses to somewhat reduce the combustion temperature in favor of increasing the longevity of the combustion chamber. The full stoichiometric combustion temperature of oxygen-hydrogen is about 2,800° C. (5,100° F.), which is hotter than most materials can tolerate. Therefore, techniques for managing the temperature are employed, as would be familiar in the art. For example, ablative surfaces can be used as combustion chamber linings, or heavy inert materials such as xenon gas can be added to the combustion chamber. Decreased temperature leads to decreased thrust however, although this is somewhat (although not entirely) offset by the increased mass expelled. Sufficiently reducing temperature can improve combustion chamber longevity. In other embodiments, the combustion temperature can be decreased by adding together the two combustion gases (hydrogen and oxygen, for example) to create a fuel-rich combustion mixture. This again reduces temperature by distributing the energy of those hydrogen molecules which do react across the mass of the residual unburned hydrogen. Although the exhaust velocity is proportional to the square root of the energy content per gram of propellant, it is also inversely proportional to the mass of the individual exhaust molecules. Thus, such an embodiment should be able to reduce temperature by using excess hydrogen, without sacrificing as much overall exhaust velocity. Similar results can be obtained using an oxidant-rich mixture. In some embodiments, RAs as described herein can also produce propellant adjuvants that are conducted to the propulsion chamber where they are added during combustion to affect some aspect of the reaction and/or exhaust, such as for example, without limitation: the temperature, heat, velocity, momentum, or kinetic energy. As an example, aluminum can be added to convert some of the heat energy to kinetic energy, thus reducing the temperature, and thereby enhancing combustion chamber longevity.

iii. Special Principles of Vehicle Design

In recognition of the special challenges of long-range and supra-atmospheric travel and vehicle design, certain features of the invention are discussed below in more detail.

### a) Long Duration Flight Principles

Propulsion mechanisms such as expulsive combustion propulsion that integrate the RA technology disclosed herein offer the prospect of a prolonged flight range, constrained only by practical matters such as reliability, maintenance, equipment endurance, and crew lifetime. While not all vehicles are designed to withstand the stresses of lift-off from an earthbound launching pad, it is envisioned that these vehicles can be directed into earth orbit as components that can be assembled while orbiting; once assembled, they can accelerate away from the Earth's residual gravity towards their destination. The vehicle is desirably self-sustaining once assembled, which is consistent with the principles of the invention. The RA technologies disclosed herein permit the generation of propellants and materials for life support. For example, once travel is underway, the on-board RAs can provide abundant propellant and fuel. Furthermore, closed cycle life-support systems already familiar in the art can be augmented with RAs to replenish necessary components such as gases for breathing and fluids for hydration as they are gradually consumed during the voyage.

Once a craft has been accelerated to travel in a desired trajectory at a desired velocity in a vacuum, it experiences substantially no drag or other effects due to atmosphere or other friction. Rather, under Newton's First Law of Motion, the craft will continue on an initial trajectory at an initial velocity until a force is applied to change its trajectory and/or velocity. Once the vehicle is underway on its chosen course at the chosen velocity, the only thrust required is for navigational purposes, to change course or velocity. With little thrust required during the duration of the flight, a relatively small amount of propellant will be required. Therefore, low-capacity output RAs can be designed that are sufficient to provide power for navigation and course correction. Moreover, because the propulsion of the vehicle is not materially constrained by fuel or propellant availability, it can be accelerated continuously or intermittently during flight to reach a desired velocity, with no resource-limited upper limit.

As an example, the propellant tanks of the vehicle can be filled to capacity when the vehicle is launched, with the RAs available to replenish the amount of propellant used for navigational purposes. In embodiments, any suitable gas can also be used as a propellant without undergoing a chemical reaction; the gas can simply be delivered to a propellant nozzle, which can eject the gas “as is” without any chemical reaction to provide an acceleration effect. Furthermore, as has been previously described for expulsive combustion engines, any suitable fuels and oxidizing agents can be used to produce combustion, or propellants can be provided that combine in hypergolic reactions, such as the reaction between NO₂ and dimethyl hydrazine as an example. A given vehicle could use either or both mechanisms for generating thrusts.

In designing a vehicle based on the principles of the invention as disclosed herein, a preliminary decision is typically made about the temperature that needs to be achieved in the combustion chamber to generate the desired thrust. Once that temperature has been determined, appropriate strategies for thermal management can be devised. Achieving and sustaining the desirable temperature for combustion is limited by the physical characteristics and heat tolerances of those materials forming the vehicle's chambers and nozzles, and by the ability of thermal management systems to discharge, on a continuing basis, the excess heat by-product generated by combustion.

Thus, once a combustion temperature is determined, the properties of the combustion chamber, the nozzles, engine arrangements, radiator materials, and the like, can be specified, with appropriate components being selected and integrated into the supporting subsystems that make it possible to create and sustain the desired combustion temperature. These components all become components of the vehicle's overall architecture. The total mass of the engines, radiator structures, vehicle body, infrastructures, RA apparatus, support systems, plumbing, and expected payload (essentially the vehicle's operational mass) can be summed, and divided into the expected aggregate engine thrust when operating at engine temperature to calculate the acceleration that the overall vehicle can produce. If this is near to or less than 9.8 m/s/s (Earth's surface gravity) then the vehicle cannot be reliably launched from or land on, Earth under its own power; however, such vehicles can be assembled outside the Earth's atmosphere and deployed for supra-atmospheric travel during their operational lives. If the acceleration exceeds 9.8 m/s/s by, say 10%, 20%, or more, then the vehicle can be launched from and land upon Earth's surface.

### b) Thermal Management and Radiator Design

For those vehicles intended for travel as disclosed herein, thermal management focuses on protection and preservation of the materials forming the vehicle. Of particular importance are the thermal attributes of those materials comprising the propulsion chamber(s) and nozzle(s). Candidate materials to consider for nozzle(s) and combustion/propulsion chamber(s) include, without limitation hafnium carbide (with a melting point of 3,958° C. (7,156° F.)), tantalum carbide (with a melting point of 3,768° C. (6,814° F.)), tungsten (with a melting point of 3,422° C. (6,192° F.)), cubic boron nitride (with a melting point of 2,973° C. (5,383° F.)), tungsten carbide (with a melting point of 2,770° C. (5,018° F.)), molybdenum (with a melting point of 2,623° C. (4,753° F.)), niobium (columbium) (with a melting point of 2,468° C. (4,474° F.)), tungsten-molybdenum alloys, Inconel® alloys (i.e., alloys of nickel, chromium and often cobalt, generally with smaller amounts of niobium, molybdenum, iron, and a variety of other elements to give different properties to the alloy), graphite tungsten aluminum alloys, carbon/carbon (C/C) composites (heat resistant up to 3,000° C. and higher), and the like.

In general, the propulsion chamber design is open to many avenues of implementation, falling into two primary categories: traditional combustion chambers, and magnetic containment. Physical propulsion chambers associated with chemical and atomic propulsion are constructed from materials that are able to endure long term stresses of hot propellant under high pressure. Since thrust is positively correlated to the mass of the propellant, its temperature, its pressure, and its exit velocity, the more resistant the chamber is to heat and pressure, the more efficient the vehicle's performance. Physical propulsion chambers can be constructed to serve as good thermal conductors in order to carry away the excess heat by-product left over after producing the thrust that is expelled from the chamber as hot exhaust, or that is discharged immediately as radiant energy by the nozzles. Unlike atmospheric jet engines that can be cooled by contact with air (conduction and convection), and unlike traditional chemically-powered vehicles in which the amount of energy to be dissipated is materially limited by the amount of fuel they carry, propulsion chambers for vehicles in accordance with the principles of the invention can be subject to much longer unmitigated fuel burns. Thus, unless the excess heat can be conducted away from vulnerable components and dissipated, the heat will lead to material failure. In such vehicles, heat can be managed through conduction and radiant loss. Conduction can shift the heat to other parts of the vehicle, but the vehicle as a whole must be able to radiantly discharge all excess heat. In supra-atmospheric environments, excess heat can be ultimately discharged by radiative emission from the outward facing vessel surfaces of sufficient area.

The overall need for heat management can be incorporated in the design and structure of the vehicle. Aspects of radiator design include without limitation: size, strength, extent, shape, weight, composition, materials, position, structure, construction, geometry, configuration, thermal emissivity, thermal conductivity, thermal reflectivity, and thermal insulation, and depend on engineering constraints and requirements specific to each embodiment. Depending on the amount of heat, it is possible that the vehicle's natural surface geometry can suffice for heat dissipation, although in embodiments requiring maximum ongoing thrust, the engines can produce energy that exceeds the vehicle design's capacity to discharge it. To improve steady-state radiant discharge rates to allow prolonged propulsion, radiators and other similar heat-discharging features can be added to the design, such as radiative fins, “wings”, shells, and other emissive surfaces, to improve the vase vehicle's ability to discharge heat. Exemplary materials for radiators and other heat-discharging features include: (i) materials that are thermally radiative, i.e., with high emissivity coefficients (EC), ideally near 0.9 or higher such as lampblack paint (EC 0.98), certain tiles (EC 0.97), anodized aluminum (EC 0.9), oxidized copper (EC 0.87), oxidized steel (EC 0.79), and carbon (graphite) (EC 0.7 to 0.8 at temperatures up to 3600° C.), (ii) thermally low radiative materials (low EC), such as polished gold (EC 0.025), aluminum foil (EC 0.03), polished silver (EC 0.02 to 0.03), unpolished silver (EC 0.04), polished copper (EC 0.04), and polished steel (EC 0.07); (iii) thermally conducting materials, such as cubic boron nitride (which is also very hard, strong, and thermally stable to over 2900° C., making it particularly suitable as a propulsion chamber material), diamonds (1000 W/(m K)), silicon carbide (120 W/(m K)), copper (401 W/(m K) @ 0° C., 383 W/(m K) @ 327° C., 371 W/(m K) @ 527° C., 357 W/(m K) @ 727° C., 342 W/(m K) @ 927° C.), gold (318 W/(m K) @ 0° C., 304 W/(m K) @ 327° C., 292 W/(m K) @ 527° C., 278 W/(m K) @ 727° C., and 262 W/(m K) @ 927° C.), aluminum (236 W/(m K) @ 0° C., 232 W/(m K) @ 327° C., 220 W/(m K) @ 527° C.), (iv) thermally insulating materials, as are known in the art; and (v) combinations of the foregoing, which can be more emissive, more conducting, more insulating, less conductive, less emissive, more reflective, more weight-bearing, and/or lighter than any single material alone.

Advantageously, radiators for vehicles can be constructed in layers: Layers can be grouped in the following general categories, although this list is intended to be non-limiting: (i) an outer surface layer, exposed to the environment which can be covered or coated with thermally radiative material(s) having a high emissivity coefficient; such as, for example: lampblack paint, tile, graphite, or anodized aluminum; (ii) a layer adjacent to (i) that can comprise one or more layers of highly thermally-conductive material(s) such as diamond, cubic boron nitrite, or copper designed to rapidly move/diffuse heat to the widest possible area; (iii) a weight bearing structural layer, such as a body structure or struts or ribs, to support the other layers; and (iv) a thermally insulative layer deployed interiorly. In embodiments, radiators can be tightly coupled physically to the combustion/propulsion chamber(s), nozzle(s), and heat sources to expedite heat flow from them into the radiator(s). In embodiments, radiators can be constructed as two-sided fins where both sides are exposed to the environment and both can be used to emit heat. Moving through a two-sided radiative “fin” one might find layers (i), (ii), (iii), (ii), (i) in that order. In embodiments, some of the layers can be combined, for example by integrating layers (ii) & (iii) into a common layer covered on each side with (i), so that the layers are arranged in the fin in the following order (i), (ii/iii), (i). In other embodiments, radiators can be constructed where the outside is emissive and the inside is insulative, used in circumstances such as the vehicle's “skin.” Moving inward through such a one-sided radiative surface, one might find layers in the following orders: (i), (ii), (iii), (iv) or (i), (ii), (iv), (iii). Other configurations of layers can be readily envisioned.

In embodiments, the radiator surface can be configured as a large external shell firmly attached to the hot propulsion components by strong, thermally conducting connections, but held away from the main vessel by weight-bearing, thermally non-conducting struts or other attachments. Advantageously, the radiator shells are held away from the main payload and other temperature sensitive part(s) of the vehicle using attachments or struts that are not thermally conductive or that are insulative. Such a shell can be formed in any convenient geometry, for example in the shape of a cylinder, a sphere, an ellipsoid, a truncated sphere, ellipsoid, paraboloid, hyperboloid, or other conic section of rotation, a truncated cone or pyramid facing rearward, a geodesic dome, sphere, or other structure rendered geodesically, with any of these shapes facing in any desired direction. In embodiments, any geometry for a radiator shell can be employed, or any combination of geometries that effectively radiates heat away from the areas of heat concentration on the vehicle, and/or that prevents heat reaching the payload or other thermally sensitive areas. In embodiments, the radiator can be configured so that the radiating surface is held, positioned, and contoured to reduce the amount of the radiating surface “visible” to the vessel's payload or other thermally sensitive areas, thereby reducing the amount of radiated heat incident upon the payload or other thermally sensitive areas. In embodiments, the radiator can be configured as a radiative surface or surfaces attached to the vehicle in a way that conducts heat from the propulsion chambers to the surface(s). In some exemplary designs, radiator designs can optionally embody one or more of features such as: a layered design in which emissive materials are outward facing (away from the payload), toward the external environment; a layered design that comprises more conducting materials underneath (closer to the payload) the more emissive layers, thereby more effectively distributing heat to the emissive layer(s); a layered design in which certain layers have more weight-bearing strength than others; a layered design with insulating materials buffering heat flow as needed, for example, between conducting layers and a low emissive layer; or a layered design with less emissive more inward (closer to the payload or facing the payload).

In choosing appropriate geometric configurations for the radiating surface, in particular for those radiators that mostly or partially surround the payload, the goal is reduce the amount of heat that is radiated back toward the payload or other thermally sensitive areas of the vessel. This can be accomplished by constructing a radiator as a spherical shell surrounding the payload and attached to the (hot) propulsion engines by thermally conducting struts that conduct the propulsion heat byproducts into the shell. The conductive layer in the shell can distribute heat rapidly through the shell, while the emissive layer on the outer surface of the shell, positioned on top of the conducting layer, can emit heat into the surrounding environment. In steady state operations, parts of this shell will be hot, but the emissive exterior of the shell will radiate a large proportion of heat away from the vessel into the environment. However, the inner aspect of the shell will also tend to radiate some portion of the heat into the shell's interior, back toward the vessel and back towards other parts of the inner shell surface, tending to warm the vehicle. This effect can be countered, if necessary, by putting a low emissivity layer on the interior shell surface (facing the payload), and adding a reflective, low emissivity surface to the payload or other areas undesirably affected by the heat. In embodiments, other insulating layers can be positioned between the conducting and the inner low-emissivity layers.

In embodiments, the radiator(s) are attached to the propulsion chamber. A radiator can be substantially supported by this attachment, which then requires that the attachment component be weight-bearing, as well as heat tolerant and thermally conductive. This might entail a thicker or more massive structure for support, with the support made from different materials than other parts of the radiator. Veins or ribs in or near the radiator surface can also provide structural strength, facilitate heat transfer, or both. In an embodiment, a “vascular” arrangement can be designed in which thicker, stronger, and/or more conductive trunks branch out into lighter, smaller, thinner structures as the need to support weight and to transfer and tolerate heat diminishes with distance from the propulsion chamber(s). Parts of the supporting components at different distances from the propulsion chamber(s) may be fashioned to have different properties, using different materials, dimensions, thickness, weights, etc. The design of these structures can vary, depending on how much weight, strength, emissivity, conductivity, heat tolerance, and the like, is required at a given portion of the surface. Areas further from the propulsion chamber(s) are likely to be cooler, and may not be required to support as much weight, or tolerate, conduct, or emit as much heat as areas closer to the propulsion chamber(s). In exemplary embodiments, a honeycomb-like grid of cells of hexagonal, pentagonal, square, triangular, and/or other geometric shapes can be attached to and can spread out from the propulsion chamber(s). This grid can serve to transfer heat to an emissive material surfacing each cell, and/or can support the weight of a radiator surface.

The size and shape of the radiator surfaces, as well as their attachment mechanisms, can be determined based on the overall engineering principles that guide the construction of the vehicle, including its overall mass, projected acceleration demands, and the envisioned needs for thrust. It is understood that the thrust is positively correlated to the heat produced by the propulsion chamber(s), and that the area required for an emissive radiant surface area is positively correlated to heat production. Designs for radiator surfaces and their supporting structures can be determined based on these and other engineering factors familiar to artisans ordinarily skilled in the field of vehicular construction.

### 5. Expulsive Combustion Engine Systems Using Instantiated Fuels: Second Exemplary Embodiment

a. Engine Systems for Vehicles

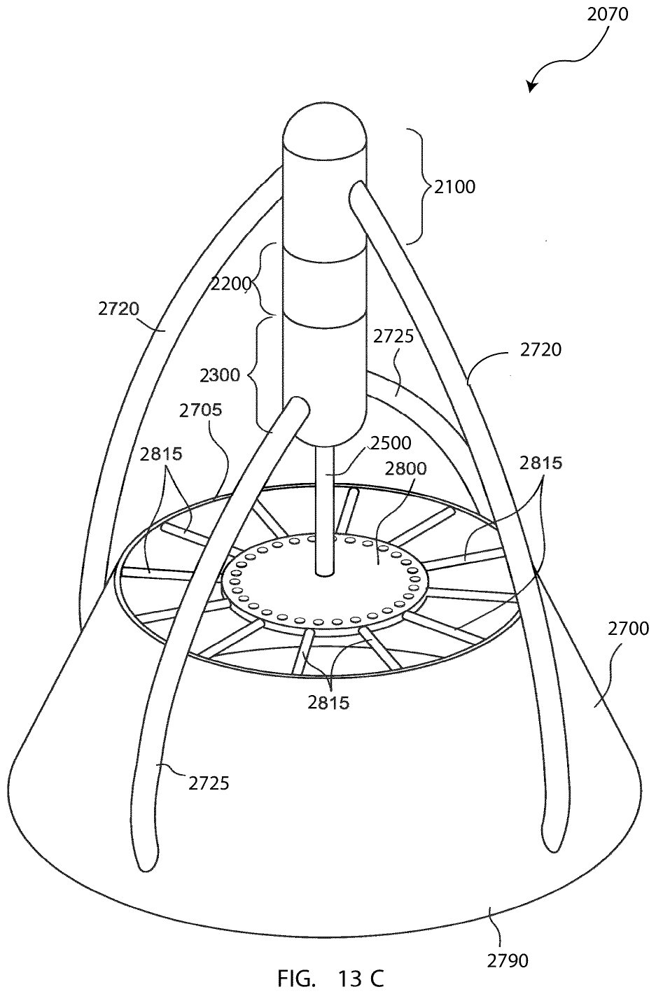

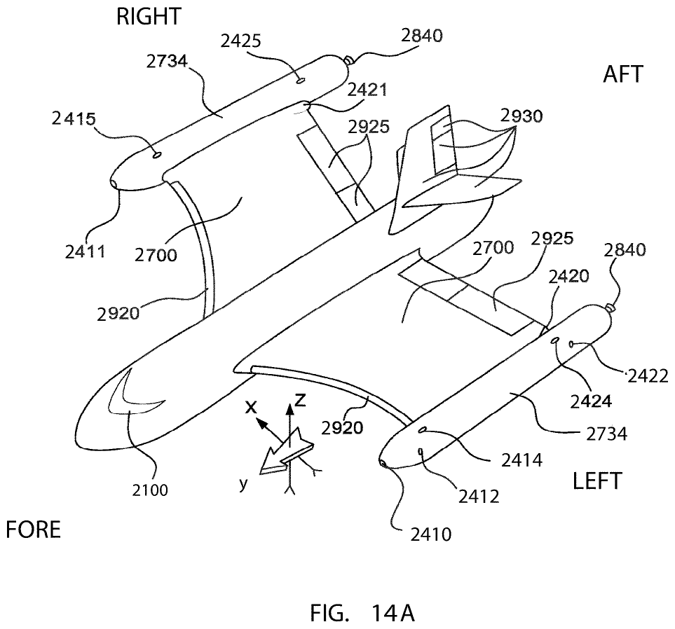

As has been described above, ECE systems can be advantageously employed to power vehicles and other machines intended to operate in anaerobic environments, such as a vacuum, underwater, etc. Another exemplary vehicle consistent with the principles of the invention is depicted schematically in FIGS. 13A-13C. These Figures illustrate an embodiment of a vehicle suitable for long-range travel or other travel, whether manned by human pilots or unmanned. Numbered features having the same number in different figures represent the same feature in each of the Figures.

As shown in FIG. 13A, a vehicle 2070 comprises a payload pod 2100, a propellant locus 2300, with an electrical power bay 2200 disposed between the payload pod 2100 and the propellant locus 2300 and attached to the distal end of the payload pod 2100 and the proximal end of the propellant locus 2300, so that all three structures together form a single unified structure. The payload pod 2100 can carry any payload, including living beings, such as human or animal passengers or crew for the vehicle. The electrical power bay 2200 contains equipment for producing and storing electrical power as may be needed for functions on the vehicle such as secondary functions. The propellant locus 2300 produces the fuel and the oxidant for combustion to propel the vehicle, in keeping with the principles of the invention as described herein. The fuel and oxidant produced in the propellant locus is directed into the propulsion locus 2800 through one or more conduits 2500. A plurality of downward directed propulsion chambers are arranged radially within the propulsion locus 2800, with each propulsion chamber having a nozzle (not identified) through which the exhaust gases generated by the combustion of fuel and oxidant in that combustion chamber are expelled from the combustion chamber in a downward direction to produce thrust that moves the vehicle in the opposite direction, i.e., upward. The propulsion locus 2800 is attached to the radiator 2700 at or near the upper edge 2705 of the radiator 2700, which is attached to the periphery of the propulsion locus 2800 by strong heat-conducting members 2815 such as struts or spokes. The expelled gases (not shown) from the propulsion locus 2800 pass through the open central portion of the radiator 2700. The arrangement of the heat-conducting members 2815 is also depicted in FIG. 13B, in which a transverse section of the vehicle 2070 allows the radially directed orientation of the members 2815 to be appreciated.

The radiator 2700 extends distally from its points of proximal attachment to the propulsion locus in the shape of a truncated cone, with its lower edge 2790 forming the open-ended skirt at the bottom of the vehicle 2070. The exhaust gases are expelled along an exit path into the open area defined by the interior aspect of the radiator 2700. The outer surface of the radiator 2700 is highly heat-emissive. The top of the radiator 2700 can be a sturdy heat-conducting disk that connects the radiator 2700 to the propulsion locus 2800 so the chambers of the propulsion locus 2800 are directed downward from or through the top of the radiator 2700. In embodiments, the high velocity expelled exhaust gases (not shown) move downward through the open distal end of the radiator 2700 as a hot narrow blast stream, exiting the radiator enclosure 2700 through its lower edge 2790 without directly impinging on the radiator 2700 itself. Heat energy produced by the propulsion locus 2800 can flow by thermal conduction into the radiator 700 to be emitted into the environment, thereby being dissipated. In steady-state operation, the radiator 2700 will experience a temperature/heat gradient with the highest values near its upper edge 2705, where the radiator 2700 is closes to the propulsion locus 2800 connection.

The payload pod 2100 is positioned at the top of vehicle 2070. The radiator 2700 is secured to the payload pod 2100 by a set of long struts 2720 that attach at a distal portion of the radiator 2700, where the heat of the radiator 2700 is less than it is more proximally. In embodiments, the payload pod 2100 has a reflective surface in whole or in part, with reflective surfaces also provided for the propellant locus 2300, especially the lower part. The radiator 2700 is secured to the propellant locus 2300 by a set of shorter struts 2725, which also are affixed to the distal portion of the radiator. The long struts 2720 and the shorter struts 2725 can be made of sturdy non-thermally conductive materials, with their inner aspects (facing the radiator 2700) being reflective in order to conduct, and reabsorb, as little heat as possible from the radiator's outer surface, and with their outward-facing surfaces (facing towards the environment, away from the radiator 2700) being emissive in order to radiate away any stray heat it may have acquired to protect the propellant locus 2300 and the payload pod 2100 from heat exposure. In embodiments, the radiant heat lost by the payload pod 2100 will equal or exceed the heat that (i) is generated within the pod itself; (ii) is received by conduction through the cabin struts from the radiator, and (iii) is reabsorbed from radiant heat dissipated by the rest of the ship. If some heat accumulates, then it can be discharged; heat discharge or cooling is understood to be a secondary function that can be performed by including a heat discharge or cooling subsystem, which subsystem can be powered by the systems and methods of the present invention as disclosed herein. In embodiments, a heat discharge or cooling subsystem can comprise one or more RA devices that assemble a substance, such as a gas, that can be employed using refrigeration or heat pump techniques to extract excess heat from one or more components of the vehicle, with the heated substance then being jettisoned from the vehicle or otherwise disposed of or recycled.

The technology disclosed herein contemplates a wide variety of design possibilities, depending for example on mission intention: interstellar multi-decade operation imposes a different and more stringent, set of constraints than intra-solar system operation involving runs of days or weeks. With different mission intentions come engineering and cost trade-offs, and the vehicles can be customized accordingly. For example, the payload of a vehicle for longer-range travel can be designed to support a larger number of passengers and support their community with appropriate amenities, while a vehicle for shorter voyages can be much simpler and smaller, designed to support a smaller number of occupants or instead designed for unmanned use.

i. Primary and Secondary Propulsion

Primary propulsion drives the vehicle in its main, major, direction of travel. As explained above, such vehicles also will typically require additional propulsion in directions or for purposes apart from the primary propulsion. Such secondary propulsion systems can be used for functions such as guidance, course correction, and maneuvering, although it may be possible in some embodiments for the primary propulsion system to be used for such secondary functions as well. For example, primary propulsion can be used to accomplish secondary propulsion functions by manipulating and redirecting some energy from the primary thrust flow with the use of control surfaces such as flaps, louvers, diverters, “ailerons”, etc. and/or magnetic or electromagnetic fields.

In embodiments, secondary propulsion for vehicles can be provided by one or more engine units that are mounted to provide lateral thrust. Such engines can involve any appropriate mechanisms for propulsion, and can be the same as or different than each other, and the same as or different than the engine unit used for primary propulsion. Chemical or electromagnetic propulsion is especially favored, especially in situations where the engine is only used infrequently and for short periods of time. In some embodiments, these secondary engines can be pivotable or otherwise capable of being oriented to provide thrust in a particular direction.

In embodiments, a vehicle can be propelled by only a single primary propulsion engine/thruster. For those vehicles desiring to maintain continuous uniform acceleration, but in which the primary engine needs to have periods of dormancy to avoid overheating or fatigue, engine redundancy is desirable. In vehicles designed for long-range missions or manned missions, or in those vehicles that need to limit continuous operation of a primary engine, or that need to deactivate the engine occasionally for maintenance multiple, redundant, propulsion engines/thrusters are advantageous.

Engine arrangements can be envisioned for vehicles having multiple, redundant engines. For example, engines can be arranged in a circle of 6, 12, 20, 30, 60, etc., around the vehicle's central axis of the direction of travel. In other embodiments, engines can be arranged in patterns derived from hexagons with 7, 19, 37, 61, . . . , 1+3*n*(n−1) engines. This sort of pattern permits a variety of available balanced, radially symmetric, configurations even if multiple engines fail or are inactive. Employing active engines together as in radially symmetric groups is desirable because it eliminates the tendency for yaw or other undesirable direction changes, which otherwise would require active course correction to counteract. A radially symmetric group of engines is any engine pair separated by 180°, any engine triplet by 120°, any engine quintuplet by 72°, etc., where the engines are equidistance from the center. In embodiments, radially balanced groups or subsets of engine groups, can be used in “shifts” or bursts being switched on and off in intervals, offering another mechanism for avoiding heat fatigue and decreasing materials stress.

In an embodiment, a large number of engines can be employed. for example, 60 engines can be arranged radially and symmetrically, with each engine designed to individually supply at least 5% of the total force necessary to maintain a desired one-g (9.8 m/sec/sec) acceleration. Such an array of engines offers flexibility and redundancy, with a large number of balanced engine pairs being available to achieve the one-g acceleration, with no engine needing to be active more than ⅓ of the time, on average. How long each engine can remain active depends on engineering and materials constraints specific to each embodiment.

With this type of resting/recovery strategy, as one symmetric group (e.g., pair) of engines is inactivated, systems control logic in the vehicle's computer processing systems can simultaneously activate another group (having the same number of engines) in a way that provides a smooth and continuous transition. Recognizing that changes in motion and acceleration can be associated with changing the power sources from one set of engines to another, one can include measures to prevent these changes from being problematic. For example, the interval of activation from one set of engines to another can be increased, or larger banks of less powerful engines can be used instead of smaller banks of more powerful engines. To illustrate this latter approach, a bank of 1200 smaller-scale propulsion engines can be constructed, with each supplying only 0.25% of the acceleration or position change, arranged in a suitable geometric pattern, such as a larger hexagonal array of engines with a smaller hexagonal array inside. While more engines can weigh more and will require more infrastructure and plumbing, using less energetic engines can smooth transitions from one bank to another and can sustain longer run intervals with less wear. As another approach, controls can be provided to balance more precisely the power-up and power-down curves by improved throttling. As yet another approach to smooth transitions from one engine bank's activity to another's, a brief acceleration force can be introduced at each transition to better balance any difference between the power-up versus power-down curves. For example, such a brief countervailing force can be produced by a single special engine located at the center point of a ring or other arrangement of primary engine banks. Such a central engine can be of the same or different propulsion class as the primary engines, and can be selected to closely complement the power-up versus power-down differences of the cycles of primary propulsion engines,

The systems and methods disclosed herein are applicable to a large variety of vehicle and other designs intended for various purposes, missions, and needs. Such designs can include, by way of example and not of implementation: (a) designs for short-range voyages, measured in minutes or hours; (b) designs for medium-range voyages, measured in hours or days, such as a voyage from the Earth's surface to Earth orbit or to the Moon, and return; and (c) designs for long-range voyages where constant enduring propulsion over a long time is desirable, from days to weeks to years. For each case, one modality of propulsion can have advantages, but it is understood that propulsion techniques can be advantageously combined and selected for the particular use case. For short-range voyages, chemically-driven engines are appropriate. For medium-range voyages, atomic or electromagnetic propulsion can be used, or combinations of engine types can be employed. For example, a chemical propulsion system can be selected for surface take-off and landing, while an electromagnetic propulsion system can be used outside the Earth's atmosphere. For long-range voyages, especially if the vehicle will be traveling mainly outside any atmosphere, either atomic or electromagnetic propulsion can be used for the entire voyage, or can be combined with a chemical propulsion system if Earth lift-off or landing are envisioned. If the vehicle is constructed outside the Earth's atmosphere so that it does not encounter its resistance and the Earth's gravity, a chemical propulsion system can be eliminated entirely. If such a system is needed initially, for example for leaving the Earth's gravitational field or its atmosphere, it can be discarded, similar to the practice of discarding stages of conventional systems that launch satellites and other supra-atmospheric vehicles. In embodiments, primary engines can be constructed to provide variable thrust, so that they can land on and take off from designated surfaces, and can overcome surface gravity as needed.

As has been previously described, chemically propelled engines are driven by combustion reactions of two or more materials, a fuel and an oxidant, being combined in one or more propulsion chambers. As has been previously described, these materials (both fuels and oxidants) can be instantiated, or filtered, or isolated, or extracted, or nucleated, in sets of RAs. Suitable fuels include those for which a combustion reaction produces rapidly expanding hot gases. Exemplary fuels include materials such as, without limitation, hydrogen, ammonia, various types of alcohols, and various types of hydrocarbons, as have been described previously. Exemplary oxidants include materials such as, without limitation: oxygen, hydrogen peroxide, ozone, the halogens, etc., and various isotopes thereof, as have been described previously. While the systems and methods disclosed herein are suitable for use in both continuous and intermittent combustion engine systems, it may be desirable under certain circumstances to collect propellants into batches and use them intermittently. For example, it might be desirable to collect the propellant into intermediate holding tanks, compressing, liquefying, or otherwise transforming it as necessary, before injecting it into a propulsion chamber for combustion or explosive expansion.

In addition to their uses as primary propellants, expulsive combustion engines using instantiated fuels and oxidants can be used to power auxiliary propulsion units mounted laterally for secondary propulsion, to effect steering, guidance, course correction, and maneuvering. Regardless of the primary propulsion method selected, RAs can also produce reactants onboard for reactions power other energy needs, such as electricity for equipment, computers, and other apparatus and amenities.

As has been previously described, the systems and methods disclosed herein can be used to power electric or electromagnetic propulsion technologies applicable to vehicles. If this sort of propulsion is desired, electricity to power such propulsion can be generated in one of the following ways: (a) reactants produced by RAs such as hydrogen and oxygen can be used in fuel cells to produce electricity; (b) reactants produced by RAs can be combusted, and the energy of combustion can power a generator that produces electricity; or (c) reactants produced by RAs can be used as propellants for propulsion thrusters. As an example, RAs can be used to produce material(s) used as propellants (e.g., xenon, or argon) with at least one electric (or ionic, or plasma) propulsion thruster (such as, without limitation, a Hall-Effect Thruster [HET], VASIMIR, NEXT-C, and the like). In this embodiment, the electricity and the propellant are conducted to the at least one electric propulsion thruster(s), where the electricity is ultimately used by the thruster to accelerate the propellant, thereby producing thrust which propels the vehicle.

ii. Secondary Functions

In addition to the energy used for primary and secondary propulsion, energy is required to accomplish a number of secondary functions for the vehicle. Such secondary vehicle functions and onboard equipment requiring energy include without limitation: computers and processors; life support systems and amenities; controllers; sensors; controls; monitors; thermostats; detectors; alarms; conduits and conduit components; collectors and accumulators; pumps; fans; injectors; accumulators; valves; gates; shunts; plumbing; pressurizers; compressors; humidifiers and dehumidifiers; filters; purifiers; refrigerators; extractors; blenders; dissolvers; coolers; heaters; liquefiers; engines and engine support; RAs and RA support; breathing apparatus; tools; navigation; communication; ventilation systems; air conditioning systems; sanitary systems; food storage and preparation equipment; and other equipment. Electricity for these purposes can be produced as described above. Power used to accomplish such secondary functions is termed “ancillary power.”

As used herein, the term “secondary function” refers to those tasks or utilities on board the vehicle that do not relate to its primary or secondary propulsion. Electricity is a convenient source of energy to accomplish such secondary functions, and electricity can be produced using the systems and methods disclosed herein. As an example, one or more RAs can be used to produce reactants such as hydrogen and oxygen, which can be used to power fuel cells, or to power a generator that can itself produce electricity, as has been previously described. In embodiments, at least one battery can be employed in the vehicle, for to start the vehicle, to activate the control computers on the vehicle, and to energize the devices used to produce the ongoing ancillary power. The charge of batteries used by the vehicle and its infrastructure can be restored and maintained once ancillary power production is underway.

One important use of ancillary power is the powering of the RA systems themselves. The associated RA states and properties (including, but not limited to humidity, temperature, wavelength, pulse frequency, and amplitude) are coordinated with the geometry and material qualities of the cavities/tubes within the RAs to extract specific types of atoms and molecules. RAs require power, initially to establish their required operating state and properties and to initiate activity, and in some cases on an ongoing basis to maintain and assure their proper operating environment.

b. Special Principles of Vehicle Design
i. Radiation Shielding

The availability of RAs to permit instantiation of necessary propellants allows an advantageous reduction in weight for vehicles, as has been previously described. This allows such vehicles to carry materials needed for radiation shielding without imposing an excessive weight burden on the vehicle itself. More importantly, the RA technologies disclosed herein enable the production of such radiation shielding materials on board the vehicle itself. Cosmic radiation, comprised mainly of high-speed protons and helium nuclei, is ubiquitous beyond the Earth's natural magnetic shielding (its magnetosphere) and poses significant long-term risk to travelers in that environment. Certain terrestrial metals, such as gold or platinum, have their atoms arranged in such densely packed geometric lattices that they can offer improved protection against radiation as compared to conventional materials used for this purpose. However, such metals are rare, expensive, and heavy to transport. A RA system can be appropriately tuned to economically instantiate, or filter, or isolate, or extract, or nucleate, enough of such metal(s) to envelope part or all of the vehicle with a protective layer of such shielding. The radiation shielding instantiated by the RAs can be supplemented by layers of substances such as polyethylene or lithium hydride, for example and without limitation, that are positioned interior to the metal to absorb the secondary cascade of particles produced by the collision of incoming cosmic rays with the atomic nuclei of the metal layer. For long voyages, a RA system can permit the vehicle crew to equip itself with the protective shielding it needs. Together with a complement of tools and biologicals (e.g., starter plants, seeds, bacteria, etc.) to produce shelter, shielding, atmosphere, water, fuel, food, and other essentials and amenities, the array of RAs can produce materials for other anticipated or unanticipated needs.

ii. Conduits and Flow

As material moves between points it is said to move through a conduit. Examples of such material include without limitation: hydrogen, oxygen, xenon, argon, nitrogen, other gases, fuels, oxidizing agents, boron, and any other elements or compounds used within the system. Depending on a vehicle's design and engineering constraints, conduits employed can range from straightforward direct connections to complicated paths in which a number of operations are performed, sometimes conditionally, on the subject material. Such operations involving conduits include, for example and without limitation, being pumped, collected, combined, combined with the output of other conduits or sources, stored, pressurized, compressed, liquefied, solidified, filtered, gated, shunted, injected, diverted, merged, blended, dissolved, extracted, sensed, tested, humidified, dehumidified, monitored, measured, regulated, accumulated, cooled, heated, or otherwise processed. Such operations may involve the use of components including, for example and without limitation: pumps, sensors, gates, shunts, injectors, valves, baffles, pipes, splitters, plumbing, relays, filters, controls, accumulators, tanks, reservoirs, fans, pressurizers, humidifiers, dehumidifiers, compressors, refrigerators, blenders, dissolvers, extractors, dryers, coolers, heaters, liquefiers, and sensors and controls for flow, humidity, concentration, temperature, volume, and pressure, as well as other sensors and controls and processing equipment. Each operation may be performed zero or more times, sometimes simultaneously, and the order in which they are performed (and whether they are necessary) depends on a particular implementation's design, tradeoffs, and constraints. Conduits may also be used to route power and signals and signal cables.

### 6. Expulsive Combustion Engine Systems Using Instantiated Fuels: Third Exemplary Embodiment

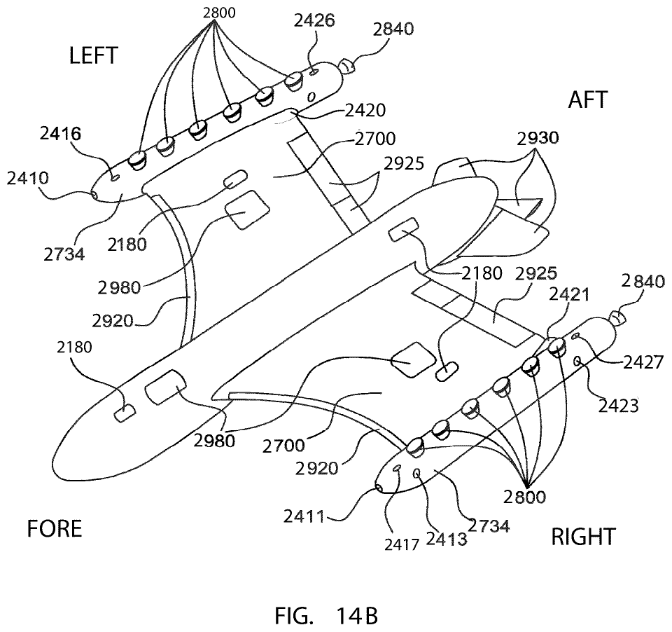

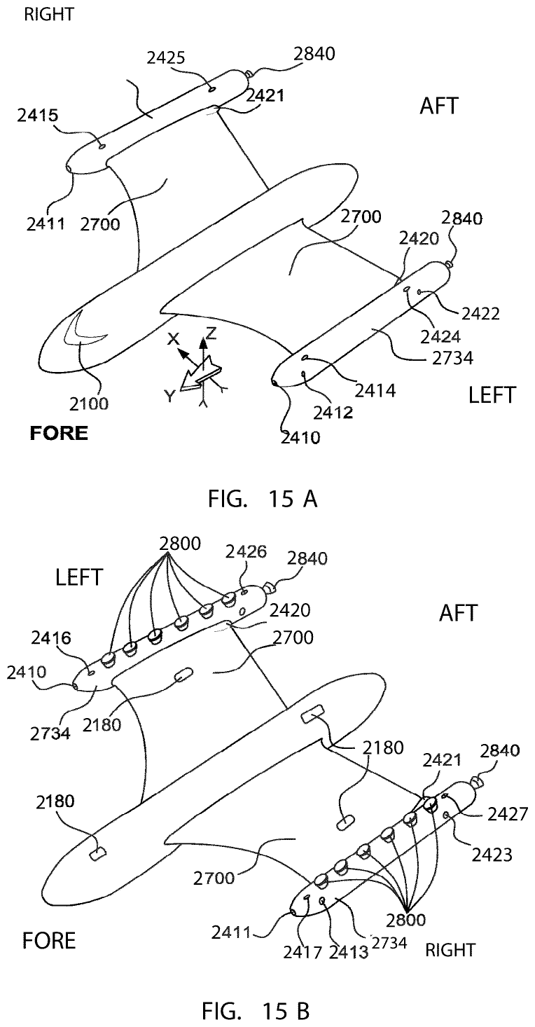

FIGS. 14A, 14B, and 15A, 15B depict versions of another exemplary embodiment of a vehicle propelled by expulsive combustion engine systems using instantiated fuels. The depicted embodiments are vehicles that can fly through the air aerodynamically and also operate in a vacuum environment. We can refer to such vehicles as “GAVADADAS” (Go Anywhere Vehicle, Any Direction, Any Distance, Any Speed).

The meaning of pictorial number tags used in FIGS. 14A, B and FIGS. 15A, B that are not herein defined are intended to carry the same, or analogous, significance as the similarly numbered tags explained in association with the illustrations discussed above. Functions associated with items 2100, 2200, 2300, 2320, 2330, 2340, 2350, and 2370, and conduits 2500, 2520, 2530, 2540, and 2550 discussed above are in connection with those Embodiments #1 and #2 may all be present in this Embodiment #3, although only certain of them are explicitly identified in the Figures associated with Embodiment #3. Certain features are depicted in both FIGS. 14A and B, and FIGS. 15A and B, while other features are only depicted in one set of Figures. Certain features present in those Figures associated with Embodiments #1 and #2 are also present in some or all of FIGS. 14A, 14B, 15A, and 15B, whether or not explicitly identified. Certain features are described below in more detail.

As shown in FIGS. 14A, 14B, 15A, and 15B, the lifter thrusters 2800 can be powered by any sort of propellant. The pusher engines 2840 can also be powered by any sort of propellant, but typically would be the type of engine as those used in the lifter thrusters 2800. In one exemplary embodiment, the lifting, pusher, and steering thrusters use chemical propulsion. In embodiments, electric thrusters are used selectively, for example only when the vehicles are operating in a vacuum environment.

The radiator structure items 2705, 2710, 2720, 2725, and 2790 described in previous Figures need not have a precise structural analog in FIGS. 14A and 14B and 15A and 15B. Instead, radiator functions in the illustrated GAVADADAS embodiment are performed by the surfaces of the wings (where these radiator functions are identified as 2700, but are equated with wings), their nacelles 2734 and (in some embodiments) the wings' aerodynamic control surfaces 2920 and 2925. The outer surface of these can be covered by a layer of durable, heat-resistant, emissive material positioned on top of one or more layers of strong, durable, heat-resistant and heat-conductive materials, for heat management as has been described above.

The embodiment illustrated in FIG. 14A and FIG. 14B is supplied with aerodynamic features familiar to those skilled in aircraft design: for example, the radiator surfaces 2700 are implemented as wings with flaps and slats on the leading edge (2920), and spoilers, flaps, ailerons, and tabs on the trailing edge (2925). The empennage (tail assembly) can include a conventional rudder, stabilizer, elevators, and tabs (2930). The undercarriage of the vehicle features extensible, telescoping, struts (2180) suitable for resting or landing vertically on somewhat uneven terrain, as well as conventional wheeled landing gear assemblies (2980) which are lowered before landing and folded back into the craft after take-off.

Two exemplary embodiments having different configurations are shown in the Figures (FIGS. 14A-14B and FIGS. 15A-15B). These Figure sets both exhibit sixteen steering thrusters: 8 mounted forward on the wing nacelles (2410-2417); 8 mounted aft (2420-2427). Used in proper combination, these 16 alignment thrusters permit maneuvers along all axes, and provide redundancy in event of thruster failure. Because these thrusters are in some embodiments used only rarely for short bursts (typically only of a few seconds), there is no need for an elaborate and extensive heat dissipation system similar to the radiator structures 2700 that are configured as wings. These small thrusters can be self-contained propulsion units, each with its own associated RAs for fuel and oxidizer production, making elaborate plumbing connections from the propellant locus (2300, but not shown in these Figures) unnecessary. In other embodiments, these thrusters could be implemented as self-contained electric thruster units each with their own associated RAs for instantiating a propellant such as xenon. Power might be provided centrally from an electrical power bay 2200 (not shown), or with an associated RA,

Used in proper combination, these 16 steering (alignment) thrusters enable maneuvers along all axes, and provide redundancy in event of thruster failure. Basic maneuvers include, for example: to turn or yaw left; to roll counterclockwise (CCW); to pitch up; to pitch down; to shift right; to shift forward; to shift backward; to shift (nudge) down; to shift (nudge) up. Shift operations are particularly advantageous for delicate maneuvers such as landing, docking, and avoiding obstacles while hovering and moving slowly.

Other differences between the intra-atmospheric and the supra-atmospheric modes of operation include:
Lift In supra-atmospheric mode or operation, lift is achieved with lifting thrusters. In aircraft mode or operation, at low horizontal speed, lift can also be achieved with lifting thrusters; in an atmosphere at high or other horizontal speed, lift can be achieved aerodynamically with wings rather than depending on lifting thrusters which may be functionally impaired by the apparent wind generated at high horizontal velocity through an atmosphere. In aircraft mode or operation, ascent can be achieved by lift developed while accelerating down a runway; descent by gliding down a runway and losing lift while decelerating. This entails landing gear with wheels and sturdy tires.
Steering In supra-atmospheric mode or operation, steering is achieved with steering thrusters. In aircraft mode or operation, at low horizontal speed, steering can also be achieved with steering thrusters; at high horizontal speed, steering can be achieved using aerodynamic control surfaces such as ailerons, flaps, stabilizers, spoilers, rudders, elevators, and tail—rather than depending on steering thrusters which may be functionally impaired by the apparent wind generated at high horizontal velocity through an atmosphere.
Ascent/Descent In either mode, ascent can be achieved with lifting thrusters operating at more than “′one-G”; descent with lifting thrusters carefully operated at near to, but less than, “one-G”. This entails using “struts” as landing gear, since hot billowing lifter exhaust is apt to damage tires. Extensible struts can be provided to accommodate variable or uneven terrain.
Noise In supra-atmospheric mode or operation, the high-powered lifting thrusters, which are directed downward, are apt to be objectionably noisy especially when used overpopulated areas. In aircraft mode or operation, noise is apt to be comparable with conventional jet aircraft.
Transit As a vehicle operating in an supra-atmospheric environment, transit is generally presumed to be done primarily vertically by the lifters operating at as high an acceleration as engineering constraints, and the comfort of passengers (if any), permit. As an aircraft, transit is generally presumed to be done primarily horizontally by pushers, while the vehicle is held aloft either by lift thrusters or by aerodynamic lift generated by the wings.

Other differences exist between supra-atmospheric vehicles and intra-atmospheric vehicles (aircraft). For example, vehicles designed primarily for use in an supra-atmospheric environment or which do not require high lateral velocity in an atmosphere, may elect in the interest of reducing mass not to implement the pusher engines or aerodynamic features such as a tail empennage, and do not need various control surfaces such as flaps and other airfoils or aerodynamic control surfaces, and the landing wheel assemblies. Vehicle features should advantageously function in atmospheric operation, although high forward speeds create cross-wind in atmospheric environments that may impair operation of the lift and steering thrusters if they are of the chemical type. Further, it is understood that electric thrusters at present cannot operate effectively in the atmosphere, so alternative propulsion mechanisms (such as chemical propulsion) are necessary.

The exemplary embodiments herein discussed allow supra-atmospheric features to be activated and deactivated during aircraft operation at any reasonable speed. Note that the depicted embodiments of supra-atmospheric vehicles do not require aircraft features. Implementation of supra-atmospheric features will function well in the atmosphere, provided forward speed is kept sufficiently low and the differences in designs and operating requirements are kept in mind. Thus, lifters can be used on supra-atmospheric vehicles for vertical take off and landing (VTOL), but the design of supra-atmospheric vehicles must ensure that landing-gear tires are not damaged by the hot exhaust gases of lifters during VTOL operation.

The disclosure herein has focused on issues of design for supra-atmospheric vehicles that are particularly relevant to or affected by the present invention. Therefore the disclosure has omitted description of those conventional aspects and details of implementation already familiar to those of ordinary skill in the art of vehicular design. Omitted, for example, are discussions of entry portals, life support systems, recycling, guidance, control, communication, protection against hazards (such as radiation shielding), wiring, plumbing, safety, redundancy, and security.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

### EXAMPLES

### Example 1: Energy/Light Combed Activation (E/LC)

One hundred milligrams (100 mg) of powdered carbon was placed in a GG-EL graphite tubular reactor (15.875 mm) OD, with ID machined to ˜9 mm). This reactor was inserted into a reactor assembly FIG. 2A and then placed into a high vacuum oven for degassing according to the Degassing Procedure (See Profile 1 or Profile 2). After degassing, the reactor assembly is transferred to a test cell for processing. Research-grade Nitrogen (N₂) was delivered at 2 SLPM to purge the system for a minimum of 25 seconds or more. The gases were fed through the E/MEE in a horizontal and level gas line, as described above. During purging, gas sampling lines are also purged. TEDLAR® scaled bags, when used, are connected to the sampling lines during the purge cycle.

Referring to FIG. 1, the argon “KC” light 108 located in position 0 (vertical lamp orientation; 7.62 cm from inlet or entrance flange; at 180°; bulb tip pointing up 2.54 cm from the outer diameter of the gas line) was turned on at the onset while simultaneously energizing the power supply to 5 amps. This light was kept on for a minimum hold time of 9 sec. Next light 109 in position 1 (109; horizontal lamp orientation; 7.62 cm from inlet or entrance flange; at 180°; bulb tip facing exit plate; bulb glass base at the optical entrance; 5.08 cm, from the outer diameter of the gas line), a krypton light, was turned on and the power is increased to 10 amps on the power supply. This was held for 3 seconds, light 107, in position 1 (107; horizontal lamp orientation; at 0°; bulb tip at the optical exit facing the exit plate; 5.04 cm from the outer diameter of the gas line), a xenon light was turned on and held for 9 seconds and the power was increased to 15 amps. After these 3 lights have been sequentially turned on, the sealed TEDLAR® bags are opened for gas collection, and the amperage delivered to reactor was adjusted to 100 amps and held for a minimum of 30 seconds. Immediately after the power was increased light 103 in position 1 (103; vertical lamp orientation; 7.62 cm from inlet or entrance flange; at 0°; bulb tip pointing down 2.54 cm from the outer diameter of the gas line), a neon light, was turned on.

Amperage harmonic patterning was then initiated on the reactor. With each amperage pattern (oscillation), the gases fed to the reactor can treated by the same or different light sequence. In one embodiment of the experimental protocol, the amperage of the reactor was increased to 78.5 amps over 1 second, the high-end harmonic pattern point. The amperage of the reactor was then decreased to 38.5 amps over 9 seconds and held at 38.5 amps for 3 seconds. Immediately at the start of the 3 second hold, an argon light 122 in position 1 (122; horizontal lamp orientation; at 180°; bulb tip pointing towards entrance plate at the optical entrance; 5.04 cm from the outer diameter of the gas line) was turned on. After the 3 second hold, amperage to the reactor was then ramped up to 78.5 amps over 9 seconds with a 3 second hold upon reaching 78.5 amps before a downward ramp was initiated. The reactor amperage was decreased to 38.5 amps, over 9 seconds and then held for 3 seconds. Immediately at the start of the 3 second hold, light 103 (103), a neon light in position 1, was turned on. The reactor amperage was again ramped up to 78.5 amps over 9 seconds, held there for 3 seconds, and then again ramped down to 38.5 amps over 9 seconds. A long-wave ultraviolet lamp (104; horizontal lamp orientation; at 90°; bulb tip facing entrance plate at the optical entrance; 5.04 cm from the outer diameter of the gas line) in position 1 was turned on.

The reactor was again ramped up to 78.5 amps over 9 seconds, held for 3 seconds, then decreased to 38.5 amps over another 9 seconds. Next a short-wave ultraviolet lamp (105 horizontal lamp orientation; 7.62 cm from inlet or entrance flange; at 270°; bulb tip at the optical entrance and facing the entrance plate; 5.04 cm from the outer diameter of the gas line) in the E/MEE (position 1) E/MEE section light was turned on and held for 3 seconds. The reactor was again ramped up to 78.5 amps over 9 seconds and held for 3 seconds. After the 3 second hold, the reactor amperage was decreased to 38.5 amps over another 9 seconds. The reactor was then held at 38.5 amps for 3 seconds, before another ramp up to 78.5 amps over 9 seconds was initiated. At 3 seconds into this ramp, lamp 107, in position 1 (107) was turned on and held there for the remaining 6 seconds of the 9 second total ramp. The reactor was held for 3 seconds in this condition.

The lights were turned off simultaneously in the E/MEE section as follows: (103), (108), (106), (105) and (104) and the reactor was deenergized. The reactor was held at this state, with continuous gas flow for 27 seconds during which the TEDLAR® bags are closed and removed. All remaining lights were turned off and gas flow continues for 240 seconds.

### Example 2: Degassing Profile 1

One hundred milligrams (100 mg) of powdered carbon was placed in a graphite tubular reactor (15.875 mm) OD, with ID machined to ˜9 mm), as described above and loaded into a closed end system. After ten closed end set-ups have been completed, each individual unit was loaded into the degassing oven openings and all incoming and outgoing lines were connected to the closed end systems. Isolated each incoming line to each reactor while maintaining the outgoing lines in an open position. Started the vacuum system until the vacuum gauge reads at least 750 mmHg. Upon reaching 750 MmHg, closed all outgoing line valves from the closed end systems and secured the vacuum pump. Performed a 30-minute leak test of the system. After successfully passing the leak check, opened each incoming line to the closed end system one at a time at 0.4 slpm N₂. Once all incoming lines were open and the vacuum gauge reached a slight positive pressure, opened the outgoing gas line on the degassing oven. Started the degassing oven profile ramping from T_{amb} to 400° C. over 1 hour while maintaining N₂ flow. After the 1-hour ramp, maintained flow for an additional hour for temperature stabilization while maintaining gas flow. After the temperature stabilization was complete, secured all incoming gas flows and isolated the degassing oven vent line. Immediately started the vacuum pump and begin the degassing protocol. Maintained the temperature and vacuum for 12 hours. After the 12 hours, allowed the oven to cool prior to closed end unit removal.

### Example 3: Degassing Profile 2

One hundred milligrams (100 mg) of powdered carbon was placed in a graphite tubular reactor (15.875 mm) OD, with ID machined to ˜9 mm), as described above and loaded into a closed end system. After ten closed end set-ups have been completed, each individual unit was loaded into the degassing oven openings and connected all incoming and outgoing lines to the closed end systems. Isolated each incoming line to each reactor while maintaining the outgoing lines in an open position. Started the vacuum system until the vacuum gauge reads at least 750 mmHg. Upon reaching 750 MmHg, closed all outgoing line valves from the closed end systems and secured the vacuum pump. Performed a 30-minute leak test of the system. After successfully passing the leak check, opened each incoming line to the closed end system one at a time at 0.4 SLPM N₂. Once all incoming lines were open and the vacuum gauge reached a slight positive pressure, opened the gas outgoing gas line on the degassing oven. Started the degassing oven profile ramping from 200° C.±50° C. to 400° C. over 1 hour while maintaining N₂ flow. After the 1-hour ramp, maintained flow for an additional hour for temperature stabilization while maintaining gas flow. After the temperature stabilization was complete, secured all incoming gas flows and isolated the degassing oven vent line. Immediately started the vacuum pump and began the degassing protocol. Maintained the temperature and vacuum for 12 hours. After the 12 hours, allowed the oven to cool prior to closed end unit removal.

### Example 4: Gas Analysis

For the chemical analysis of gas samples in TEDLAR® bags, a test protocol was developed based on the standard test method established for internal gas analysis of hermetically-sealed devices. Prior to sample measurement, system background was determined by following exact measurement protocol that is used for sample gas. For system background and sample, a fixed volume of gas was introduced to the Pfeiffer QMA 200M quadrupole mass spectrometer (QMS) system through a capillary. Through a capillary, a fixed volume of gas was introduced to the Pfeiffer QMA 200M quadrupole mass spectrometer (QMS) system. After sample gas introduction, the ion current for specific masses (same as masses analyzed for system background) were measured. During background and sample gas analyses total pressure of the QMS system was also recorded, allowing for correction of the measured ion current.

TABLE 2
Gases analyzed for the test method and
measured masses used in deconvolution.

| Gas | Masses used for deconvolution |
|---|---|
| 1. Hydrogen | 2, 18, 55, 57 |
| 2. Helium (3) | 2, 4 |
| 3. Helium (4) | 4 |
| 4. Methane | 14, 15 |
| 5. Water | 18, 32, 40 |
| 6. Neon (20) | 18, 20, 40 |
| 7. Neon (22) | 20 |
| 8. Nitrogen | 14 |
| 9. Carbon Monoxide | 14, 28 |
| 10. Oxygen | 32 |
| 11. Argon | 40, 41, 43 |
| 12. Carbon Dioxide | 44 |
| 13. Tot. HC and Org. | 55, 57 |
| 14. Fluorocarbons | 69 |
| 15. Ammonia | 17, 18 |
| 16. Krypton | 84 |
| 17. Xenon | 132 |

### Data Analysis:

Measurements of the ion current for each mass were corrected to the average of measured background contributions corrected for pressure difference. Subsequent to the background correction, individual corrected mass signals were averaged and corrected to a known gas standard to determine the percent volume of 17 gas species. All corrections were determined using nitrogen and nitrogen-hydrogen mixture reference gases analyzed to match selected process gas for test samples using the developed protocol based on the standard test method, in accordance with Military Standard (MIL-STD-883) Test Method 1018, Microcircuits, Revision L, FSC/Area: 5962 (DLA, 16 Sep. 2019). Results below: 1%=10,000 ppm, Volume values for gas blanks and samples were produced using the developed gas analysis test method and validated using a gas mixture standard of 99.98% nitrogen and 0.02% hydrogen. All analytical performed by EAG Laboratories, Liverpool, NY using standard TEDLAR® bag gas sampling protocols and specified mass spectrometry methods.

Mass Analyzer: Quadrupole mass spectrometer (Pfeiffer QMA 200M)
Measurement mode: Analog scan for selected masses
No. of channels used: 64
Mass resolution: Unit resolution
Maximum detectable concentration: 100%
Minimum detectable concentration: 1 ppb
Background vacuum: <2×10⁻⁶ Torr

### Results:

Protocol 1:

| Gases Analyzed | | | | | |
|---|---|---|---|---|---|
| (Vol %) | Ill. 1 | Ill. 2 | Ill. 3 | Ill. 4 | Ill. 5 |
| Hydrogen | 0.7678 | 0.2405 | 0 | 0 | 0.0162 |
| Helium (4) | 0.1923 | 0.2963 | 0.1928 | 0.5476 | 0.1254 |
| Methane (CH₄) | 0 | 0 | 0 | 0 | 0 |
| Water (H₂O) | 0.4054 | 1.0773 | 0 | 0 | 0 |
| Neon (20) | 0.036 | 0.03 | 0.0417 | 0.1789 | 0.0345 |
| Neon (22) | 0.0036 | 0.003 | 0.0042 | 0.0179 | 0.0035 |
| Nitrogen | 95.276 | 89.3705 | 99.347 | 88.2306 | 99.6251 |
| Carbon | 0 | 0 | 0 | 0 | 0 |
| Monoxide (CO) | | | | | |
| Oxygen | 3.1604 | 8.5606 | 0.3796 | 10.945 | 0.1826 |
| Argon | 0.0676 | 0.349 | 0.0003 | 0.08 | 0 |
| Carbon | 0.0138 | 0 | 0 | 0 | 0 |
| Dioxide (CO₂) | | | | | |
| Total | 0.0269 | 0 | 0.0175 | 0 | 0 |
| Hydrocarbons | | | | | |
| and Organics | | | | | |
| Fluorocarbons | 0.0261 | 0.0417 | 0.0162 | 0 | 0.0127 |
| Ammonia | 0 | 0.031 | 0 | 0 | 0 |
| (NH₃) | | | | | |
| Krypton | 0.0242 | 0 | 0 | 0 | 0 |
| Xenon | 0 | 0 | 0 | 0 | 0 |

| Gases Analyzed | | | | |
|---|---|---|---|---|
| (Vol %) | Ill. 6 | Ill 7. | Ill. 8 | Ill. 9 |
| Hydrogen | 1.027 | 0 | 0 | 4.0494 |
| Helium (4) | 0.364 | 2.6033 | 0.2145 | 25.118 |
| Methane (CH₄) | 0 | 0 | 0 | 0 |
| Water (H₂O) | 0 | 0 | 0 | 0 |
| Neon (20) | 0.1093 | 0.4736 | 0.0308 | 5.6369 |
| Neon (22) | 0.0109 | 0.0474 | 0.0031 | 0.5637 |
| Nitrogen | 97.1911 | 94.6204 | 95.9834 | 56.538 |
| Carbon | 0 | 0 | 0 | 0 |
| Monoxide (CO) | | | | |
| Oxygen | 1.2975 | 2.2553 | 3.7604 | 4.1726 |
| Argon | 0 | 0 | 0.0078 | 0 |
| Carbon | 0 | 0 | 0 | 0 |
| Dioxide (CO₂) | | | | |
| Total | 0 | 0 | 0 | 1.0654 |
| Hydrocarbons | | | | |
| and Organics | | | | |
| Fluorocarbons | 0 | 0 | 0 | 1.9565 |
| Ammonia | 0 | 0 | 0 | 0 |
| (NH₃) | | | | |
| Krypton | 0 | 0 | 0 | 0.8997 |
| Xenon | 0 | 0 | 0 | 0 |

Protocol 2:

| Gases Analyzed | | | | | | |
|---|---|---|---|---|---|---|
| (Vol. %) | Ill. 10 | Ill. 11 | Ill. 12 | Ill. 13 | Ill. 14 | Ill. 15 |
| Hydrogen | 0 | 1.0428 | 1.3437 | 0 | 1.6249 | 1.7941 |
| Helium (4) | 0.4679 | 0.3492 | 0.4409 | 0.8074 | 0.4888 | 0.6406 |
| Methane (CH₄) | 0 | 0 | 0 | 0 | 0 | 0 |
| Water (H₂O) | 0 | 2.3924 | 3.1436 | 0 | 4.4032 | 2.4182 |
| Neon (20) | 0.1598 | 0 | 0 | 0 | 0 | 0 |
| Neon (22) | 0.016 | 0 | 0 | 0 | 0 | 0 |
| Nitrogen | 76.7986 | 79.9798 | 94.2126 | 51.1046 | 92.2167 | 75.6209 |
| Carbon Monoxide | 0 | 0 | 0 | 0 | 0 | 0 |
| (CO) | | | | | | |
| Oxygen | 22.079 | 15.565 | 0.8348 | 48.088 | 1.239 | 18.7733 |
| Argon | 0.4639 | 0.5717 | 0 | 0 | 0 | 0.721 |
| Carbon Dioxide | 0 | 0.0991 | 0.0244 | 0 | 0.0274 | 0.0319 |
| (CO₂) | | | | | | |
| Total Hydrocarbons | 0 | 0 | 0 | 0 | 0 | 0 |
| and Organics | | | | | | |
| Fluorocarbons | 0.0147 | 0 | 0 | 0 | 0 | 0 |
| Ammonia (NH₃) | 0 | 0 | 0 | 0 | 0 | 0 |
| Krypton | 0 | 0 | 0 | 0 | 0 | 0 |
| Xenon | 0 | 0 | 0 | 0 | 0 | 0 |

Standard (Nitrogen):

| | Vol % |
|---|---|
| | Standard |
| | 99.98 vol % N₂/ |
| Gases Analyzed | 200 ppm H₂ |
| Hydrogen | 0.0223 |
| Helium (3) | 0.0000 |
| Helium (4) | 0.0000 |
| Methane (CH₄) | 0.0000 |
| Water (H₂O) | 0.0000 |
| Neon (20) | 0.0000 |
| Neon (22) | 0.0000 |
| Nitrogen | 99.9777 |
| Carbon Monoxide | 0.0000 |
| (CO) | |
| Oxygen | 0.0000 |
| Argon | 0.0000 |
| Carbon Dioxide (CO₂) | 0.0000 |
| Total Hydrocarbons | 0.0000 |
| and Organics | |
| Fluorocarbons | 0.0000 |
| Ammonia (NH₃) | 0.0000 |
| Krypton | 0.0000 |
| Xenon | 0.0000 |

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference.

While this invention has been particularly shown and described with references to preferred embodiments thereof, it will be understood by those skilled in the art that various changes in form and details may be made therein without departing from the scope of the invention encompassed by the appended claims. Numerical values where presented in the specification and claims are understood to be approximate values (e.g., approximately or about) as would be determined by the person of ordinary skill in the art in the context of the value. For example, a stated value can be understood to mean within 10% of the stated value, unless the person of ordinary skill in the art would understand otherwise, such as a value that must be an integer.

1. An expulsive combustion engine energized by combustion of a fuel to produce thrust, comprising:
(a) a set of one or more reactor assemblies (RAs) that produces the fuel;
(b) a source of an oxidizing agent;
(c) a fuel intake system in fluid communication with the set of one or more RAs sand further in fluid communication with a combustion chamber, wherein the fuel intake system delivers the fuel into the combustion chamber;
(d) an oxidant delivery system in fluid communication with the source of the oxidizing agent, wherein the oxidant delivery system delivers an oxidizing agent into the combustion chamber;
(e) a control system operatively coupled to the fuel intake system and the oxidant delivery system, wherein the control system regulates delivery of a preselected fuel amount and a preselected oxidizing agent amount into the combustion chamber, and wherein the control system controls the combustion of the fuel and the oxidizing agent when the preselected fuel amount and the preselected oxidizing agent amount are present in the combustion chamber, thereby producing energy and exhaust gases; and
(f) a nozzle in fluid communication with the combustion chamber, through which the exhaust gases exit the combustion chamber in a preselected direction to produce the thrust.

2. (canceled)

3. (canceled)

4. The engine of claim 1, wherein the fuel comprises hydrogen.

5. The engine of claim 1, wherein the source of the oxidizing agent is a second set of RAs that produces the oxidizing agent.

6. (canceled)

7. (canceled)

8. A method of producing thrust to propel a vehicle, comprising:
(a) operatively associating the vehicle with the expulsive combustion engine of claim 1;
(b) activating the set of one or more RAs to produce the fuel;
(c) directing the fuel produced by the set of one or more RAs to enter the fuel intake system in fluid communication with the combustion chamber, wherein the fuel intake system directs the fuel into the combustion chamber;
(d) providing a source of the oxidizing agent;
(e) directing the oxidizing agent from the source of the oxidizing agent into the combustion chamber;
(f) mixing the fuel and the oxidizing agent to form a combustion mixture;
(g) igniting the combustion mixture to produce a combustion, wherein the combustion produces energy and exhaust gases; and
(h) directing the exhaust gases to exit the combustion chamber in a preselected direction, thereby producing the thrust to propel the vehicle.

9. (canceled)

10. (canceled)

11. The method of claim 8, wherein the fuel comprises hydrogen.

12. The method of claim 8, wherein the source of the oxidizing agent is a second set of RAs.

13. (canceled)

14. (canceled)

15. (canceled)

16. (canceled)

17. (canceled)

18. A method of propelling a vehicle on a predetermined course, comprising:
(a) providing an expulsive combustion engine for the vehicle, wherein the expulsive combustion engine is operatively coupled to the vehicle, and wherein the expulsive combustion engine provides motive power to the vehicle by producing thrust;
(b) producing a fuel for the engine, wherein the step of producing the fuel comprises the following substeps:
(i) adding a fuel feed gas to an electromagnetic embedding apparatus:
(ii) exposing the fuel feed gas to at least one E/MEE light source;
(iii) directing the fuel feed gas from step (ii) to a reactor assembly comprising:
a gas inlet and one or more gas outlets;
a reactor chamber containing a nanoporous carbon disposed within a cup and, optionally, covered with a cap;
a first porous frit defining a floor of the reactor chamber disposed within the cup;
a second porous frit defining the ceiling of the reactor chamber; wherein each porous frit has a porosity that is sufficient to allow a gas to permeate into the reactor chamber;
a reactor head space disposed above the reactor chamber;
at least one RA coil surrounding the reactor chamber and/or reactor head space operably connected to a power supply, wherein the computer processing unit is configured to control the power supply to the RA coil;
(iv) subjecting the nanoporous carbon powder to harmonic patterning to instantiate a product fluid comprising the fuel; and
(v) collecting the product fluid comprising the fuel;
(c) mixing an oxidant with the fuel, thereby forming a combustible fuel mixture; and
(d) combusting the combustible fuel mixture in the combustion chamber to generate energy and to produce exhaust gases that are expelled from the combustion chamber to produce thrust that provides motive power to the vehicle; and
(e) directing the vehicle to follow the predetermined course.

19. (canceled)

20. The method of claim 18, wherein the fuel feed gas comprises nitrogen.

21. The method of claim 18, wherein the fuel comprises hydrogen.

22. (canceled)

23. The method of claim 18, wherein the oxidant is produced by a second set of one or more RAs.

24. (canceled)

25. (canceled)

26. The method of claim 18, further comprising pressurizing or compressing at least one of the fuel and the oxidant prior to its delivery into the combustion chamber.

27. A system for propelling a vehicle along a designated route, comprising:
(a) a propellant locus comprising at least one set of fuel-instantiating RAs for producing fuel, and at least one set of oxidant-instantiating RAs for producing oxidant;
(b) a propulsion locus comprising:
(i) a combustion chamber within which a mixture of fuel and oxidant is combusted to produce exhaust gas and to generate energy comprising heat energy; and
(ii) a nozzle for directing the exhaust gas to exit the combustion chamber in a direction consistent with propelling the vehicle along the designated route;
(c) a series of conduits in fluid communication with the propellant locus and the combustion chamber, wherein the series of conduits directs the fuel and the oxidant into the combustion chamber; and
(d) a heat management subsystem, comprising a primary heat deflector and one or more radiator structures for managing heat energy.

28. The system of claim 27, wherein the propellant locus further comprises at least one set of RAs for producing a propellant additive, and wherein the series of conduits directs the propellant additive into the combustion chamber.

29. The system of claim 28, wherein the series of conduits comprises a premixing chamber within which the propellant additive is premixed with at least one of the fuel and the oxidant to form a mixture before entering the combustion chamber, wherein the mixture is thereafter directed into the combustion chamber.

30. (canceled)

31. (canceled)

32. (canceled)

33. The system of claim 27, further comprising an ancillary power source producing electricity for one or more secondary functions.

34. (canceled)

35. (canceled)

36. (canceled)

37. (canceled)

38. (canceled)

39. (canceled)

40. The system of claim 27, further comprising a secondary propulsion system for carrying out a secondary function selected from the group consisting of guidance, course correction, and maneuvering, wherein the secondary function directs the vehicle along the designated route.

41. (canceled)

42. A vehicle, comprising:
a payload pod conveying a payload, an electrical power bay, a propellant locus, a propulsion locus, and a radiator,
wherein a distal end of the payload pod is affixed to a proximal end of the electrical power bay, and wherein a distal end of the electrical power bay is affixed to a proximal end of the propellant locus, and wherein the payload pod, the electrical power bay, and the propellant locus are integrated to form a single unified structure;
wherein the electrical power bay is operatively coupled to one or more of the payload pod, the propellant locus, and the propulsion locus to provide power thereto;
wherein the propellant locus instantiates a fuel and an oxidant to deliver to the propulsion locus;
wherein the propulsion locus comprises one or more combustion chambers;
wherein the fuel and the oxidant pass through a set of conduits in fluid communication with the propellant locus and the propulsion locus to reach the propulsion locus and to enter one or more combustion chambers disposed therein;
wherein the fuel and the oxidant undergo combustion in the one or more combustion chambers, thereby generating energy and producing exhaust gases that are expelled in an exit path from the propulsion locus to create thrust that propels the vehicle in a forward direction; and
wherein the radiator has a proximal end that is affixed to the propulsion locus and a distal end that is open, wherein the radiator is disposed circumferentially around the exit path to circumscribe at least a portion of the exit path, and wherein the radiator is secured to the payload pod with a set of long struts and is secured to the propellant locus by a set of shorter struts.

43. (canceled)

44. (canceled)

45. (canceled)

46. The vehicle of claim 42, wherein the electrical power bay provides power for one or more secondary functions.

47. The vehicle of claim 42, wherein the propellant locus comprises a first set of one or more RAs for instantiating the fuel and a second set of one or more RAs for instantiating the oxidant.

48. (canceled)

49. The vehicle of claim 42, further comprising a set of conduits in fluid communication with the propellant locus and the one or more combustion chambers, and wherein the fuel and oxidant pass through the set of conduits to reach the one or more combustion chambers.

50. (canceled)

51. (canceled)

52. The vehicle of claim 42, further comprising a heat discharge or cooling subsystem.

53. (canceled)

54. The vehicle of claim 42, further comprising radiation shielding.

55. (canceled)
